(19) United States
(12) Patent Application Publication
(10) Pub. No.: US 2023/0200309 A1
(43) Pub. Date: Jun. 29, 2023

(54) PLANT GROWTH PROMOTING SYSTEM RADIATING QUANTUM ENERGY

(71) Applicant: EUNHAE ENC CO, LTD., Siheung-si, Gyeonggi-do (KR)

(72) Inventor: Boo Yeol KIM, Ansan-si (KR)

(73) Assignee: EUNHAE ENC CO, LTD., Siheung-si, Gyeonggi-do (KR)

(21) Appl. No.: 18/018,798

(22) PCT Filed: Jul. 23, 2021
(86) PCT No.: PCT/KR2021/009580

§ 371 Date: Jan. 30, 2023

(30) Foreign Application Priority Data
Jul. 28, 2020 (KR) 10-2020-0093539

(51) Int. Cl. A01G 9/26; A01G 7/02; A01G 7/04; A01G 9/24; B01F 25/312; B01F 23/237; C25B 1/50; C25B 1/01; C02F 1/50

(52) U.S. Cl. CPC A01G 9/26; A01G 7/02; A01G 7/04; A01G 9/247; B01F 25/312; B01F 23/23762; C25B 1/50; C25B 1/01; C02F 1/50; C02F 2303/04; C02F 2305/00

(57) ABSTRACT

A plant growth promoting system according to the present invention makes foliar application of nitric oxide containing a mineral material, an enzymatic material, and a soil microorganism to a root part and leaves of a plant by pressure spraying, makes foliar application of carbonated water containing a plant growth promoter and a moisture fluctuation inhibitor to leaves of the plant by pressure spraying, and applies quantum energy to a round surface and an aerial part of the plant, thus providing the effect of promoting the growth of the plant.

### FIELD OF INVENTION

The present invention relates to a plant growth promoting system with irradiation of quantum energy, more particularly, a plant growth promoting system is established such that: high field electron energy generated in a process of high-voltage discharge is applied to air components composed of nitrogen (N2), oxygen (O2), and water molecules (H2O) in water vapor to produce nitric oxide (NO) through electrochemical reaction such as dissociation, excitation, ionization, oxidation, reduction, etc.; the produced nitric oxide (NO) is supplied to the neck of a venture-ejector mounted on a circulation pipe by pressurizing the same (NO) using a pressurizer, and then is injected to an aqueous solution circulating inside the venture-ejector, followed by supplying the solution between discharge electrodes installed inside a dissolver while mixing; a high voltage in the form of a pulsed electromagnetic field (PEMF) is applied to another discharge electrode installed in water to firstly dissolve nitric oxide (NO) through discharge in water so as to produce nitric oxide water (NO water), followed by providing the NO water to a first reactor; nitrogen-releasing sources such as calcium phosphate, clay fly ash, mica, lanthanide rare earths, enzymes, soil microorganisms, etc. are selected and added to the first reactor to thus produce NO water containing the above substances, followed by irradiating pulsating quantum energy to the above produced NO water to bring about electrical disturbance and electric polarization, thereby inducing a quantum wave field; NO water with high order in the form of small group water and in a coherent domain state is produced by partially dissociating hydrogen bonds and covalent bonds between water dipoles; after decompressing high-pressure carbon dioxide gas filled in a container to an appropriate pressure while adjusting the same to an appropriate flow rate, the gas is fed to the neck of the venture-ejector installed on the circulation pipe, in which the aqueous solution is circulated by a circulation pump, to admix the carbon dioxide gas with the aqueous solution; variable power in the form of a pulsed electromagnetic field (PEMF) generated in a high-voltage pulse generator is supplied to a discharge electrode, a ground electrode and a trigger voltage electrode provided inside a dissolver chamber so as to degas bubbles of the carbon dioxide gas contained in the aqueous solution, followed by first dissolution in the aqueous solution to thus produce a first carbonated water; after supplying the first carbonated water to a second reactor, carbon dioxide-releasing substances, plant growth promoting substances and moisture fluctuation inhibitor substances are selected and added to the first carbonated water and then introduced into the second reactor to produce a carbonated water containing the above carbon dioxide-releasing substance, plant growth promoting substance and moisture fluctuation inhibitor substance; simultaneously, the produced carbonated water is irradiated with pulse quantum energy along with electrolysis to increase a concentration thereof in the second reactor, while bringing about electrical disturbance and electric polarization to thus induce a quantum wave field; a carbonated water with high order in the form of small group water and in a coherent domain is produced by partially dissociating hydrogen bonds and covalent bonds between water dipoles; variable power in the form of a pulsed electromagnetic field (PEMF) generated in a power supply is applied to first and second quantum energy generating coils wound in opposite directions in a pulse quantum energy generator that consist of the power supply as well as the first and second quantum energy generating coils, so that two variable magnetic fields in the form of a pulsed electromagnetic field (PEMF) in opposite directions are irradiated and overlapped at 90° angle to a direction of current flow to generate the pulse quantum energy in the first and second quantum energy generating coils; the generated pulse quantum energy is irradiated to: underground of a soil at a predetermined depth; the ground surface; a soil in a space 410, which is defined by predetermined horizontal length, vertical length and height to a predetermined height from the ground surface, and in which a plant growth promoting system is installed; and the carbonated water that contains mineral substances, enzyme substances, carbon dioxide-releasing substances such as nitric oxide containing soil microorganisms, aromatic carboxylic acid, plant growth-promoting substances, moisture fluctuation inhibitors, etc., wherein the carbonated water is sprayed to the roots and leaves of a plant planted in the above soil, so as to bring about electrical disturbance and electric polarization, thereby inducing a quantum wave field; the nitric oxide and the carbonated water, which have high order in the form of small water groups and are in a coherent domain state, are pressurized by partially dissociating hydrogen bonds and covalent bonds between water dipoles, followed by injecting the produced nitric oxide and carbonated water to the plant and foliar fertilization of the plant, while irradiating quantum energy to the ground surface and an aerial part of the ground, so as to promote the growth of the plant.

### BACKGROUND OF INVENTION

In general, in rural areas, fields and paddies are cultivated to grow various crops such as rice, barley, pepper, tomato, potatoes, etc. to contribute to the income of farmers. However, it is the current situation that most of farms are occupied by the aged, and rice-field farming and dry-field farming are too much for them.

Domestic agriculture faces difficulties due to aging of the agricultural population, reduction of agricultural manpower and farmland, and reduction of the proportion of production.

According to the statistics of the Ministry of Agriculture, Food and Rural Affairs, domestic agricultural land has been continuously decreasing from 19.0% of the total land in 2000 to 17.1% in 2013, and the proportion of agriculture, forestry and fishery in the gross domestic product also plummeted from 4.4% in 2000 to 2.3% in 2013.

Further, the use of pesticides to reduce the damage of pests and improve the production of crops, the excessive use of fertilizers, and acid rain caused by air pollution acidify the soil, and the continuous loss of minerals contained in the soil ravages the soil and reduces the air quality. Due to biological stress caused by pollution, heat waves, pests and other living things, as well as abiotic stress caused by changes in physical or chemical environments such as heat, drought, salinity, etc., the ability of plant roots to absorb necessary substances from the soil is lost. In fact, the plants take a method of absorbing various elements based on the smallest amount of one among all elements that the plants can absorb according to Liebig's law of the least amount. Accordingly, if a mineral composition as a trace element is insufficient, even though a great amount of organic fertilizers containing nitrogen (N), phosphorous (P), potassium (K), etc. is given, only the acidification of the soil is accelerated and a variety of essential components for growth cannot be efficiently absorbed. As a result, the yield in arable land would be sharply reduced. Therefore, it is necessary to improve plant growth environments such as soil improvement.

1. Korean Patent Publication No. 10-1974032 (Title of Invention: Complex mineral composition and manufacturing method for high-functional products) described that sulfur and a sulfur solution including a sulfur solvent is passed through a magnetizer to remove heavy metals such as lead and arsenic during magnetization to produce a processed product, and the product is dispersed in a high-functional hydrogen water clustered in nano-size, which was manufactured using a hydrogen generator, and then, minerals and saponin are further added thereto and mixed, thereby producing a complex mineral preparation. The above technology may have a role of restoring the degraded soil by providing minerals, however, has no function to promote plant growth by nitric oxide water, carbonated water and irradiation of quantum energy.

2. Korean Patent Publication No. 10-11379274 (Title of the invention: Nitric oxide-containing water production device with sterilization function) described that high electric field energy generated in the high-voltage discharge process is applied to the inhaled external air, covalent bonds of nitrogen (N2) molecules and oxygen (O2) molecules as air constituents are dissociated through electrochemical reaction such as dissociation, excitation, ionization, oxidation, reduction, etc. to thus generate nitric oxide (NO), and then, the generated NO is pressurized by a pressurizer, fed to a diffuser installed in water and injected into the water to dissolve the same so as to produce nitric oxide water. However, this technology does not have a function of irradiating quantum energy as well as the supply of carbonated water.

3. Korean Patent Publication No. 10-11613087 (title of invention: carbonated water production apparatus) described that, in a mixer including a branch pipe for water supply and a pipe for supplying carbon dioxide mounted on the inlet side while having a carbonated water discharge pipe, in which carbon dioxide is mixed with water and dissolved, at the outlet side, water is supplied to the (municipal) water supply pipe by a pressure of a pump, and carbon dioxide gas filled at high pressure is supplied to the carbon dioxide gas supply pipe by the self-pressure of the carbon dioxide gas, wherein a pressure ratio of the water supply pressure and the carbon dioxide gas supply pressure is adjusted in the range of 1:2 to 5, so that the carbon dioxide gas is dissolved in the supplied water in a compression and mixing way to produce carbonated water. However, this technology does not include nitric oxide and has no function of quantum energy irradiation.

In other words, the plant growth promoting device technology with irradiation of quantum energy that has been developed till now is incomplete in terms of efficiency and scalability due to the aforementioned problems. Further, with respect to activation of root nodule bacteria (rhizobium) by supplying nitric oxide to generate auxin, foliar fertilization with high concentration of carbon dioxide and nitric oxide, irradiation of quantum energy to roots and leaves of the plants to enhance the immunity of the plants while promoting the growth of plants, generation and irradiation of quantum energy with a wide range of applications while securing stability and durability, technologies have yet to be developed.

### SUMMARY OF INVENTION

### Technical Problem to be Solved

In order to achieve the above object, the plant growth promoting system with irradiation of quantum energy according to the present invention is established and may include: a discharge chamber in the form of a hollow structure, provided with an inner cylinder in which a discharge electrode is mounted on an inner surface of the chamber, and an outer cylinder in which a ground electrode is mounted on an outer surface of the chamber; an air FAN connected to the discharge chamber, which is used to inhale (or suck) an external air and remove dust therefrom, wherein the air FAN supplies the air free of dust into the discharge chamber by a pressing force of the air FAN, at the same time, applies a high voltage in the form of a pulsed electromagnetic field (PEMF) generated by a power supply to the discharge electrode and the ground electrode arranged to face each other inside the discharge chamber, so as to start discharge and form a high electric field electron energy band between the discharge electrode and the ground electrode, and wherein, in a process of passing the dust-free air through a filter by the pressing force of the air FAN in the above energy band, the high electric field electron energy is irradiated to air constituents, that is, oxygen molecules, nitrogen molecules, and water molecules in water vapor to dissociate the nitrogen molecules and oxygen molecules through electrochemical reaction such as dissociation, excitation, ionization, oxidation, reduction, etc., and generate nitric oxide (NO) through ionic coupling; a venture-ejector installed on a circulating aqueous solution supply pipe, wherein the nitric oxide is supplied to a neck of the venture-ejector by a pump and mixed with the aqueous solution, variable power in the form of a pulsed electromagnetic field (PEF) generated in a high-voltage pulse generator is supplied to the discharge electrode, the ground electrode and a trigger voltage electrode provided in the chamber to degas bubbles of nitric oxide contained in the aqueous solution, followed by first dissolution in the aqueous solution and providing the same to a first reactor; an additive storage tank in which a nitrogen-releasing source such as calcium phosphate, clay, fly ash, mica, lanthanide rare earths, enzymes, and soil microorganisms are stored, wherein any one or more among the above substances are selected and introduced to the first reactor, followed by irradiating a pulse quantum energy thereto so as to produce a nitric oxide water; another venture-ejector mounted on a circulation pipe, in which the aqueous solution is circulated by a circulation pump, wherein, after decompressing high-pressure carbon dioxide gas filled in a container to an appropriate pressure while adjusting the same to an appropriate flow rate, the gas is fed to a neck of the venture-ejector to admix the carbon dioxide gas with the aqueous solution, variable power in the form of a pulsed electromagnetic field (PEMF) generated in a high-voltage pulse generator is supplied to a discharge electrode, a ground electrode and a trigger voltage electrode provided inside a dissolver chamber so as to degas bubbles of the carbon dioxide gas contained in the aqueous solution, followed by first dissolution in the aqueous solution and supplying the same to a second reactor, wherein any one or more of the carbon dioxide-releasing substances, plant growth promoting substances and moisture fluctuation inhibitor substances are selected and then introduced into the second reactor, followed by irradiation of a pulse quantum energy as well as hydrolysis to thus produce a carbonated water containing carbon dioxide gas; a pulse quantum energy generator consisting of first and second quantum energy generating coils as well as the power supply, wherein two variable power supplies in the form of a pulsed electromagnetic field (PEMF) generated in the power supply are applied to the first and second quantum energy generating coils wound in opposite directions to each other so that two variable magnetic fields in the form of a pulsed electromagnetic field (PEMF) in opposite directions are irradiated and overlapped at 90° angle to a direction of current flow in the first and second quantum energy generating coils to generate the pulse quantum energy, wherein the nitric oxide is pressurized and injected to: underground of a soil at a predetermined depth; the ground surface; and roots of plants planted in a soil in a space, which is defined by predetermined horizontal length, vertical length and height to a predetermined height from the ground surface, and in which the plant growth promoting system is installed, followed by foliar fertilization on leaves of the plant, the carbonated water is pressurized and injected to the leaves of the plants, followed by foliar fertilization, and the quantum energy is irradiated to the ground surface and an aerial part of the ground to thus promote the growth of the plants.

### Technical Solution

In order to achieve this object, the plant growth promoting system with irradiation of quantum energy according to the present invention may include: a nitric oxide generator 110 that consists of a filter housing 111 in which a dust removal filter 111a is provided, an external air introduction FAN 112, a discharge chamber 113 in a hollow structure in which an outer cylinder 113a and an inner cylinder 113b are provided, a discharge electrode 114a disposed in a circumferential direction of an inner surface of the outer cylinder 113a, a ground electrode 114b disposed in a circumferential direction of an outer surface of the inner cylinder 113b, electric heaters 116a and 116b which are inserted into the discharge electrode 114a and the ground electrode 114b, a first power supply 115 for applying high-voltage power to the discharge electrode 114a and the ground electrode 114b, first and second power supplies 116c and 116d for applying power to the first and second electric heaters 116a and 116b, a pressurizer 117, and a venture-ejector 118 which is connected to a circulation pump 152 of a first reactor;

a nitric oxide dissolver 120 that consists of a high-voltage pulse generator 121, as well as discharge electrodes 122a and 122b, ground electrodes 123a and 123b and trigger voltage electrodes 124a and 124b, which are provided to be insulated inside a circulation pipe of the first reactor, a transformer 125, and conductive wires (126a, 126-1a, 126b, 126c), whereby bubbles containing nitric oxide are degassed and dissolved during discharge in water so as to produce first nitric oxide water while sterilizing bacteria in water and irradiating quantum energy;

a first additive feeder 130 that consists of storage tanks (131a, 131b, 131c, 131d), a feed pipe 132 which is connected to a lower portion of the storage tanks and disposed at one side of an upper portion of the first reactor, and a metering pump 133;

a first quantum energy generator 140 that consists of a drive motor 141, a shaft 141a made of an insulating material and connected to the drive motor 141, a shaft lower fixture 141b, a variable power supply 142, first magnetic field generating coils (143a, 143b, 143c), second magnetic field generating coils 144a and 144b, and a conductive wire 145;

a nitric oxide water supply means 160 in a rectangular parallelepiped shape having an inclined structure on a lower portion thereof, in which a circulation pipe 151 is installed on one part of the left side of the inclined lower portion, a circulation pump 152 is mounted on the circulation pipe, a discharge pipe 153 on one part of a lower right side, a drain pipe 154 is provided on the bottom surface, a (municipal) water supply pipe 155 is mounted on one part of an upper right side, another circulation pipe 151 is mounted on one side of a top surface, the drive motor 141 of the first quantum energy generator 140 is provided in the center at an interval, the additive feed pipe 132 is disposed at an interval, a nitric oxide concentration detector 511 is installed at an interval, the shaft 141a made of an insulating material connected to the drive motor 141 and the shaft lower fixture 141b are installed therein, and the first reactor 150 is provided therein and consists of a plurality of first magnetic field generating coils (143a, 143b, 143c) and second magnetic field generating coils (144a, 144b) while being apart from each other on the insulating material shaft 141a, and these coils receive power from the variable power supply 142 installed on the outside, wherein any one or more substances among a nitrogen-releasing source, clay, fly ash, mica, lanthanide rare earths, enzymes and soil microorganisms is introduced to the firstly prepared nitric oxide water so as to produce a second nitric oxide water containing the same;

a carbon dioxide gas (CO2) feeder 210 that consists of a container (bombe) 211 filled with carbon dioxide gas at high pressure, a pressure regulator 212, an electric heater 213, a flow control valve 214, a feed pipe 215, and a venture-ejector 216;

a carbon dioxide gas dissolver 220 that consists of a high-voltage pulse generator 221, discharge electrodes 222a and 222b, ground electrodes 223a and 223b, trigger voltage electrodes 224a and 224b, a transformer 225, and conductive wires (226a, 226-1a, 221b and 226c),

wherein bubbles containing carbon dioxide gas are degassed and dissolved during discharge in water to produce a first carbonated water while sterilizing aquatic bacteria and irradiating quantum energy;

a second additive feeder 230 that consists of storage tanks (231a, 231b, 231c), a feed pipe 232 and a metering pump (233);

an electrolysis device 240 that includes an electrolyzer 245 consisting of a DC power supply 241, a positive (+) electrode 242, a negative (−) electrode 243 and a conductive wire 244, as well as a second quantum energy generator 249 consisting of a first cusp coil 245, a second cups coil 248 and a power supply 248, thereby embracing a pulse quantum energy generator that performs an electrolysis reaction while irradiating an aqueous solution with quantum energy;

a carbonated water supply means 260 in a rectangular parallelepiped shape having an inclined structure on a lower portion of the main body, in which a circulation pipe 251 is installed on one part of the left side of the inclined lower portion of the main body, a circulation pump 252 is mounted on the circulation pipe 251, a carbon dioxide gas feeder 210 is provided at an interval, a dissolver 220 is provided at an interval, a discharge pipe 253 is mounted on one part of a lower right side, a drain pipe 254 is provided on the bottom surface, a water supply pipe 255 is mounted on one part of an upper right side, another circulation pipe 251 is mounted on one side of a top surface, the additive feed pipe 232 is provided at an interval, a carbonated water concentration detector 512 is provided at an interval, the positive (+) electrode 242 and the negative (−) electrode 243 of the first electrolyzer are installed inside, and a second reactor 250 is provided therein, in which the first cusp coil 246 and the second cusp coil 247 receiving power from the power supply 248 of the second quantum energy generator 249 are installed on the outside at an interval so as to perform electrolysis while irradiating the firstly prepared carbonated water with quantum energy, wherein any one or more substances among carbon dioxide gas-releasing substances such as aromatic carboxylic acid, plant growth promoting substances such as auxin, and moisture fluctuation inhibitors is introduced to produce a second carbonated water containing the same;

a third quantum energy generator 310 that includes a power supply unit 315 consisting of an AC power generator 311, AC/DC converter 312, DC/DC converter 313 and a control unit 314 involving a pulse width modulation (PWM) control way and functions of pulse frequency modulation (PFM), pulse frequency (density) modulation (PDM) and pulse repetition rate (PRR) control, as well as first and second quantum energy generating coils 441 and 442, wherein the power in the form of a pulsed electromagnetic field (PEMF) produced by the power supply unit 315 is applied to the first and second quantum energy generating coils 441 and 442, which are disposed in a space 410 where the plant growth promotion system is installed, to generate, overlap and extinct the pulsed electromagnetic field (PEMF) in opposite directions to produce pulse quantum energy, and the produced pulse quantum energy is irradiated to: a soil for planting the plant in the space 410 where the plant growth promoting system is installed; the plant planted in the soil; and the nitric oxide water and the carbonated water injected to the soil and the plants for fertilization and foliar fertilization;

a fourth quantum energy generator 320 that includes a power supply device 327 consisting of: a power supply unit 321 comprising an AC power supply 321a or a DC power supply (DC: battery) 322b; AC/DC converter 322; an automatic supply power switch 323 (ATS); a low frequency generation/output unit 324; a switching element 325; and a control unit 326 involving a pulse width modulation (PWM) control way and functions of pulse frequency modulation (PFM), pulse frequency (density) modulation (PDM) and pulse repetition rate (PRR) control, as well as a second quantum energy generator 320, wherein the power in the form of a pulsed electromagnetic field (PEMF) applied from the power supply device 327 is applied to the first and second quantum energy generating coils 441 and 442, which are disposed in the space 410 where the plant growth promotion system is installed, to generate, overlap and extinct the pulsed electromagnetic field (PEMF) in opposite directions to produce pulse quantum energy, and the produced pulse quantum energy is irradiated to: the soil for planting the plant in the space 410 where the plant growth promoting system is installed; the plant planted in the soil; and the nitric oxide water and the carbonated water injected to the soil and the plants for fertilization and foliar fertilization;

a fifth quantum energy generator 330 that includes a power supply device 339 consisting of: a power supply 331; a switch power supply 332; a micro-controller 333; a capacitor 334; a pulse shaper 335; a pulse phase time controller 336; a voltage level converter 337; and a switch HEXFET 338, as well as the first quantum energy generating coil 441 and the second quantum energy generating coil 442, wherein the power in the form of a pulsed electromagnetic field (PEMF) applied from the power supply device 339 is applied to the first and second quantum energy generating coils 441 and 442, which are disposed in the space 410 where the plant growth promotion system is installed, to generate, overlap and extinct the pulsed electromagnetic field (PEMF) in opposite directions to produce pulse quantum energy, and the produced pulse quantum energy is irradiated to: the soil for planting the plant in the space 410 where the plant growth promoting system is installed; the plant planted in the soil; and the nitric oxide water and the carbonated water injected to the soil and the plants for fertilization and foliar fertilization, and wherein any one among the above quantum energy generators is selected and used as a quantum energy irradiation device 300 to irradiate quantum energy;

the space 410 which is defined by predetermined horizontal length, vertical length and height to a predetermined height from the ground surface and in which the plant growth promoting system is installed, as well as underground of the soil at a predetermined depth and the ground surface;

a nitric oxide water and nitric oxide-containing water supply means 420 that consists of a pressure pump 421, a feed pipe 422, an electromagnetic valve 423 and an injection nozzle 424, wherein the firstly prepared nitric oxide water or the secondly prepared nitric oxide water containing any one or more substances among a nitrogen-releasing source, clay, fly ash, mica, lanthanide rare earths, enzymes and soil microorganisms is supplied to the space 410 in which the plant growth promoting system is installed;

a carbon dioxide gas and carbonated water supply means 430 that consists of a pressure pump 431, a feed pipe 432, an electromagnetic valve 433 and an injection nozzle 434, wherein the firstly prepared carbonated water or the secondly prepared carbonate water containing any one or more substances among carbon dioxide-releasing substances such as aromatic carboxylic acid, plant growth promoting substances such as auxin, and moisture fluctuation inhibitors is supplied to the space 410 in which the plant growth promoting system is installed; and

a quantum energy generator 400 that consists of any one power supply selected among the above first, second and third quantum energy generation power supplies (315, 327 and 339), as well as the first quantum energy generating coil 441 and the second quantum energy generating coil 442, wherein quantum energy is irradiated to: the soil for planting the plant in the space 410 where the plant growth promoting system is installed; the plant planted in the soil; and the nitric oxide water and the carbonated water injected to the soil and the plants for fertilization and foliar fertilization, and may further include a control panel 500.

### Effect of Invention

According to the plant growth promoting system of the present invention, nitric oxide containing mineral substances, enzyme substances and soil microorganisms may be pressurized and injected to roots of plants planted in a soil of a space in which the plant growth promoting system is installed while performing foliar fertilization to leaves of the plants, in addition, a carbonated water containing plant growth promoting substances and moisture fluctuation inhibitors is pressurized and injected to the leaves of the plant while performing foliar fertilization and irradiating the ground surface and an aerial part of the ground, thereby attaining effects of promoting plant growth.

### BRIEF DESCRIPTION OF DRAWINGS

FIG. 1 is a schematic diagram showing the overall configuration of a plant growth promoting system with irradiation of quantum energy according to the present invention.

FIG. 2 is a cross-sectional view showing a nitric oxide generator of the plant growth promoting system with irradiation of quantum energy, as shown in FIG. 1.

FIG. 3 is a cross-sectional view showing a nitric oxide dissolver of the plant growth promoting system with irradiation of quantum energy, as shown in FIG. 1.

FIG. 4 is a cross-sectional view showing an additive feeder of the plant growth promoting system with irradiation of quantum energy, as shown in FIG. 1.

FIG. 5 is a cross-sectional view illustrating a quantum energy irradiator of the plant growth promoting system with irradiation of quantum energy, as shown in FIG. 1, and a first reactor embracing the quantum energy irradiator therein.

FIG. 6 is a cross-sectional view showing a power supply of the quantum energy irradiator of the plant growth promoting system with irradiation of quantum energy, as shown in FIG. 1.

FIG. 7 is a cross-sectional view showing a carbon dioxide gas feeder of the plant growth promotion system with irradiation of quantum energy, as shown in FIG. 1.

FIG. 8 is a cross-sectional view showing a carbon dioxide gas dissolver of the plant growth promotion system with irradiation of quantum energy, as shown in FIG. 1.

FIG. 9 is a cross-sectional view showing an additive feeder of the plant growth promotion system with irradiation of quantum energy, as shown in FIG. 1.

FIG. 10 is a cross-sectional view showing an electrolyzer of the plant growth promotion system with irradiation of quantum energy, as shown in FIG. 1, and a second reactor embracing the electrolyzer therein.

FIG. 11 is a cross-sectional view showing a power supply of the electrolyzer of the plant growth promotion system with irradiation of quantum energy, as shown in FIG. 10.

FIG. 12 is a cross-sectional view showing a third quantum energy generator of the plant growth promotion system with irradiation of quantum energy, as shown in FIG. 1.

FIG. 13a is a cross-sectional view showing a fourth quantum energy generator of the plant growth promotion system with irradiation of quantum energy, as shown in FIG. 1.

FIG. 13b is a cross-sectional view showing a fifth quantum energy generator of the plant growth promotion system with irradiation of quantum energy, as shown in FIG. 1.

FIG. 14 is a cross-sectional view showing a space configuration in which the plant growth promotion system shown in FIG. 1 is constructed.

FIG. 15 is a cross-sectional view showing a control panel of the plant growth promoting system shown in FIG. 1.

### DETAILED DESCRIPTION OF PREFERRED EMBODIMENTS OF INVENTION

Hereinafter, embodiments of the present invention will be described in detail with reference to the accompanying drawings. First, when adding reference numerals to the constituent elements of each drawing, embodiments of the present invention to the same constituent elements will be described in detail with reference to the accompanying drawings. It should be noted that the same components have the same reference numerals as much as possible even though they are indicated on different drawings. Further, in describing the present invention, if it is determined that a detailed description of a related known configuration or function may obscure the gist of the present invention, the detailed description thereof will be omitted. In addition, although preferred embodiments of the present invention will be described below, the technical spirit of the present invention is not limited thereto and may be of course practiced by those skilled in the art.

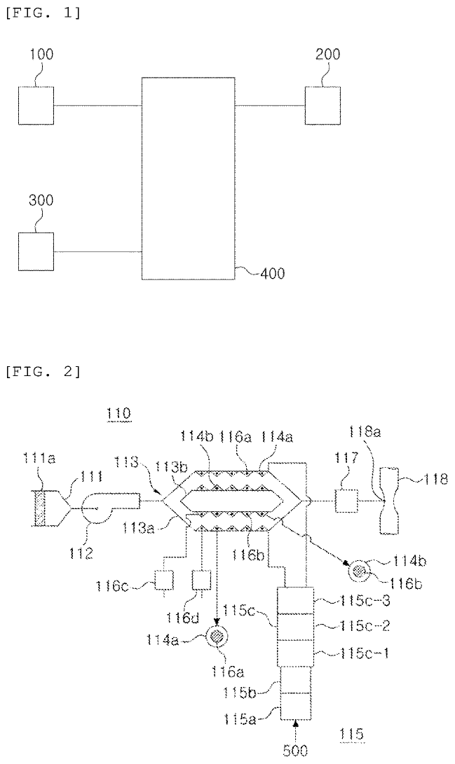

FIG. 1 is a schematic diagram showing the overall configuration of a plant growth promotion system with irradiation of quantum energy according to the present invention.

When described with reference to the accompanying drawing,

the plant growth promoting system with irradiation of quantum energy may include: a nitric oxide generator 110 that consists of a filter housing 111 in which a dust removal filter 111a is provided, an external air introduction FAN 112, a discharge chamber 113 in a hollow structure in which an outer cylinder 113a and an inner cylinder 113b are provided, a discharge electrode 114a disposed in a circumferential direction of an inner surface of the outer cylinder 113a, a ground electrode 114b disposed in a circumferential direction of an outer surface of the inner cylinder 113b, electric heaters 116a and 116b which are inserted into the discharge electrode 114a and the ground electrode 114b, a first power supply 115 for applying high-voltage power to the discharge electrode 114a and the ground electrode 114b, first and second power supplies 116c and 116d for applying power to the first and second electric heaters 116a and 116b, a pressurizer 117, and a venture-ejector 118 which is connected to a circulation pump 152 of a first reactor;

a nitric oxide dissolver 120 that consists of a high-voltage pulse generator 121, as well as discharge electrodes 122a and 122b, ground electrodes 123a and 123b and trigger voltage electrodes 124a and 124b, which are insulated inside a circulation pipe of the first reactor, whereby bubbles containing nitric oxide are degassed and dissolved during discharge in water so as to produce first nitric oxide water while sterilizing bacteria in water and irradiating quantum energy;

a first additive feeder 130 that consists of storage tanks (131a, 131b, 131c, 131d), a feed pipe 132 which is connected to a lower portion of the storage tanks and disposed at one side of an upper portion of the first reactor, and a metering pump 133;

a first quantum energy generator 140 that consists of a drive motor 141, a shaft 141a made of an insulating material and connected to the drive motor 141, a shaft lower fixture 141b, a variable power supply 142, first magnetic field generating coils (143a, 143b, 143c), second magnetic field generating coils 144a and 144b, and a conductive wire 145;

a nitric oxide water supply means 160 in a rectangular parallelepiped shape having an inclined structure on a lower portion thereof, in which a circulation pipe 151 is installed on one part of the left side of the inclined lower portion, a circulation pump 152 is mounted on the circulation pipe 151, a discharge pipe 153 on one part of a lower right side, a drain pipe 154 is provided on the bottom surface, a water supply pipe 155 is mounted on one part of an upper right side, another circulation pipe 151 is mounted on one side of a top surface, the drive motor 141 of the first quantum energy generator 140 is provided in the center at an interval, the additive feed pipe 132 is disposed at an interval, a nitric oxide concentration detector 511 is installed at an interval, the shaft 141a made of an insulating material connected to the drive motor 141 and the shaft lower fixture 141b are installed therein, and the first reactor 150 is provided therein and consists of a plurality of first magnetic field generating coils (143a, 143b, 143c) and second magnetic field generating coils (144a, 144b) while being apart from each other on the insulating material shaft 141a, and these coils receive power from the variable power supply 142 installed on the outside, wherein any one or more substances among a nitrogen-releasing source, clay, fly ash, mica, lanthanide rare earths, enzymes and soil microorganisms is introduced and mixed so as to produce a second nitric oxide water containing the same;

a carbon dioxide gas (CO2) feeder 210 that consists of a container (bombe) 211 filled with carbon dioxide gas at high pressure, a pressure regulator 212, an electric heater 213, a flow control valve 214, a feed pipe 215, and a venture-ejector 216;

a carbon dioxide gas dissolver 220 that consists of a high-voltage pulse generator 221, discharge electrodes 222a and 222b, ground electrodes 223a and 223b, trigger voltage electrodes 224a and 224b, a transformer 225, and conductive wires (226a, 226-1a, 221b and 226c), wherein bubbles containing carbon dioxide gas are degassed and dissolved during discharge in water to produce a first carbonated water while sterilizing aquatic bacteria and irradiating quantum energy;

a second additive feeder 230 that consists of storage tanks (231a, 231b, 231c), a feed pipe 232 and a metering pump (233);

an electrolysis device 240 that includes an electrolyzer 245 consisting of a DC power supply 241, a positive (+) electrode 242, a negative (−) electrode 243 and a conductive wire 244, as well as a second quantum energy generator 249 consisting of a first cusp coil 245, a second cups coil 248 and a power supply 248, thereby embracing a pulse quantum energy generator that performs an electrolysis reaction while irradiating an aqueous solution with quantum energy; a carbonated water supply means 260 in a rectangular parallelepiped shape having an inclined structure on a lower portion of the main body, in which a circulation pipe 251 is installed on one part of the left side of the inclined lower portion of the main body, a circulation pump 252 is mounted on the circulation pipe 251, a carbon dioxide gas feeder 210 is provided at an interval, a dissolver 220 is provided at an interval, a discharge pipe 253 is mounted on one part of a lower right side, a drain pipe 254 is provided on the bottom surface, a water supply pipe 255 is mounted on one part of an upper right side, another circulation pipe 251 is mounted on one side of a top surface, the additive feed pipe 232 is provided at an interval, a carbonated water concentration detector 512 is provided at an interval, the positive (+) electrode 242 and the negative (−) electrode 243 of the first electrolyzer are installed inside, and a second reactor 250 is provided therein, in which the first cusp coil 246 and the second cusp coil 247 receiving power from the power supply 248 of the second quantum energy generator are installed on the outside at an interval so as to perform electrolysis while irradiating the aqueous solution with quantum energy, wherein any one or more substances among carbon dioxide gas-releasing substances such as aromatic carboxylic acid, plant growth promoting substances such as auxin, and moisture fluctuation inhibitors is introduced to produce a second carbonated water containing the same;

a third quantum energy generator 310 that includes a power supply unit 315 consisting of an AC power generator 311, AC/DC converter 312, DC/DC converter 313 and a control unit 314 involving a pulse width modulation (PWM) control way and functions of pulse frequency modulation (PFM), pulse frequency (density) modulation (PDM) and pulse repetition rate (PRR) control, as well as first and second quantum energy generating coils 441 and 442, wherein the power in the form of a pulsed electromagnetic field (PEMF) produced by the power supply unit 315 is applied to the first and second quantum energy generating coils 441 and 442, which are disposed in a space 410 where the plant growth promotion system is installed, to generate, overlap and extinct the pulsed electromagnetic field (PEMF) in opposite directions to produce pulse quantum energy, and the produced pulse quantum energy is irradiated to: a soil for planting the plant in the space 410 where the plant growth promoting system is installed; the plant planted in the soil; and the nitric oxide water and the carbonated water injected to the soil and the plants for fertilization and foliar fertilization;

a fourth quantum energy generator 320 that includes a power supply device 327 consisting of: a power supply unit 321 comprising an AC power supply 321a or a DC power supply (DC: battery) 322b; AC/DC converter 322; an automatic supply power switch 323 (ATS); a low frequency generation/output unit 324; a switching element 325; and a control unit 326 involving a pulse width modulation (PWM) control way and functions of pulse frequency modulation (PFM), pulse frequency (density) modulation (PDM) and pulse repetition rate (PRR) control, as well as a second quantum energy generator 320, wherein the power in the form of a pulsed electromagnetic field (PEMF) applied from the power supply device 327 is applied to the first and second quantum energy generating coils 441 and 442, which are disposed in the space 410 where the plant growth promotion system is installed, to generate, overlap and extinct the pulsed electromagnetic field (PEMF) in opposite directions so as to produce pulse quantum energy and irradiate the pulse quantum energy; a fifth quantum energy generator 330 that includes a power supply device 339 consisting of: a power supply 331; a switch power supply 332; a micro-controller 333; a capacitor 334; a pulse shaper 335; a pulse phase time controller 336; a voltage level converter 337; and a switch HEXFET 338, as well as the first quantum energy generating coil 441 and the second quantum energy generating coil 442, wherein the power in the form of a pulsed electromagnetic field (PEMF) applied from the power supply device 339 is applied to the first and second quantum energy coils 441 and 442, which are disposed in the space 410 where the plant growth promotion system is installed, to generate, overlap and extinct the pulsed electromagnetic field (PEMF) in opposite directions to produce pulse quantum energy, and the produced pulse quantum energy is irradiated to: the soil for planting the plant in the space 410 where the plant growth promoting system is installed; the plant planted in the soil; and the nitric oxide water and the carbonated water injected to the soil and the plants for fertilization and foliar fertilization, and wherein any one among the above quantum energy generators is selected and used as a quantum energy irradiation device 300 to irradiate quantum energy;

the space 410 which is defined by predetermined horizontal length, vertical length and height to a predetermined height from the ground surface and in which the plant growth promoting system is installed, as well as underground of the soil at a predetermined depth and the ground surface; a nitric oxide water and nitric oxide-containing water supply means 420 that consists of a pressure pump 421, a feed pipe 422, an electromagnetic valve 423 and an injection nozzle 424, wherein the nitric oxide water containing any one or more substances among a nitrogen-releasing source, clay, fly ash, mica, lanthanide rare earths, enzymes and soil microorganisms is supplied to the space 410 in which the plant growth promoting system is installed; a carbon dioxide gas and carbonated water supply means 430 that consists of a pressure pump 431, a feed pipe 432, an electromagnetic valve 433 and an injection nozzle 434, wherein the carbonated water containing any one or more substances among carbon dioxide-releasing substances such as aromatic carboxylic acid, plant growth promoting substances such as auxin, and moisture fluctuation inhibitors is supplied to the space 410 in which the plant growth promoting system is installed; and

a quantum energy generator 400 that consists of any one power supply selected among the above first, second and third quantum energy generation power supplies (315, 327 and 339), as well as the first quantum energy generating coil 443 and the second quantum energy generating coil 444, wherein quantum energy is irradiated to: the soil for planting the plant in the space 410 where the plant growth promoting system is installed; the plant planted in the soil; and the nitric oxide water and the carbonated water injected to the soil and the plants for fertilization and foliar fertilization, in addition, further comprising a control panel 500.

FIG. 2 is a cross-sectional view showing a nitric oxide (gas) generator of the plant growth promoting system with irradiation of quantum energy. When described in reference to the accompanying drawing, the nitric oxide (gas) generator 110 may consist of a filter housing 111 in which a dust removal filter 111a is provided, an external air introduction FAN 112, a discharge chamber 113 in a hollow structure in which an outer cylinder 113a and an inner cylinder 113b are provided, a discharge electrode 114a disposed in a circumferential direction of an inner surface of the outer cylinder 113a, a ground electrode 114b disposed in a circumferential direction of an outer surface of the inner cylinder 113b, electric heaters 116a and 116b which are inserted into the discharge electrode 114a and the ground electrode 114b, a first power supply 115 for applying high-voltage power to the discharge electrode 114a and the ground electrode 114b, first and second power supplies 116c and 116d for applying power to the first and second electric heaters 116a and 116b, a pressurizer 117, and a venture-ejector 118.

When power is supplied from the control panel 500 to the external air introduction FAN 112, the FAN 112 is operated to introduce external air into the filter housing 111 by a suction force to thus remove dust in the air while passing the filter 111a. Then, the air is fed into the discharge chamber 113 in a hollow structure shape composed of the inner cylinder 113a and the outer cylinder 113, which forms a flow path. In the power supply 115 that consists of a step-up transformer 115a, a rectifier circuit 115b, a control unit 115c comprising an input module (115c-1), an operation module (115c-2) and a control module (115c-3) involving a pulse width modulation (PWM) control way and functions of pulse frequency modulation (PFM), pulse frequency (density) modulation (PDM) and pulse repetition rate (PRR) control, when 60 Hz AC power with single-phase 220V is supplied to the step-up transformer 115a, the step-up transformer 115a may be in the range of the single-phase 1 to 300 KV. When variable power in the form of a pulsed electromagnetic field (PEMF) generated while being adjusted to the range of 1 to 500 KHz is supplied to the discharge electrode 114a and the ground electrode 114b wound with a predetermined number of turns in the opposite direction to a winding direction of the discharge electrode 114a, a variable magnetic field in the form of a pulsed electromagnetic field (PEMF) in different directions may be generated at an angle of 900 to a current flow direction. Therefore, in the central portion between the discharge electrodes 114a and 114b, the variable magnetic field in the pulsed electromagnetic field (PEMF) form may be overlapped and extinct to thus produce pulse quantum energy in a zero magnetic field state, which in turn, initiates discharge and forms a high electric field electron energy band. Then, when power is supplied from the power supply 116c to a first electric heater 116a, which is present in the discharge electrode 114a and is wound in the same direction as the winding direction of the discharge electrode 114a and, at the same time, power is supplied from the power supply 116d to a second electric heater 116b, which is present in the ground electrode 114b and is wound in the same direction as the winding direction of the ground electrode 114b, a magnetic field may be formed in the first electric heater 116a and the second electric heater 116b at an angle of 90° to the current flow direction, so that magnetic fields in opposite directions to each other may overlap and extinct in the middle portion between the discharge electrodes 114a and 114b to thus produce pulse quantum energy in a zero magnetic field state, which in turn heats the discharge electrodes 114a and 114b so as to improve discharge efficiency owing to inflow of heat energy. By a pressing force of the FAN 112, air flowing between the discharge electrodes 114a and 114b may be discharged by receiving application of high electric field electron energy through a high-voltage generator 115, and an electrochemical reaction with the introduced indoor air may be implemented as follow, provided that electric and electronic energy denotes “e” while M refers to Na, K, Ca or Mg.

First, the dissociation reaction consists of the following steps.

1) e+O2→O+O+e

2) e+N2→N+N+e

3) e+O2→O−+O

Further, the ionization reaction consists of the following steps.

1) e+N2→N+N++2e

2) e+N2→N2++2e

3) e+O2→O+O++2e

4) e+O2→O2++2e

Further, the oxidation reaction consists of the following steps.

1) e+O2→O+O

2) O+NO+M→NO2+M

3) O+H2O→OH+OH

4) OH+NO2→HNO3

Further, the reduction reaction consists of the following steps.

1) e+N2→e+N+N

2) N+NO→N2+O

Activated gases such as nitric oxide (NO), nitrogen dioxide (NO2), and hydroxyl ion (OH-radical) ions are generated by the oxidation reaction.

In the electrochemical reaction process, OH radical active species generation reaction sterilizing airborne bacteria consists of the following steps, wherein water molecules are dissociated and generated from water vapor in the air.

1) e+H2O→H++OH−

2) e+H2O→H+OH+e

3) O+H2O→2OH−

As described above, after pressurizing clean air, in which hydroxyl ions (OH-radical) generated by dissociation of the water molecules of the water vapor are introduced, by a pressurizer 127 while sterilizing bacteria and airborne viruses in the clean air, the pressurized air is supplied to the neck 118a of the venture-ejector 118, injected into a circulating water circulated by the circulation pump 152, and admixed in the form of bubbles in water, followed by supplying the same into a dissolver 120.

Further, the discharge electrode (positive (+) electrode) 114a and the ground electrode (negative (−) electrode) 114b may be formed using any one selected from stainless steel (STS304, 316La, 403, etc.) containing tungsten, titanium, nickel and chromium, constantine alloy, molybdenum disilicide, platinum, cobalt alloy and hastalloy. In order to improve discharge efficiency on the surface of the discharge electrode, any one or more among catalysts such as titanium dioxide (TiO2), platinum (Pt), manganese dioxide (MnO2), zirconium silicate (ZrSiO4), lithium hydroxide (LiOH), palladium (Pd) and rhodium (Rh) is preferably selected and coated.

Further, the discharge electrode (124a, 124b) is implemented in any morphology of flat plate, equilateral triangle, square, rectangle, polygon, circle, cone, pyramid, spring, stud bolt, etc. Further, another implementation method is to combined different shapes such as square, triangle, rectangle, cone, pyramid, etc. Further, it may be implemented as other shapes having processed on the outer side in the form of a triangular screw, a square screw, or a round screw.

Further, the high-voltage generator 115 involves a pulse width modulation (PWM) control way and functions of pulse frequency modulation (PFM), pulse frequency (density) modulation (PDM) and pulse repetition rate (PRR) control, may configured in a fixed type in which input voltage and output voltage are present to appropriate values, and a variable type in which the input voltage is fixed while the output voltage, frequency and rated capacity may be arbitrarily adjustable, wherein the input voltage is direct current (DC) 12V or higher or alternating current (AC) 110V or higher, while the secondary output voltage to supply variable power in the form of a pulsed electromagnetic field (PEMF) may be the electric field energy (Ie, eV) which can break the covalent bond of oxygen molecules (O2) in the air; 12.0857 eV or higher, electric field energy (Ie, eV) which can break the covalent bond of nitrogen molecules (N2); 15.58 eV or higher, and electric field energy (Ie, eV) which can break the covalent bond of water molecules (H2O); 12.621 eV or higher.

Therefore, with regard to the high-voltage generator 125 of the present invention, the input side voltage is a DC current (DC) of 12V or more and an AC current voltage of 110V or more, while the output side variable voltage in the form of a pulsed electromagnetic field (PEMF) is a DC voltage (DC) and an alternating voltage (AC) in the range of 1 to 300 KV. Further, the variable frequency (Hz) at the output side in the form of a pulsed electromagnetic field (PEMF) may be in the range of 1 to 500 KHz for alternating current (AC).

For this purpose, the variable voltage V at the output side in the form of a pulsed electromagnetic field (PEMF) of the high-voltage generator 115 may be in the range of 1 to 300 KV, while the variable frequency at the output side in the form of a pulsed electromagnetic field (PEMF) may be selected in the range of 1 to 500 KHz so as to set the voltage and the frequency. Further, as the rated capacity (W, A), a fixed high-voltage generator arbitrarily selected with appropriate capacity according to preset conditions, or a variable high-voltage generator with adjustable voltage, frequency and capacity may be used.

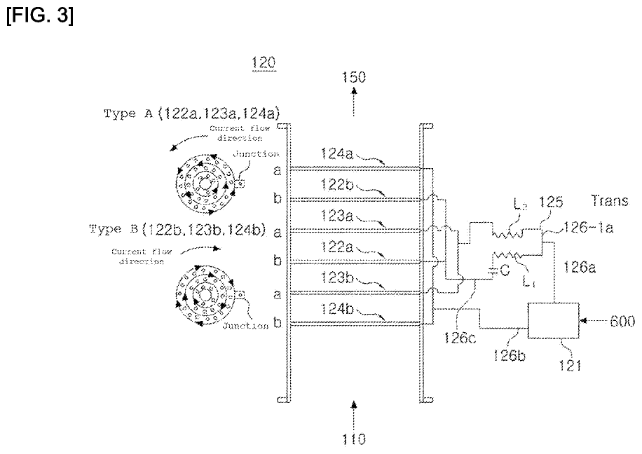

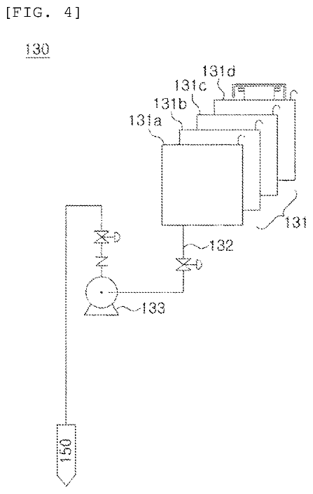

FIG. 3 is a cross-sectional view showing a nitric oxide dissolver of the plant growth promoting system with irradiation of quantum energy. When described with reference co the accompanying drawing, the nitric oxide dissolver 120 may consist of the high-voltage pulse generator 121, the discharge electrodes 122a and 122b, the ground electrodes 123a and 123b, the trigger electrodes 124a and 124b, the transformer 125, the conductive wires (126a, 126-1a, 126b, 126c).

As shown in FIG. 3, a morphology of each of the discharge electrodes 122a and 122b, the ground electrodes 123a and 123b, and the trigger electrodes 124a and 124b may be entirely in a disk-shape and processed in the form of a solenoid coil modified to have a predetermined width by a modeling process through a laser, wherein a plurality of holes having a predetermined diameter may be formed by drilling a disk-shaped plane having a predetermined diameter to in the circumferential direction so that the circulating water can pass through, and wherein a second electrode 124b of the trigger electrodes, a second electrode 123b of the ground electrodes, a first electrode 122a of the discharge electrodes, a first electrode 123a of the ground electrodes, a second electrode 122b of the discharge electrodes, and a first electrode 124a of the trigger electrodes are insulated and aligned inside a housing in this order from the bottom to the top while being spaced from one another at intervals such that the processed coils of the adjacent electrodes (facing each other) may be arranged in opposite directions to each other. For example, the second electrode 124b of the trigger electrodes is arranged to be spaced apart from the inner lower end at a predetermined height, the second electrode 123b of the ground electrodes is arranged in the upper direction at an interval, the first electrode 122a of the discharge electrodes is arranged in the upper direction at an interval, the first electrode 123a of the ground electrodes is arranged in the upper direction at an interval, the second electrode 122b of the discharge electrodes is arranged in the upper direction at an interval, and the first electrode 124a of the trigger electrodes is arranged in the upper direction at an interval such that the processing directions of the adjacent coils are opposed to each other.

The high voltage generated by the high-voltage pulse generator 121 may be applied to the discharge electrodes 122a and 122b, the ground electrodes 123a and 123b, and the trigger voltage electrodes 124a and 124b, one conductive wire 126a at the output side of the high-voltage pulse generator 121 may be connected to the ground electrodes 123a and 123b via a secondary inductor L2 of the transformer 125, while the other conductive wire 126b may be connected to a primary terminal and a secondary terminal of the capacitor c while interposing a primary inductor L1 of the transformer 125 therebetween, thereby being connected to the discharge electrodes 122a and 122b.

The other output conductive wire 126b of the high-voltage pulse generator 121 may be connected to the trigger electrode electrodes 124a and 124b. When power is supplied to the high-voltage pulse generator 121 from the control panel 500 and a pulsed electromagnetic field (PEMF) with a positive (+) potential is applied to an output line 126a of the high-voltage pulse generator 131, the capacitor c may be gradually charged by the primary side inductor L1. In this regard, when a trigger voltage is generated to the secondary side inductor L2 by a change in current so that pulse energy is transferred between the trigger voltage electrodes 124a and 124b and the ground electrodes 123a and 123b, and high voltage in the form of a pulsed electromagnetic field (PEMF) is applied to the discharge electrodes 122a and 122b, a magnetic field in the form of a pulsed electromagnetic field (PEMF) may be generated in opposite directions at an angle of 90° to a current flow direction. Further, magnetic fields in the form of a pulsed electromagnetic field (PEFM) in opposite directions may overlap and extinct in the middle of the second electrode 124b of the trigger electrodes and the second electrode 123b of the ground electrodes, in the middle of the second electrode 123b of the ground electrodes and the first electrode 122a of the discharge electrodes, in the middle of the first electrode 122a of the discharge electrodes and the first electrode 123a of the ground electrodes, in the middle of the first electrode 123a of the ground electrodes and the second electrode 122b of the discharge electrodes, and in the middle of the second electrode 122b of the discharge electrodes and the first electrode 124a of the trigger electrodes to thus produce pulse quantum energy in a zero magnetic field state, which is irradiated while occurring free discharge in water.

This free discharge may cause a main discharge between the discharge electrodes 122a and 122b and the ground electrodes 123a and 123b. Further, the trigger voltage is generated only when the capacitor c is charged.

In the case of discharge occurring by two electrodes of the discharge electrodes 122a and 122b and the ground electrodes 123a and 123b, such main charge does not occur in the discharge electrode 122 and the ground electrode 123 if a large breakdown voltage (that is, a large high-voltage pulse) is not applied.

However, since the nitric oxide dissolver 120 has the trigger voltage electrodes 124a and 124b, the main discharge can be initiated even at a small breakdown voltage (i.e., a small high-voltage pulse). Once the main discharge occurs, it becomes the same level as the high-voltage pulse.

It is a simple structure to generate a high-voltage pulse voltage and a trigger voltage from the high-voltage pulse generator 131 using LC series circuit.

The output voltage of the high-voltage pulse generator 121 is appropriately selected within the range of 1 to 300 KV, and the current value is selected within the range of 0.1 to 50 A with the selected appropriate voltage.

Further, a pulse repetition rate (number of pulses per unit time; PRR) is selected within the range of 20 Hz to 10 KHz with the selected appropriate voltage, and a pulse width is selected within the range of 1 to 5 ms with the selected appropriate voltage. Power output under the above conditions may directly be applied to the trigger electrodes 124a and 124b through one conductive wire 126b, while the other conductive wire 126a may be connected to the transformer 125. Further, one conductive wire (126-1a) of the transformer 125 may be applied to the ground electrodes 123a and 123b via an inductor L2, while the other conductive wire 126c of the transformer 125 may be connected to a primary terminal of the capacitor c while interposing the primary inductor L1 of the transformer 125 therebetween. Further, through the conductive wire 126c connected to the secondary terminal, the power may be applied to the discharge electrodes 122a and 122b whereby discharge is initiated between the discharge electrodes 122a and 122b, the ground electrodes 123a and 123b, and the trigger electrodes 124a and 124b.

According to measurement data transmitted to a real-time control unit 50 by a bubble detection sensor (not shown), the output voltage of the high-voltage pulse generator 121 may be adjusted in the control unit 500. If the bubble breakage rate does not reach a set target value, the pulse voltage or pulse repetition rate should be increased. On the other hand if the target value is raised, the pulse voltage and the pulse repetition rate should be adjusted downward.

Further, magnetic field and magnetic field generated by the discharge electrodes 122a and 122b, the ground electrodes 123a and 123b, and the trigger voltage electrodes 134a and 134b overlap and extinct to produce pulse quantum energy, and nitric oxide bubbles are efficiently destroyed through irradiation of the pulse quantum energy so as to improve a dissolution rate of nitric oxide in water and activate dissolved nitric oxide water.

Further, the irradiation of pulse quantum energy may bring about electric disturbance to nitric oxide water and electric polarization to thus induce (generate) a quantum wave field so that water molecules have electrostatic traction, interference phenomenon (inter-stimulation between plants) at long distances may occur, hydrogen bonds and covalent bonds between water dipoles may be partially dissociated to form a small group water in a “microcluster” structure, and the nitric oxide water primarily prepared in a process of treatment to form a high-order coherent domain state may be activated.

Further, the materials of the discharge electrodes 122a and 122b, the ground electrodes 123a and 123b and the trigger voltage electrodes 124a and 124b may be one or more selected among stainless steel (STS304), titanium, hastalloy, iron, copper, aluminum, tin, etc.

When the output power with output voltage, output current, pulse repetition rate and pulse width preset in advance in the high-voltage pulse generator 121 is applied to the discharge electrodes 122a and 122b, the ground electrodes 123a and 123b, and the trigger voltage electrode 124a and 124b through conductive wires to transfer pulse energy between the discharge electrodes 122a and 122b, the ground electrodes 123a and 123b and the trigger voltage electrode 124a and 124b and initiate discharge, shock wave may occur due to discharge and, at the same time, bubbles containing nitric oxide gas flowing into the neck portion 128a of the venture-ejector 128 passing between the discharge electrodes 122, 124 and 123 may be destroyed by the discharge shock wave, and the shock wave due to a water hammer pressure generated while destroying the bubbles may effectively destroy the bubbles. Although there may be a problem of absorbing the discharge shock wave in reverse depending on a size of the bubbles, bubbles with a large particle diameter of about 1.0 mm or more may absorb the discharge shock wave before the bubbles are destroyed to thus reduce the size of the bubbles to 1.0 mm or less.

Herein, the bubble-breaking water hammer pressure is a pressure generated in water when destroying the bubbles.

Further, the bubble may not only extend a discharge distance, but also destroy bubbles with the discharge shock wave.

Although large and small bubbles are mixed in the bubbles, if an average particle diameter is 1 mm or less, the above-mentioned “synergistic effects of water hammer pressure to become discharge shock wave again” and “air bubble atmosphere with an average particle diameter of 1 mm or less” are applied, therefore, the “synergistic effects of water hammer pressure to become discharge shock wave again” may occur.

Further, bubbles or plasma are generated between both electrodes during discharge. Plasma leaves ions or radicals as residues. Since a high-voltage pulse is applied to both electrodes at 20 Hz or higher, the ions and radicals may be used for the next discharge before these extinct. In this case, the ions and radicals extend a discharge distance beyond bubbles.

Further, with regard to destruction of bubbles of the same particle size, as the discharge distance increases, the high-voltage pulse generator 121 also becomes ultra-high voltage and high current, and the generator becomes large. On the other hand, as the discharge distance decreases, the generator may become high-voltage pulse and low voltage, may have low cost and reduced noise, and may safely and efficiently destroy air bubbles.

Further, as the number of micro-bubbles with small particle diameters in the water increases, the discharge distance may be extended when the same discharge voltage is applied to the discharge electrodes 122, 124 and 123, thereby improving the bubble-breaking ability. The high voltage generated by the high-voltage pulse generator 121 is initially discharged between the discharge electrodes 122a and 122b, the ground electrodes 123a and 123b, and the trigger voltage electrodes 124a and 132b through the conductive wire 126a, etc. to thus destroy bubbles containing nitric oxide passing through the discharge electrodes 122, 124 and 123, so that nitric oxide gas is released and dissolved in water to produce first nitric oxide water, hydroxyl ions (OH−) contact a bacterial cell membrane to destroy the same and perform sterilization, the bacteria in water become extinct again by a water hammer pressure generated while breaking excess nitric oxide bubbles, and oxygen atoms (O) and oxygen ions (O2*) are dissolved in the water to increase a dissolved oxygen concentration (DO) in water.

Further, as the smaller the particle size of the bubbles containing the active gas and as there are more bubbles in the same volume of water, the greater the discharge effects between the discharge electrodes 122, 124 and 123, the number of contacting with the bacteria in the water increases, and the water hammer pressure generated when breaking the bubbles may further improve a sterilization rate of bacteria in the water.

Further, when the output power with output voltage, output current, pulse repetition rate and pulse width preset in advance in the high-voltage pulse generator 121 is applied to the discharge electrodes 122a and 122b and the ground electrodes 123a and 123b, through conductive wires (126(126-1a, 126c), pulse energy may be transferred between the discharge electrodes and the ground electrodes 122 and 123 to induce additional voltage V across a cell membrane of the bacteria in water. Then, when a sum of accumulated potentials exceeds a threshold voltage in the range of 200 mmV to 1V, pores (transmembrane pore. P) begin to be formed in the cell membrane and, if cells are exposed for a longer time when the cell membrane potential is above the threshold value, perforation may cause influx of extracellular ions, which in turn leads to loss of homeostasis and subsequent apoptosis, resulting in irreversible cell death.

Disclosed is a method of extinction (destroy) of a cell membrane through electroporation, in which high voltage generated by a high-voltage generator is applied to a discharge electrode.

It can be inferred from the microbial removal process of Zimmerman's research result s. Zimmerman has disclosed a research result & #56194;& #56402; if there is a potential difference of about 1 Volt around a cell membrane of microorganisms, a microorganism membrane is under dielectric breakdown, and contents of the cell flow out of the cells to extinct microorganisms. & #56194;& #56403; (Zimmerman, U., G. Pilwat, and F. Eiemann, “Dielectric Breakdown of cell membrane”, Biophys. J. 1974 November; 14 (11):88199).

Electroporation refers to the fact that the plasma membrane of a cell exposed to a high-voltage pulsed electric field becomes temporarily permeable due to destabilization of the lipid bilayer and formation of pores (p) within certain specific parameters.

The cell plasma membrane consists of a lipid bilayer approximately 5 nm thick (t).

The cell membrane essentially acts as a non-conductive dielectric barrier forming a capacitor. Even in the absence of an applied electric field due to physiological conditions, a potential difference naturally occurs due to a charge separation phenomenon formed across the cell membrane between the inside and outside of the cell membrane.

When a high voltage is applied to the discharge electrodes 122a and 122b and the ground electrodes 123a and 123b in the high-voltage pulse generator 121 of the nitric oxide dissolver 120, additional voltage (V) may be induced across the cell membrane as long as the electric field exists. The induced voltage is directly proportional to the intensity of an external electric field and a radius of the cell. When a sum of the potentials accumulated in the cell exceeds the threshold voltage between 200 mV and 1 V, it begins to form pores in the cell membrane.

If the potential of the cell membrane does not exceed a critical value and a pore area is small compared to the entire cell membrane surface, perforation of the cell membrane may become reversible. In this reversible electroporation method, when the applied electric field is removed, the cell membrane is restored to its original state, and the cell remains in a viable state. When cells are exposed for a longer period of time with the cell membrane potential above the threshold value, the perforation may cause an influx of extracellular ions, which in turn leads to loss of homeostasis and subsequent apoptosis, resulting in irreversible cell death.

Nitric oxide is first dissolved in water, and the circulating water after sterilization of bacteria is supplied to the first reactor 150 by the circulation pump 152.

FIG. 4 is a cross-sectional view showing the additive feeder of the first reactor shown in FIG. 2, and will be described with reference to the accompanying drawing, wherein the additive feeder 130 consists of storage tanks 131a, 131b, 131c, 131d, and a feed pipe 13 and a metering pump 133. The additive stored in the first storage tank 131a is a nitrogen monoxide (NO) releasing material that is hydroxide apatite (Ca10(PO4)10(OH)2) forming a diazenium diolate functional group by adding nitrogen monoxide, wherein a phosphate compound in apatite (Ca10(PO4)10(OH)2) may include, for example, calcium metaphosphate (Ca(PO3)2), phosphoric acid (H3Pa4), monosodium phosphate (NaH2PO4), dibasic sodium phosphate (Na2HPO4), primary potassium phosphate (KH2PO4), dibasic potassium phosphate (K2HPO4), monobasic ammonium phosphate (NH4H2PO4), dibasic ammonium phosphate ((NH4)2HPO4), etc., inorganic nitrogen sources may include, for example, urea, liquid urea ammonium nitrate, anhydrous ammonium, calcium nitrate, potassium nitrate, ammonium sulfate, ammonium thiosulfate, ammonium phosphate, liquid ammonium polyphosphate, and mixtures thereof. phosphate of any one selected from the above substances or any one among the inorganic nitrogen sources may be selected and used. When power is supplied to the metering pump 133 in the control panel, the metering pump 133 operates to inhale or suck and pressurize a nitric oxide-releasing substance stored in the storage tank 131a, and then, feeds the same to the first reactor 150 for preparation of nitric oxide through the feed pipe 132.

Further, as a mineral source stored in the second storage tank 131b, clay having the components shown in Table 1, which is mined in Hongseong, Chungcheongnam-do (in 00 Company);

TABLE 1
Composition and content of clay

| division | Ig loss | Sio₂ | Al₂O₃ | Fe₂O₃ | CaO | MgO | Na₂O | K₂O | TiO₂ | ZrO2 | P2O5 | Cr₂O₃ | MnO | C |
|---|---|---|---|---|---|---|---|---|---|---|---|---|---|---|
| enemy clay | 7.38 | 59.82 | 19.59 | 8.77 | 0.23 | 0.63 | 0.19 | 2.15 | 1.02 | — | 0.13 | — | — | — |

*Analyzed according to chemical analysis and test method of KS L 4007 (Chemical analysis method of clay)

mica with the components shown in Table 2 which is mined near Samcheok-si, Gangwon-do;

TABLE 2
Composition and content of mica

| | | Water- | Water- | Water- | | | | | Water- |
|---|---|---|---|---|---|---|---|---|---|
| | Total | soluble | soluble | soluble | Soluble | Soluble | Water- | Soluble | soluble |
| | nitrogen | phosphoric | potassium | silicic | lime | Goto | soluble | boron | molybdenum |
| Item | (%) | acid (%) | (%) | acid (%) | (%) | (%) | manganese (%) | (%) | (%) |
| content | 0.05 | 0.0002 | 0.009 | 0.17 | 0.13 | 0.017 | 0.0012 | 0.008 | 0.002 |

| | | | carddenium/ | | Ah | | | |
|---|---|---|---|---|---|---|---|---|
| | Soluble | Arsenic | mercury | Lead | Annual | Chromium | Copper | Nickel |
| Item | iron (%) | (mg/kg) | (mg/kg) | (mg/kg) | (mg/kg) | (mg/kg) | (mg/kg) | (mg/kg) |
| content | 0.0033 | 4.97 | 0.00 | 25.52 | 35.6 | 43.84 | 21.29 | 9.49 |

*Analysis agency: Eco-friendly Agricultural Food Safety Center Co. Ltd.

fly ash containing unburned carbon powder having the components shown in Table 3, which is collected from an electric dust collector installed at the rear end of a boiler in a domestic thermal power plant;

TABLE 3
Chemical composition of fly ash with high unburned carbon content

| | chemical composition | | | | | | | | | | |
|---|---|---|---|---|---|---|---|---|---|---|---|
| | SiO2 | AL2O3 | Fe2O3 | CaO | Na2O | K2O | SO3 | MgO | P2O5 | TiO2 | Ig loss |
| weight(%) | 42.05 | 20.06 | 7.27 | 4.73 | 1.52 | 1.13 | 0.53 | 1.17 | 0.60 | 1.27 | 19.20. |

a composition having the components shown in Table 3, in which the ash burned in an incineration facility is dissolved in hydrochloric acid and precipitated to recover sewage sludge recovered during the wastewater treatment process at a biological wastewater treatment plant of a domestic industry; or

TABLE 4
Composition of leachate obtained by dissolving incinerated
sewage sludge in hydrochloric acid (g/l)

| pH | Al | Mn | Fe | Na | Mg | P | S | K | Ca |
|---|---|---|---|---|---|---|---|---|---|
| 3.5 | 4.81 | 0.18 | 9.46 | 0.11 | 0.25 | 21.44 | 0.01 | 1.91 | 6.92 |

Among processed powders of conversion furnace slag or air cooled slag having the components shown in Table 4 discharged during steel production in the steelmaking process,

any one is selected and stored in the second storage tank.

TABLE 5
Conversion furnace slag, air cooled slag ingredients

| | chemical composition | | | | | | | |
|---|---|---|---|---|---|---|---|---|
| | SiO2 | Mg | Fe2O3 | Na2O | K2O | Ca | Al2O3 | TiO2 |
| weight % | 13.3 | 3.48 | 1.78 | 0.23 | 0.066 | 22.3 | 4.2 | 0.75 |

*Measuring method: ICP-OES

Further, the lanthanide rare earths stored in the storage tank 141b may include any one selected from scandium (Sc), yttrium (Y), lanthanum (La), cerium (Ce), praseodymium (Pr), neodymium (Nd), promethium (Pm), samarium (Sm), europium (Eu), gadolidium (Gd), terbium (Tb), dysprosium (Dy), holmium (Ho), erbium (Er), thulium (Tm), Ytterbium (Yb) and lutedium (Lu) and may be stored.

Rare earth (RE) literally means rare soil that is rare on Earth. Rare earth elements are stable even in dry air and have good thermal conductivity. Major mine materials from which the rare earth elements are detected may include monazite, bastnaesite, xenotime, etc.

The primary nutrient elements (mass consumption) of plants may include, for example, nitrogen (N), phosphorus (P) and potassium (K), wherein nutrients of phosphorous (P) and potassium (K) are provided. Secondary nutrients (consumption in small amounts) for plants are iron (Fe), sulfur (S), calcium (Ca), magnesium (Mg), etc.

Further, the enzyme stored in the third storage tank 131c may include, for example, any one selected from acetyl xylan esterase, allophanate hydrolase, alpha amylase, alpha mannosidase, alpha-L-arabinofuranosidase, alpha-L-rhamnosidase, amylase, amylo-alpha-1,6-leucosidase, arylesterase, bacterial alpha-L-rhamnosidase, carboxymuconolactone decarboxylase, catalase, catechol dioxygenase, cellulase, chitobiaase/beta-hexo-anidinase, Co dehydratase, CoA ligase, dexarboxylase, dienlactone hydrolase, deoxygenase, dismutase, dopa4,5-deoxygenase, esterase, group 4 glycosylhydrolase, glucanase, glucodextranase, glucosidase, glutathione, S-transferase, glycosylhydrolase, hyaluronidase, hydratase/decarboxylase, hydrogenase, hydrolase, isoamylase, laccase, levan sucraase/invertase, mandelate, racemase, mannosyl oligosaccharide glucokidase, meliviase, methanomicrobialespterin S-methyl transferase, methenyltetrahydro-methanopterin cyclohydrolase, methyl coenzyme M-reductase, methyl muconolactone-methyl-isomerase, monoxide additional enzyme, pectinesterase, periplasm pectinate lyase, peroxidase, phenolase, phenol oxidase, phenolic decarboxylase, phytanoyl-CpA deoxygenase, polysaccharide deacetylase, Flonase, reductase, tetrahydromethanopterin S-methyl group transferase, ceromoca glucanotransferase and tryptophan 2,3-deoxygenase, Candida, Torula, Hanseniaspora, Hansenula, Kluyveromyces, Metschnikowia, Pichia, Starmerella and Torulaspora, and then may be stored in the third tank 131c.

Since nitrogen fertilizers were discovered, these have been advantageously used to increase crop yields. For example, ammonium nitrate has an important application in agriculture, especially, in fertilization because of its high concentration of nitrates.

Several approaches have been tried to minimize the side effects of using chemical fertilizer while maintaining beneficial effects on plant growth. Microorganisms inhabiting in the area near the roots have been known to have beneficial effects on plant growth and crop productivity.

In fact, the microflora surrounding plants is very dense and includes especially bacteria, fungi, yeasts and algae.

These inactive yeasts stimulate some microbiota in the soil and may be used as crop protection products using yeast so as to enhance or accelerate steps of decomposition of organic nitrogen into mineral nitrogen that improves nitrogen supply by the soil, production of ammonia and nitrification thereof, thereby growing the plants.

Further, the soil microorganisms stored in the fourth storage tank 141d may include, for example, any one selected from Bacillus subtilis, Bacillus licheniformis, Bacillus mojavensis, Bacillus megaterium, Bacillus pumilus, Bacillus sp, Bacillus amyloliquefaciens Cellulomonas, Cellulomonas biazotea, Pseudomonas denipripicans, Paenibacillus polymyxa, Pseudomonas stutzeri, RhodoPseudomonas palustris, Nitrobacillus geogiensis, and then may be stored. Alternatively, one or more of a growth agent such as humic acids, fulvic acids, ulmic acids and humin may be included to form the soil microorganism.

Humic acid exists as carbonized insoluble sediment in its natural state, and the roles of humic acid may include chelation of cationic nutrient substances, cation exchange function, supply of useful active organic matter and trace elements, and the like. Humic acid has various effects such as increase germination and germination rate of plant seeds, reduction of toxicity of various harmful chemicals and heavy metals, improvement of soil structure, fertilization, growth stimulation effects through cell activity, strong chelating agent, soil pH adjuster, increase in effective oxygen content in soil, increase in osmotic ability of cell membrane, increase resistance to drought, root growth promotion, etc. Because of the above effects, humic acid may promote the growth of plants to remove different organic substances.

Humic acid may also maximize the activity of microorganisms.

Fulvic acid is a combination of a low molecular weight humic acid and a non-corrosive material. Compared to humic acid, a carbon content is small but an oxygen content is high.

Fulvic acid be combined wih Ca2+, Mg2+, Fe2+, Al3+, etc. to form a salt soluble in water.

When the material is supplied to the planted plant (foliar fertilization and root fertilization), the growth of soil microorganisms is activated by oxygen supply, while the soil microorganisms absorb and accumulate inorganic pollutants such as organic matter, heavy metals and radioactive substances into the body, so as to remove contaminants, thereby promoting plant growth.

Microorganisms are increased by the vigorous root activity of plants. In this regard, the roots of plants secrete soluble diffusion substances such as amino acids, aliphatics, amides, and sugars, which account for 10 to 20% of total photosynthesis, as well as mucilage, and provide a carbon source and an energy source necessary for the growth of microorganisms. Further, oxygen generated in photosynthesis is released through the roots to form aerobic conditions around the rhizosphere and, at this time, a great amount of oxygen is delivered to the soil microorganisms to promote decomposition activity thereof while maintaining the aerobic condition. In this case, the rhizosphere provides a good habitat for soil microorganisms and a significant number of microbial groups may be formed.

Minerals necessary for the growth of microorganisms may include elements, for example, iron (Fe), manganese (Mn), boron (B), zinc (Zn), molybdenum (Mo), copper (Cu), chlorine (Cl), silicon (Si), nitrogen (N), phosphorus (P), potassium (K), calcium (Ca), vanadium (V), alumina (Al), sodium (Na), nickel (Ni), cadmium (Cd), sulfur (S), magnesium (Mg), etc. nitric oxide and phosphoric acid compounds stored in the first storage tank 131a are supplied, any one of clay, mica, fly ash, converter slag, and lanthanide rare earth materials stored in the second storage tank 131b is selected and supplied in a trace amount, or any one enzyme is selected among enzymes such as acetyl xylan esterase stored in the third storage tank 131c, and then supplied in a trace amount.

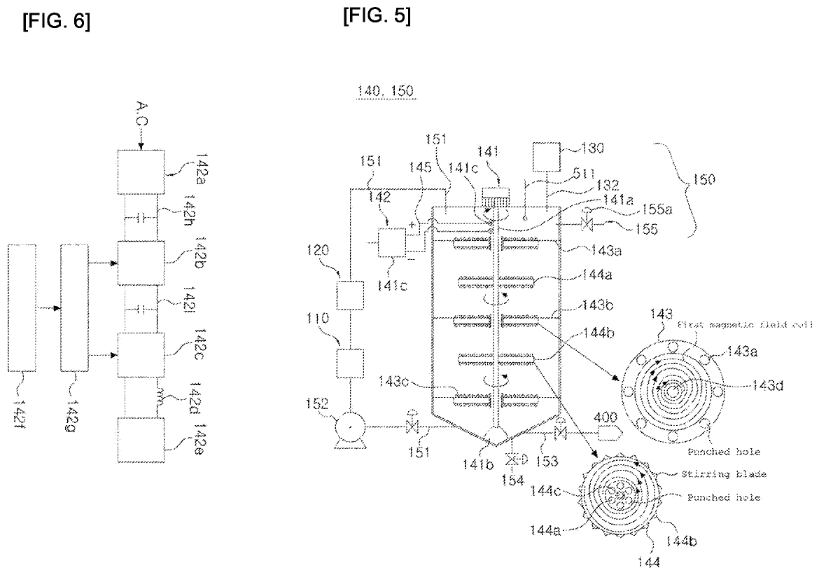

FIG. 5 is a cross-sectional view illustrating a quantum energy irradiator of the plant growth promoting system with irradiation of quantum energy, as shown in FIG. 1, and a first reactor embracing the quantum energy irradiator therein. When described with reference to the accompanying drawing, the first quantum energy generator 140 may include a drive motor 141, a shaft 141a in a hollow structure, a shaft lower fixture 141b, a first magnetic field generating coil 143, a second magnetic field generating coil 144 and the first magnetic field generating coil 143, which are mounted on the shaft 14a at intervals, and a power supply 142 for supplying power to the second energy generating coil 144. The first reactor 150 embracing the above first quantum energy generator 140 has a rectangular parallelepiped shape, wherein: a circulation pipe 151 is installed on one part of the lower left side of a main body 150 having an inclined lower portion; a circulation pump 152 is provided on the circulation pipe 151; a venture-ejector 118 having a venture neck 118a, into which nitric oxide is introduced, is installed at an interval; a dissolver 120 for firstly dissolving nitric oxide gas in water by a high-voltage pulse wave and quantum energy, which are generated by high-voltage discharge of nitric oxide bubbles in a fluid mixed with activated gas containing nitric oxide as well as a circulating water in the venture-ejector 118, is provided at an interval; a water supply pipe 155 is installed while spaced from the dissolver; another circulation pipe 151 connected to one side of an upper portion of the reactor 150 is provided; the drive motor 141 of the quantum energy generator is provided at an interval; a nitric oxide concentration detector 511 is provided at an interval; and an additive feed pipe 132 is installed at an interval. Further, at one part of the lower right side, a discharge pipe 153 for supplying carbonated water is provided in a space 410 in which the plant growth promoting system is installed, and a drain pipe 154 for discharging a deposit is mounted on the bottom side. Further, at one part of the upper left side, a power supply 142 of the quantum energy generator 140 is provided, a shaft 141a connected to the drive motor 141 of the first quantum energy generator is disposed in the inner center portion and inserted in a shaft fixture 141b mounted on an inner bottom of the first reactor 150. Further, the first and second quantum energy generating coils 143 and 144 in a disk shape having a predetermined diameter may be inserted in the shaft 141a, provided in plural at intervals and connected to the power supply 142 through a conductive wire 145.

The first quantum energy generating coil 143 may be prepared by: selecting any one material from copper, silver, platinum, titanium, and stainless steel (sts304) materials having a predetermined diameter; processing the material into a disk shape work-piece; drilling the work-piece from the edge to the center on a circumferential surface at intervals to form a plurality of aqueous solution flow holes 143a having a predetermined diameter; drilling the work-piece in the center portion to form a hole 143d having a predetermined diameter into which the shaft 141a is inserted; processing a space between the aqueous solution flow hole 143a and the center hole 143d for shaft insertion (front and back surfaces) into a modified solenoid coil shape, a troid coil shape or a Helm-Heltz coil shape using a laser modeling technique, followed by insulation; or, attaching a coil, which is formed by winding a conductive metal wire made of copper, nickel, etc. having a predetermined diameter around the space between unprocessed aqueous solution flow hole 143a and the center hole 143d for shaft insertion (front and back surfaces) with a predetermined number of turns such that the coil faces each of insulating layers on the front and back surfaces of the metal disk, followed by insulating the entire portion of the coil with an insulating material such as Teflon acetal, acrylic, etc., or an epoxy resin, and then installing the same on the shaft 141a.

The second quantum energy generating coil 144 may be prepared by: selecting any one material from copper, silver, platinum, titanium, and stainless steel (sts304) materials having a predetermined diameter, wherein the diameter and cross-sectional area are reduced by 20 to 30% compared to the first quantum energy generating coil 143; processing the material into a disk shape work-piece; providing a plurality of turbine type stirring blades 144b on a circumferential surface at an angle of 60 to 90° (vertical) at the end surface of an edge of the work-piece; drilling the work-piece in the center portion to form a hole 144c having a predetermined diameter into which the shaft 144a is inserted, and also drilling the work-piece around the circumferential surface to form a plurality of aqueous solution flow holes 144a having a predetermined diameter at a distance from the hole 144c; processing a space between the aqueous solution flow hole 144a and the turbine type stirring blade 144b (both of front and back surfaces) into a modified solenoid coil shape, a troid coil shape or a Helm-Heltz coil shape using a laser modeling technique, followed by insulating the same with an insulating material such as Teflon acetal, acrylic, etc., or an epoxy resin; or insulating the space between the aqueous solution flow hole 144a and the turbine type stirring blade 144b (both of front and back surfaces) with the insulating material such as Teflon acetal, acrylic, etc., or an epoxy resin without processing, and then, attaching a coil, which is wound with a predetermined number of turns in a modified solenoid coil shape, a troid coil shape or a Helm-Heltz coil shape using any one material selected from copper, silver, platinum, titanium and stainless steel (STS304) materials such that the coil faces each of insulating layers on the front and back surfaces of the metal disk, followed by insulating the entire portion of the coil with an insulating material such as Teflon acetal, acrylic, etc., or an epoxy resin, and then installing the same on the shaft 141a.

The installation method of the first and second quantum energy generating coils 143 and 144 on the shaft 141a of the hollow structure is as follows: with regard to a plurality of disk-shaped first quantum energy generating coils 143 and second quantum energy generating coils 144, each having a hole perforated with a predetermined diameter in the center of the shaft 141a of the hollow structure, the first quantum energy generating coil 143a is provided from the upper portion to the lower portion in the first reactor 150 and the second quantum energy generating coil 144a is provided at a distance from the above first quantum energy generating coil, and the above coils are installed in plural in this order of installation; the above coils are installed such that a winding direction (processed direction) of the of the first quantum energy generating coil 143a and a winding direction (processed direction) of the second quantum energy generating coil 144a are opposed to each other and, after a sleeve (not shown) attached to the holes 143d and 144c perforated with a predetermined diameter in the center is fixed with a fixing bolt, a bearing type power contact part 141c is mounted on one side of the upper portion of the shaft 141a and connected to a positive (+) terminal at the output side of the power supply 142, is wired into the shaft 141a in a hollow structure through a perforated hole (not shown) in an airtight structure in the lower part of the power contact 141c, and is connected to the plurality of first quantum energy generating coils 143a, 143b and 143c, respectively; in the same manner, the bearing type power contact part 141c is mounted on one side of the upper portion of the shaft 141a, is connected to a negative (−) terminal at the output side of the power supply 142, is wired into the shaft 141a in a hollow structure through a perforated hole (not shown) in an airtight structure in the lower part of the power contact 141c, and is connected to the plurality of second quantum energy generating coils 144a and 144b.

Even when the drive motor is operated and the shaft 141a connected to the drive motor 141 is rotated, the wire is not wound but power is safely supplied to the first and second quantum energy generating coils (143a, 143b, 143c, 144a and 144b), thereby generating quantum energy.

The material of the first reactor 150 is any one selected and used from among materials such as stainless steel (STS304, STS316L), glass fiber molded foam (FRP), steel (SS400), and hastalloy.

Pipes used as the circulation pipe 151, the municipal water supply pipe 155, the discharge pipe 153 and the drain pipe 154 may be any one selected and used from a carbon steel pipe for pipeline (SPP; Carbon Steel Pipe), an arc welding carbon steel pipe for pipeline (SPW: Electric Arc Welded Carbon Steel Pipes), a pressure carbon steel pipe (SPPS: Carbon Steel Pipe for Pressure Service), an alloy steel pipes for pipeline (SPA: Alloy Steel Pipes), a stainless steel pipes for Pipeline (STSXT: Stainless Steel Pipes), a galvanized water supply pipe (SPPW: Galvanized Steel Pipe for Water Service), a plastic lining steel pipe, a copper pipe, a polyvinyl chloride pipe and a polyethylene pipe.

The pump 152 may be any one selected and used from a centrifugal pump, a positive displacement pump, a rotary pump, a volute pump, a gear pump and a turbine pump.

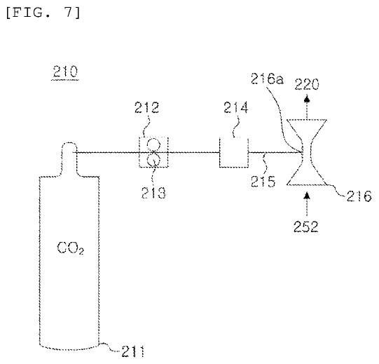

FIG. 6 is a cross-sectional view showing a power supply 142 of the quantum energy generator in the plant growth promoting system with irradiation of quantum energy, as shown in FIG. 1. With described with reference to the accompanying drawing, the power supply 142 may consist of a rectifier 142a, a converter 142b, an inverter 142c, a resonance reactor 142d, a pulse transformer 142e, a control unit 142f involving a pulse width modulation (PWM) control way and functions of pulse frequency modulation (PFM), pulse frequency (density) modulation (QDM) and pulse repetition rate (PRR) control, a gate driver 142g, first capacitor 142h and second capacitor 142i.

The rectifier 142a may convert an input single-phase 220V 60 Hz AC power into a DC voltage.

The converter 142b may boost the DC voltage converted from the AC power to the DC power in the rectifier 142a to a high voltage through a switching operation.

The inverter 142c may modulate the DC voltage boosted by the converter 142b into a pulsed electromagnetic field (PEMF) voltage.

The resonance reactor 142d may match the loads of the first and second quantum energy generating coils 143 and 144.

The pulse transformer 142e may boost the output voltage of the inverter 142c. In order to perform pulse amplitude modulation (PAM) of the switching output in the first and second quantum energy generating coils 143 and 144 and the inverter 142c, to which the output voltage of the pulse transformer 142e is applied, a signal for controlling the output voltage of the converter 142b is formed. Further, in order to control a quantum energy production amount by adjusting an intensity of the magnetic field generated in each of the first quantum energy generating coil 143 and the second quantum energy generating coil 144, the pulse transformer may further include a control unit 142f that forms a signal capable of pulse frequency (density) modulation independent of the amplitude of pulse, and a gate driver 142g that amplifies voltage of the control signal applied by the control 142f and applies the same to the converter 142b and the inverter 142c.

Iin this regard, the above power supply may include the first capacitor and the second capacitor, wherein the first capacitor 142h reduces the ripple of the voltage rectified by the rectifier 142a so as to input the voltage of the first capacitor 142h to the converter 142b, while the second capacitor 142i reduces the ripple of the DC voltage boosted through the converter 142b so as to input the voltage of the second capacitor 142i to the inverter 142c.

The rectifier 142a converts the supplied AC power into DC voltage. Then, after boosting the DC voltage by a switching operation in the converter 142b, the inverter 142c modulates the boosted DC voltage into a voltage in the form of a pulsed electromagnetic field (PEMF). Following this, the pulse transformer 142e boosts the output voltage of the inverter 142c to apply the same to the first and second quantum energy generating coils 143 and 144.

Further, since an input unit (not shown) is separately built inside the control unit 142f so that a user can input a current value, a voltage value, a frequency value, a power supply time and a stop time (timer function) to the input unit in order to provide the same to the first quantum energy generating coil 143 and the second quantum energy generating coil 144.

When power is supplied from the control panel 500 to the electromagnetic valve 155a mounted in the water supply pipe, the electromagnetic valve 155a is opened to fill the inside of the first reactor 150 with an appropriate amount of water, followed by supplying power to the circulation pump 155. When the circulation pump is operated to inhale and pressurize the aqueous solution inside the first reactor 150 and thus supplies the same to the venture-ejector 118, nitric oxide generated in the nitric oxide generator 110 may be pressurized and supplied to the neck 118a of the venture-ejector, and then, added to the aqueous solution passing through the venture-ejector 118. Then, the nitric oxide gas and the aqueous solution in a mixed fluid state may be supplied to the nitric oxide dissolver 120 by a pressing force of the circulation pump 152. When applied the high-voltage pulse (pulsed electromagnetic field: PEMF) with positive (+) potential, the capacitor c may be gradually charged by the primary inductor L1 and, due to a change in current in this time, trigger voltage is generated in the secondary inductor L2 so as to transfer pulse energy between the trigger voltage electrodes 124a and 124b and the ground electrodes 123a and 123b. When high voltage in the form of a pulsed electromagnetic field (PEMF) is applied to the discharge electrodes 122a and 122b, magnetic fields in the form of a pulsed electromagnetic field (PEMF) may be produced in opposite directions at an angle of 90° to a current flow direction. At this time, from the lower portion to the upper portion of the nitric oxide dissolver 120, the magnetic fields in the form of a pulsed electromagnetic field (PEMF) in opposite directions may overlap and extinct in the middle portion between the second electrode 124b of the trigger electrodes and the second electrode 123b of the ground electrodes, in the middle portion between the second electrode 123b of the ground electrodes and the first electrode 122a of the discharge electrodes, in the middle portion between the first electrode 122a of the discharge electrodes and the first electrode 123a of the ground electrodes, in the middle portion between the first electrode 123a of the ground electrodes and the second electrode 122b of the discharge electrodes, and in the middle portion between the second electrode 122b of the discharge electrodes and the first electrode 124a of the trigger electrodes to thus produce pulse quantum energy in a zero magnetic field state. During passing an area in which free discharge occurs in water, air bubbles containing nitric oxide are degassed and dissolved to prepare nitric oxide water and, at the same time, bacteria in the aqueous solution are sterilized in an electroporation manner. Further, during circulation to the inside of the first reactor 150, when power is supplied to the first and second quantum energy generating coils 143 and 144 from the power supply 142, magnetic fields may be generated at an angle of 90° to a current flow direction in the first and second quantum energy generating coils 143 and 144. Following this, the magnetic fields in the form of a pulsed electromagnetic field in opposite directions may overlap and extinct in the middle portion between the first and second quantum energy generating coils 143 and 144 to thus produce pulse quantum energy in a zero magnetic field state, which in turn is irradiated to the aqueous solution so as to activate the aqueous solution. At the same time, by rotation of the drive motor 141, a plurality of first and second quantum energy generating coils 143 and 144 mounted on the shaft 141a connected to the drive motor 141 may be rotated. Specifically, the second quantum energy generating coil 144 provided with a turbine type stirring blade may be installed, wherein a metal disk having the turbine type stirring blade attached to the edge thereof rotates to generate a strong turbulent flow. In this regard, nitrogen monoxide stored in the first storage tank 131a in the additive feeder 130 is introduced, followed by introducing a substance to form a diazenium dioleate functional group, other substances such as calcium phosphate, phosphoric acid (H3PO4), monosodium phosphate (NaH2PO4), etc. and stirring the same to thus prepare nitric oxide water with increased concentration.

Alternatively, mineral supply materials such as clay, mica scone, lanthanide rare earth, fly ash, etc. stored in the second storage tank 131b may be introduced while stirring, so as to prepare nitric oxide water containing minerals such as clay, mica stone, lanthanide rare earth, fly ash, etc.

Alternatively, enzyme materials such as acetyl xylan esterase stored in the third storage tank 131c may be introduced while stirring, so as to prepare nitric oxide water containing the enzyme material.

Alternatively, soil microorganisms such as bacillus subtilus stored in the fourth storage tank 131d may be introduced while stirring, so as to nitric oxide water containing the soil microorganisms.

Alternatively, the nitric oxide water prepared in the dissolver 120 may be subjected to introduction of any one or more materials among a material that forms a diazenium diolate functional group, a material such as calcium phosphate, phosphoric acid (H3PO4), monosodium phosphate (NaH2PO4), etc., minerals such as clay, mica, lanthanide rare earths, fly ash, etc., enzyme substances such as acetyl xylan esterase, and soil microorganisms such as Bacillus subtilus, or all materials thereof while stirring to prepare nitric oxide water containing the same. While stirring the prepared nitric oxide water up and down, at the same time, when power is supplied to the power supply 142 in the control panel 500 and thus variable power in the form of a pulsed electromagnetic field (PEMF) which has modified variable current, variable voltage and frequency satisfying data input in advance in an input unit of the power supply 142 is provided to a plurality of the first and second quantum energy generating coils 143 and 144, which are installed in opposite directions such that the coils facing each other are wound in opposite directions from each other, magnetic fields in a pulse form may be generated in the coils, respectively, at an angle of 90° to a current flow direction. Further, since the winding directions of the coils facing each other are opposed to each other, the electric fields in the form of a pulsed electromagnetic field (PEDF) are generated in opposite directions in the coils arranged to face each other to irradiate the magnetic field to the aqueous solution firstly, and then, the magnetic field in the form of a pulsed electromagnetic field (PEMF) may overlap and extinct in the center portion to thus produce pulse quantum energy in a zero magnetic field state. When the nitric oxide water prepared in the dissolver 120 or a nitric oxide water which contains any one or more materials among a nitrogen-releasing source, clay, fly ash, mica, lanthanide rare earths, enzymes and soil microorganisms or all materials is irradiated with the pulse quantum energy to bring about electrical disturbance and electric polarization in the nitric oxide water, thereby inducing (or causing) a quantum wave field. Further, a so-called “microcluster” phenomenon, in which hydrogen bonds between water dipoles are partially dissociated, may occur to allow a high degree of order and a small mass of water molecules, resulting in a coherent domain state.

Consequently, the nitric oxide water containing any one or more materials among a nitrogen-releasing source, clay, fly ash, mica, lanthanide rare earths, enzymes and soil microorganisms may be quickly absorbed into a soil in the space 410 where the plant growth promoting system is implemented, and into pores of roots and leaves of the plant when the roots and leaves of the plant planted in the soil are under fertilization and foliar fertilization, so that nutrients may be rapidly supplied to the leaves and roots, thereby promoting the growth thereof, while minimizing loss of the nutrients due to release into the atmosphere, flowing along with soil, washing out by rain water, etc.

*Source: A paper by Emilio Del Guidice, a scientist at the institute of Nuclear Physics in Milan, Italy.

In this regard, coherence is a physical term, meaning that two electric dipoles far apart from each other affect each other while oscillating.

FIG. 7 is a cross-sectional view showing a carbon dioxide gas feeder of the quantum energy generator in the plant growth promoting with irradiation of quantum energy, as shown in FIG. 1. When described with reference to the accompanying drawing, the nitric oxide gas may consist of a container (bombe) 211 filled with carbon oxide gas at a high pressure, a pressure regulator 212, an electric heater 213, a flow control valve (or flow regulator) 214, a feed pipe 215 and a venture-ejector neck 215a.

After mounting the pressure regulator 213 provided with a pressure gauge and the electric heater 212 on the container (bombe) 211 filled with carbon dioxide gas at a pressure of 120 kg/cm2 and provided by the carbon dioxide gas manufacturer, the feed pipe 215 is installed, the flow regulator 214 is mounted on one side of the feed pipe 215 and an outlet of the flow regulator 214 and the neck 216a of the venture-ejector 216 are connected by a pipeline.

When opening a main valve of the container 211 filled with carbon dioxide gas, high-pressure carbon dioxide gas of 120 kg/cm2 is fed to the pressure regulator 213 and, at the same time, heat generated by the electric heater 212 integrally installed with the pressure regulator 213 is used to heat the carbon oxide gas and to prevent freezing. At the same time, after reducing the pressure to 1 to 2 kg/cm2 and feeding the gas to the flow regulator 214 to regulate the flow rate to an appropriate value, the gas may be fed to the venture-ejector neck 216a through the pipeline 215, which in turn is supplied in a gaseous phase into the circulating water fed to the pipeline by the pump 252.

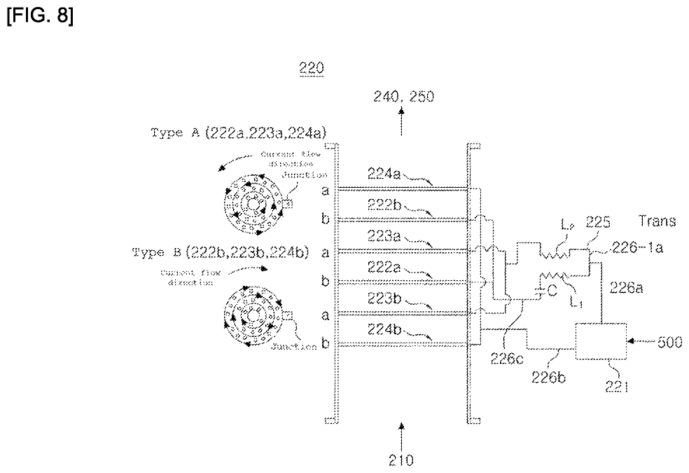

FIG. 8 is a cross-sectional view showing a carbon dioxide gas dissolver of the growth promotion system with irradiation of quantum energy as shown in FIG. 1. When described with reference to the accompanying drawing, the carbon dioxide dissolver 220 may consist of a high-voltage pulse generator 221, discharge electrodes 222a and 222b, ground electrodes 223a and 223b, trigger voltage electrodes 224a and 224b, a transformer 225, and conductive wires (226a, 226-1a, 221b and 226c).

All of the discharge electrodes 222a and 222b, the ground electrodes 223a and 223b, and the trigger voltage electrodes 224a and 224b, respectively, may have a disk shape. Specifically, each of the above electrodes is processed in a solenoid coil shape modified to have a predetermined width by a laser modeling process, followed by drilling a plane having a predetermined with to form a plurality of holes having a predetermined diameter in order to pass the circulating water through the holes. Further, the discharge electrodes 222a and 222b, the ground electrodes 223a and 223b or the trigger voltage electrodes 234a and 234b may be installed such that processed coils of the electrodes are arranged in opposite directions while insulating the inside of a flow path housing.

For example, the second electrode 224b of the trigger electrodes is installed at a predetermined height at the inner lower end of the dissolver 220 from the lower portion to the upper portion in the dissolver 220, the second electrode 223b of the ground electrodes is installed at an interval in the upper direction, the first electrodes 222a of the discharge electrodes is installed at an interval in the upper direction, the first electrode 223a of the ground electrodes is installed at an interval in the upper direction, the second electrode 222b of the discharge electrodes is installed at an interval in the upper direction, and the first electrode 224a of the trigger electrodes is installed in an interval in the upper direction, such that the winding directions of adjacent coils are opposed to each other

The high voltage generated by the high-voltage pulse generator 221 is applied to the discharge electrodes 222a and 222b, the ground electrodes 223a and 223b, and the trigger voltage electrodes 224a and 224b; a conductive wire 226-1a branched from one conductive wire 226a is connected to the ground electrodes 223a and 223b via the secondary inductor L2 of the transformer 225, and the other conductive wire 226c is coupled to a first terminal of the capactor c while interposing the primary inductor Li of the transformer 225 therebetween and is connected to the discharge electrodes 222a and 222b via the conductive wire 226c coupled to t a second terminal.

The other output wire 226b of the high-voltage pulse generator 221 is connected to the trigger electrodes 224a and 224b.

In the control panel 500 involving a pulse width modulation (PWM) way and functions of pulse frequency modulation (PFM), pulse frequency (density) modulation (PDM) and pulse repetition rate (PRR) control, when power is supplied to the high-voltage pulse generator 221, and when high-voltage pulsed electromagnetic field (PEMF) with positive (+) potential is applied to the output wire 226a of the high-voltage generator 221, the capacitor c may be gradually charged by the primary inductor L1. Due to a change in current at this time, trigger voltage occurs at the secondary inductor L2 and, therefore, when pulse energy is transferred to a space between the trigger voltage electrodes 224a and 224b and the ground electrodes 223a and 223b and high voltage in the form of a pulsed electromagnetic field (PEMF) is applied to the discharge electrodes 222a and 222b, magnetic fields in the form of a pulsed electromagnetic field (PEMF) may be generated in opposite directions at an angle of 900 to a current flow direction, and then, from the lower portion to the upper portion of the carbon oxide dissolver 220, the magnetic fields in the form of a pulsed electromagnetic field (PEMF) in opposite directions may overlap and extinct in the middle portion between the second electrode 224b of the trigger electrodes and the second electrode 223b of the ground electrodes, in the middle portion between the second electrode 223b of the ground electrodes and the first electrode 222a of the discharge electrodes, in the middle portion between the first electrode 222a of the discharge electrodes and the first electrode 223a of the ground electrodes, in the middle portion between the first electrode 223a of the ground electrodes and the second electrode 222b of the discharge electrodes, and in the middle portion between the second electrode 222b of the discharge electrodes and the first electrode 224a of the trigger electrodes to thus produce pulse quantum energy in a zero magnetic field state, which is irradiated while inducing free charge in water.

Due to the free discharge, main discharge may occur between the discharge electrodes 222a and 222b and the ground electrodes 223a and 223b. Further, the trigger voltage is generated only when the capacitor c is charged.

In the case of discharge from two electrodes of the discharge electrodes 222a and 222b, such main discharge does not occur in the discharge electrode 22 and the ground electrode if not applied a large breakdown voltage (that is, a large high-voltage pulse.

However, since the carbon dioxide dissolver 220 has the trigger voltage electrodes 224a and 224b, the main discharge may be initiated even at a small breakdown voltage (ie, a small high-voltage pulse). Once the main discharge occurs, it becomes the same level as the high-voltage pulse.

It has a simple structure that generates a high-voltage pulse voltage and a trigger voltage from the high-voltage pulse generator 231 using an LC series circuit.

The output side voltage of the high-voltage pulse generator 231 may be appropriately selected within the range of 1 to 300 KV, the current value may be appropriately selected within the range of 0.1 to 50 A, the pulse repetition rate (number of pulses per unit time; PRR) may be appropriately selected within the range of 20 Hz to 10 KHz, and the pulse width may be appropriately selected within the range of 1 to 5 ms. Under the above condition, the output power may be directly applied to the trigger electrodes 224a and 224b through one conductive wire 226b, while the other conductive wire 226a is connected to the transformer 225. Then, one conductive wire 226-1a of the transformer 225 may be applied to the ground electrodes 223a and 222b via the inductor L2, and the other conductive wire 226c of the transformer 225 may be coupled to a first terminal of the capacitor c while interposing the primary inductor Li of the transformer 225 therebetween and may be applied to the discharge electrodes 222a and 222b via the conductive wire coupled to a second terminal of the capacitor, thereby initiating discharge between the discharge electrodes 222a and 222b, the ground electrodes 223a and 223b, and the trigger electrodes 224a and 224b.

By the measurement data transmitted in real time to the control unit 500 by a bubble detection sensor (not shown), the control unit 500 may regulate output voltage of the high-voltage pulse generator 221. When a bubble breakage rate does not reach the set target value, the pulse voltage or pulse repetition rate may be increased. Further, if the target value is raised, the pulse voltage or pulse repetition rate may be adjusted downward.

Further, the pulse quantum energy produced by overlapping and extincting the magnetic fields, which are generated in the discharge electrodes 222a and 222b, the ground electrodes 223a and 223b, and the trigger voltage electrodes 224a and 224b, may be irradiated to efficiently destroy carbon oxide bubbles, thereby producing carbonated water and activating the produced carbonated water.

Further, pulse quantum energy irradiation may cause electric disturbance to the carbonated water and electric polarization to induce (generate) a quantum wave field, thereby imparting electrostatic traction to water molecules and causing interfere at a long distance (mutual stimulation between plants). Further, hydrogen bonds and covalent bonds between the water dipoles are partially dissociated to provide small group water in a “microcluster” structure, and the nitric oxide water firstly prepared in the treatment process may become activated to form a high-order coherent domain state.

The discharge electrodes 222a and 222b, the ground electrodes 223a and 223b and the trigger voltage electrodes 224a and 224b may be composed using any one or more materials selected among stainless steel (STS304), titanium, hastalloy, iron, copper, aluminum, tin, etc.

When the output voltage with the output current, pulse repetition rate and pulse width, which are preset in advance in the high-voltage generator 2211, is applied to the discharge electrodes 222a and 222b, the ground electrodes 223a and 223b, and the trigger voltage electrodes 224a and 224b via the conductive wires, and when pulse energy is transferred between the discharge electrodes 222a and 222b, the trigger voltage electrodes 224a and 224b, and the ground electrodes 223a and 223b to thus initiate discharge, a shock wave may be occur by the discharge and, at the same time, the bubbles containing the carbon dioxide gas flowing into the neck 226a of the venture-ejector 226 passing between the discharge electrodes 222, 224 and 223 may be destroyed by the discharge shock wave so that the bubbles can be efficiently destroyed by a shock wave due to a water hammer pressure generated at the breakage of bubbles. Although there may be a problem of absorbing the discharge shock wave in reverse depending on a size of the bubbles, with a boundary of the bubble size of about 1.0 mm, bubbles with a particle diameter of about 1.0 mm or less may generate the water hammer pressure and allow the discharge shock water to be active continuously, whereas bubbles with a large particle diameter of about 1.0 mm or more may absorb the discharge shock wave before the bubbles are destroyed, therefore, the size of bubbles should be maintained to 1.0 mm or less.

In this regard, the bubble-breaking water hammer pressure is a pressure generated in water when the bubble breaks.

Further, the bubble not only extends a discharge distance but also may destroy bubbles by discharge shock wave. At this time, synergistic effects in which the water hammer pressure generated at breakage of bubbles becomes the discharge shock wave again may be attained.

Although large and small bubbles are mixed in the bubbles, if the average particle diameter is 1 mm or less, the above-mentioned “synergistic effects of water hammer pressure to become discharge shock wave again” and “air bubble atmosphere with an average particle diameter of 1 mm or less” are applied, thereby attaining “synergistic effects of water hammer pressure to become discharge shock wave again”.

Further, during discharge, bubbles or plasma are generated between both electrodes. Plasma leaves ions or radicals as residues. Since a high-voltage pulse at 20 Hz or higher is applicable to both electrodes, ions and radicals may be used for the next discharge before extinction thereof. In this case, the ions and radicals extend the discharge distance beyond bubbles.

Further, in destroying bubbles of the same particle size, as the discharge distance is extended, the high-voltage pulse generator 231 also becomes ultra-high voltage and high current and the device becomes large. On the other hands, as the discharge distance is reduced, high-voltage pulse generator may become low voltage, low cost and low noise, and the air bubbles can be safely and efficiently destroyed.

Further, as there are more micro-bubbles with small particle diameters in water, the discharge distance may be extended when the same discharge voltage is applied to the discharge electrodes 222, 224 and 223, thereby improving the bubble breaking ability. High voltage generated by the high-voltage pulse generator 221 initiates discharge between the discharge electrodes 222a and 222b, the ground electrodes 223a and 223b, and the trigger voltage electrodes 224a and 224b through the conducting wires 226a, etc., which in turn, destroys bubbles containing the carbon dioxide gas passing through the discharge electrodes 222, 224 and 223 so that the carbon dioxide gas is released and dissolved into the water. Further, the water hammer pressure generated at the breakage of bubbles may allow extinction of the bacteria in the water again.

Further, when the smaller the particle size of the bubbles containing the carbon dioxide gas and when more micro-bubbles exist in the same volume of water, the greater the discharge effect between the discharge electrodes 222, 224 and 223, the number of contacting with the bacteria in the water increases, and the water hammer pressure generated at breakage of bubbles may further improve a sterilization rate of bacteria in the water.

Further, when the output power with the output voltage, output current, pulse repetition rate and pulse width preset in the high voltage pulse generator 222 is applied to the discharge electrodes 222a and 222b and the ground electrodes 223a and 223b through the conducting wire, pulse energy may be transferred between the discharge electrodes 222 and 223, and an additional voltage (V) may be induced across a cell membrane of aquatic bacteria. When a sum of accumulated potentials exceeds a threshold voltage in the range of 200 mmV to 1V, pores (transmembrane pore. P) begin to be formed in the cell membrane and, if cells are exposed for a longer time when the cell membrane potential is above the threshold value, perforation may cause influx of extracellular ions, which in turn leads to loss of homeostasis and subsequent apoptosis, resulting in irreversible cell death.

Disclosed is a method of extinction (destroy) of a cell membrane through electroporation, in which high voltage generated by a high-voltage generator is applied to a discharge electrode.

It can be inferred from the microbial removal process of Zimmerman's research results. Zimmerman has disclosed a research result & #56194;& #56402; if there is a potential difference of about 1 Volt around a cell membrane of microorganisms, a microorganism membrane is under dielectric breakdown, and contents of the cell flow out of the cells to extinct microorganisms. & #56194;& #56403; (Zimmerman, U., G. Pilwat, and F. Eiemann, “Dielectric Breakdown of cell membrane”, Biophys. J. 1974 November; 14(11):88199).

Electroporation refers to the fact that the plasma membrane of a cell exposed to a high-voltage pulsed electric field becomes temporarily permeable due to destabilization of the lipid bilayer and formation of pores (p) within certain specific parameters.

The cell plasma membrane consists of a lipid bilayer approximately 5 nm thick (t).

The cell membrane essentially acts as a non-conductive dielectric barrier forming a capacitor. Even in the absence of an applied electric field due to physiological conditions, a potential difference naturally occurs due to a charge separation phenomenon formed across the cell membrane between the inside and outside of the cell membrane.

When a high voltage is applied to the discharge electrodes 232a and 232b and the ground electrodes 233a and 233b in the high-voltage pulse generator 231 of the carbon dioxide gas dissolver 220, as long as the above electric field exists, an additional voltage (V) may be induced across the cell membrane. The induced voltage is directly proportional to an intensity of the external electric field and a radius of the cell. When the sum of the potentials accumulated in the cell exceeds the threshold voltage in the range of 200 mV to 1V, pores begin to be formed in the cell membrane.

If the potential of the cell membrane does not exceed a critical value and a pore area is small compared to the entire cell membrane surface, perforation of the cell membrane is reversible. In this reversible electroporation method, when the applied electric field is removed, the cell membrane is restored to its original state and the cell remains in a viable state. When cells are exposed for a longer period of time with the cell membrane potential above the threshold, perforation may cause an influx of extracellular ions, which in turn leads to loss of homeostasis and subsequent apoptosis, resulting in irreversible cell death.

The carbon dioxide gas is firstly dissolved in water, and the circulating water after bacteria sterilization is supplied to the second reactor 250 by the circulation pump 252.

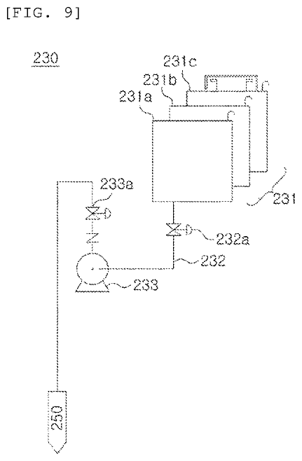

FIG. 9 is a cross-sectional view showing an additive feeder of the growth promotion system with irradiation of quantum energy as shown in FIG. 1. When described with reference to the accompanying drawing, the additive feeder 230 may consist of storage tanks 231a, 231b and 231c, a feed pipe 232 and a metering pump 233.

The additives stored in the first storage tank 231 may include: monocarboxylic acids such as HCOOH (methanoic acid (formic acid)), CH3COOH (ethanoic acid (acetic acid)), CH3CH2COOH (propionic acid); dicarboxylic acids such asHOOC(CH2))COOH (succinic acid), etc.; unsaturated aliphatic carboxylic acids such as CH3(CH2)14COOH (palmitic acid), CH3(CH2)16COOH (s-earic acid), CH3 (CH2)7CH═CH(CH2)7COOH (cis) (oleic acid), etc.; aromatic carboxylic acids (R—COOH) such as C6H5-COO (benzoic acid), C6H5(OH)COOH (salicylic acid), formic acid, butyric acid, butanoic acid, valeric acid, pentanoic acid, enantic acid, heptanoic acid, caprylic acid, octanoic acid, pelargonic acid, nonanoic acid, capric acid, decanoic acid, undecylic acid, undecanoic acid, lauric acid, dodecanoic acid, tridecylic acid, tridecanoic acid, myristic acid, teradecanoic acid, pentadecanoic acid, hexadecanoic acid, margalic acid, heptadecanoic acid, stearic acid, octadecanoic acid, arachidic acid, icosic acid, etc.; alkylene dicarboxylic acid (HOOC—(CH2)n-COOH) such as HOOC—COOH (oxalic acid), HOOCCH2COOH (malonic acid), propanedioic acid, succinic acid, butanedioic acid, glutaric acid, pentanedioic acid, adipic acid, hexanedioic acid, pimelic acid, heptanedioic acid, suberic acid, octanedioic acid, azelaic acid, nonandioic acid, sebacic acid, decanedioic acid, undecanedioic acid, dodecanedioic acid, etc.; aromatic dicarboxylic acids such as phthalic acid, benzene-1,2-dicarboxylic acid, o-phthalic acid, isophthalic acid, benzene-1,3-dicarboxylic acid, m-phthalic acid, terephthalic acid, benzene-1,4-dicarboxylic acid, p-phthalic acid, etc.; as well as any one or more materials selected from borax (Na2B407), sodium hexametaphosphate (NaPO3)6, potassium carbonate (K2C03), sodium: pyrophosphace (Na4P2O7), calcium carbonate (CaCO3), magnesium oxide (MgO), sodium molybdate (Na2MoO4), sodium silicate (Na2SiO3), sodium bicarbonate (NaHCO3), potassium bicarbonate (KHCO3), magnesium Bicarbonate (Mg(HCO3)2), calcium bicarbonate (Ca(HCO3)2) and potassium oxalate (K2C2O4), and then, may be stored in the first storage tank 241a.

Further, among natural auxin, synthetic auxin, auxin metabolite, auxin conjugate, auxin derivative and mixture (non-aqueous solution), auxin (AUXIN) and auxin (AUXIN) compounds such as indole-3-acetic acid, indole-3-butyric acid (IBA), indole-3-propionic acid, indole-3-acetic acid, phenylacetic acid, naphthalene acetic acid (NAA), 2,4-dichlorophenoxy acetic acid, 4-chloroindole-3-acetic acid, 2,4,5-trichlorophenoxy acetic acid, 2-methyl-4-trichlorophenoxyacetic acid, 2,3,6-trichlorobenzoic acid, ethylene, 4-amino-3,4,5-trichloro picoric acid, etc., or zeatin, various forms of zeatin such as N6-benzyl adenine, N6-(delta-2-isopentyl) adenine, 1,3-diphenyl urea, thidazuron, kinetin, cytokinin, cytokinin substances with activity, and other chemical formulations and mixtures thereof, or plant growth promoting substances such as gibberellin, abscisiccid, brassinosteroid, jasmonate, salicylic acid, peptides, strigolactone, etc. ected and stored among plant growth promoters such as strigolactone, any one or more materials may be selected and stored in the second storage tank 231b.

Further, any one or more substances among moisture fluctuation inhibitors such as sugars of a,a-trehalose, specifically, among carbohydrate derivatives of a,a-trehalose having a glucose polymerization degree of 3 to 6, for example: monoglucosyls such as a-maltosyl, a-glucoside, a-isomaltosyl, a-glucoside; diglucosyls such as a, a-trehalose, a-maltolyosyl, a-glucoside (alias: a-maltosyl, a, a-trehalose), a-maltosyl a-maltoside, a-isomalrosyl a-maltoside, a-isomaltosyl a-isomaltoside, etc.; triglucosyls such as a,a-trehalose, a-maltotetraosyl, a-glucoside (Alias: a-maltotriosyl, a, a-trehalose), a-maltosyl a-maltotrioside, a-panosyl a-maltoside, etc.; tetraglucosyls such as a,a-trehalose, a-maltopentaosyl a-glucoside (alias:: a-maltotetraosyl, a,a-trehalose), a-maltotriosy a-maltotrioside, a-panosyl a-maltotrioside, etc.; a,a-trehalose, and the like, may be selected and stored in the m Trehalose is a disaccharide composed of two linked glucose molecules, and is widely produced by plant insects and other organisms. This is produced in abundance by certain insects and sheep and plants but exists only in trace amounts in most plant species.

Until recently, mainly known biological activity of the above substance is that, when present at a relatively high natural abundance in cells of a specific organism, this substance may act as an antifreeze agent or an additive in a cryopreservation process. However, recent studies have demonstrated that trehalose acts as a very strong signaling molecule in plants even when present in small amounts (low concentrations) in plants.

Aqueous solutions containing trehalose or trehalose derivatives may act exogenously on crops as small concentrations of lightning and, instead of being accumulated in the storage organs of young daughter embryos as a whole, may perform movement of a significant amount of photosynthetic plants that would be lost to the waste pile of the parent plant carcasses till near the end of the growing season. Furthermore, according to signaling glycation, compared to perennial crops (e.g., fruits, nuts) that need a photosynthetic production amount required by the parent plants in order to complete a reproductive cycle of the attached daughter plants of very young embryos and embryonic storage organs, the photosynthetic products of annual plants (corn, potatoes, soybeans, etc.) may be completely and irreversibly transferred to the attached daughter plants in the most complete fashion, even to the point where the plants remain almost cellulosic carcasses of the parent. According to such a method as described above, annual yields are greatly increased at harvest so as to maximize crop production efficiency with respect to the already formed and readily available photosynthetic products.

This early application may result in healthier crops without diseases, wherein early decay leading to extinction is more helpful for health.

Moreover, the exogenous signaling molecule(s) may improve yield when applied at an early stage of crop growth.

Further, trehalose is possibly used as a central regulator of carbohydrate production and flow in plants. Partially, this signals carbohydrate availability to promote growth or potential yield. Further, this inhibits the activity of kinase SnRK1, thereby reducing major growth-limiting factors.

Further, trehalose may improve productivity and growth of crops surviving under severe environmental stress.

1. Borax (Na2B4O7) contains the element (B) absolutely necessary for the initial growth of crops, and is involved in the movement of carbohydrates and the formation of cell membranes;

2. Sodium hexametaphosphate (NaPO3)6 acts to transfer heat and decompose carbohydrates in plants, therefore, plant cells make sugar from carbon dioxide and water by chlorophyll and sunlight. This compound may increase sweet taste, accelerate the growth of roots and improve the growth of branches and leaves, resulting in an increase in yield.

3. Calcium carbonate (K2CO3) facilitates photosynthesis, water evaporation and control of water supply so as to increase resistance to the year, contributes to plant fiber production, and enhances plant cell composition.

4. Sodium pyrophosphate (Na4P2O7) is a nutrient that promotes germination, accelerates plant maturation, and enhances starch production ability.

5. Calcium carbonate (CaCO3) is a component of cell membranes, which neutralizes acid soil and adjusts soil reaction so as to promote the activity of soil microorganisms, and plays a major role in improving the soil environment suitable for plant growth.

6. Magnesium oxide (MgO) is a chlorophyll forming component, which is an indispensable element in green plants, specifically, may enhance the activity of enzymes involved in phosphate metabolism and photosynthesis.

7. Sodium molybdate (Na2MoO4) plays a role of an important trace element in the production of amino acids and proteins in plants, and is a constituent of nitrogen reducing factors.

8. Sodium silicate (Na2SiO3) has a feature of being soluble in water, therefore, is dissolved to neutralize acidic soil when sprayed on the soil. Soluble silicic acid absorbed from the roots rises into the plant body and is deposited in the epidermal cell membrane on the leaf surface to strengthen the plant. Further, this compound inhibits excess nitrogen absorption and makes it strong against pests and diseases. For fruit plants, the growth of fruits is accelerated and the color of fruits become better, while preventing fruit drop and infected fruits.

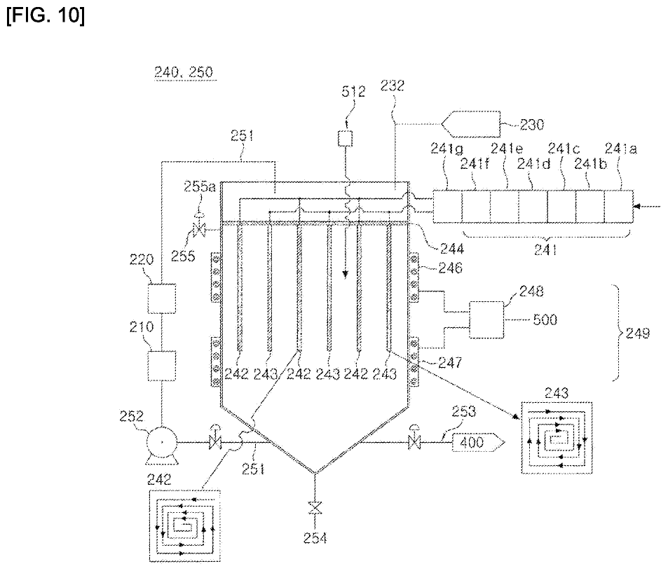

FIG. 10 is a cross-sectional view showing a second reactor 250 embracing the second quantum energy generator 249 of the growth promotion system with irradiation of quantum energy as shown in FIG. 1. When described with reference to the accompanying drawing, the second reactor 250 has a rectangular parallelepiped shape, in which: a circulation pipe 251 is installed on one part of the left side of an inclined lower portion of the main body 250; a circulation pump 252 is mounted on the circulation pipe 251; a venture-ejector 226 including a venturi neck 226a through which carbon dioxide gas is introduced is installed at an interval; a dissolver 220 for production of carbonated water by irradiating high-voltage pulse wave and quantum energy, which are generated from carbon dioxide bubbles in a fluid including a mixture of carbon dioxide gas and the circulating water in the venture-ejector 226 through high-voltage discharge, so that the carbon dioxide gas is firstly dissolved in the water to produce the carbonated water, is installed at an interval; a water supply pipe 255 is provided at an interval from the dissolver; another circulation pipe 251 connected to one side of the upper portion of the reactor 250 is provided; the additive feed pipe 232 is installed at an interval; a carbon dioxide gas concentration detector 512 is provided at an interval; the additive feed pipe 232 is mounted on one part of an upper right side at an interval; a discharge pipe 253 for supplying the carbonated water to a space 40 where the plant growth promoting system is installed, is provided on one part of the lower right side; and a drain pipe 254 for discharging deposit is installed on the bottom surface. Further, a power supply 241 of the electrolyzer is installed on one part of the upper right side, and a plurality of positive (+) electrodes 242 and a plurality of negative (−) electrodes 243 are arranged at intervals inside the electrolyzer.

Further, a first cusp coil 246 of the second quantum energy generator 249 is mounted on one side of the upper outer surface of the second reactor 250, while a second cusp coil 247 and the power supply 248 are provided in a downward direction while being spaced at a distance from each other. Further, the positive (+) electrode 241 and the negative (−) electrode 242 of the electrolysis device 240 may be installed at a distance from each other on a cradle 244 inside the second rector 250, while the power supply 241 is mounted on one side of the outer surface in order to supply power to the positive (+) electrode 241 and the negative (−) electrode 242.

The material of the second reactor 250 may be any one selected and used among materials such as stainless steel (STS304, STS316L), glass fiber molded foam (FRP), steel (SS400) and hastalloy.

Pipes used as the circulation pipe 251, the (municipal) water supply pipe 255, the discharge pipe 253 and the drain pipe 254 may be any one selected and used from a carbon steel pipe for pipeline (SPP; Carbon Steel Pipe), an arc welding carbon steel pipe for pipeline (SPW: Electric Arc Welded Carbon Steel Pipes), a pressure carbon steel pipe (SPPS: Carbon Steel Pipe for Pressure Service), an alloy steel pipes for pipeline (SPA: Alloy Steel Pipes), a stainless steel pipes for pipeline (STSXT: Stainless Steel Pipes), a galvanized water supply pipe (SPPW: Galvanized Steel Pipe for Water Service), a plastic lining steel pipe, a copper pipe, a polyvinyl chloride pipe and a polyethylene pipe.

The pump 252 may be any one selected and used from a centrifugal pump, a positive displacement pump, a rotary pump, a volute pump, a gear pump and a turbine pump.

The material of the plurality of positive (+) electrodes 242 of the electrolysis device 240 may be any one material selected and used from Schottky metals such as platinum (Pt), gold (Au), palladium (Pd), iron (Fe), cobalt. (Co), chromium (Cr), nickel (Ni), silver (Ag), titanium (Ti), rubidium (Ru), copper (Cu), molybdenum (Mo), iridium (ir), rhodium (Rh), etc.

The material of the plurality of negative (−) electrodes 243 of the electrolysis device 240 may be any one material selected and used from ohmic metals such as aluminum (Al), silver (Ag), gold (Au), iron (Fe), chromium (Cr), titanium (Ti), nickel (Ni) and copper (Cu).

The positive (+) electrode 242 and the negative (−) electrode 243 have a rectangular shape with a predetermined area.

Each of the positive (+) electrode 242 and the negative (−) electrode 243 has a rectangular shape and may be processed into a solenoid coil shape modified by a laser modeling technique, and may be provided in plural on the cradle 244 such that the processed coils are wound in opposite directions on the positive (+) electrode 242 and the negative (−) electrode 243 facing to each other.

When power is supplied to the electromagnetic valve 255a installed in the water supply pipe in the control panel 500, the electromagnetic valve 255a is opened to fill the inside of the second reactor 250 with an appropriate amount of water, followed by supplying power to the circulation pump 252. When the circulation pump is operated to inhale and pressurize the aqueous solution inside the second reactor 250 and thus supplies the same to the venture-ejector 226, carbon dioxide gas fed from the carbon dioxide gas feeder 210 may be pressurized and supplied to the neck 226a of the venture-ejector, and then, added to the aqueous solution passing through the venture-ejector 226. Then, the carbon dioxide gas and the aqueous solution in a mixed fluid state may be supplied to the carbon dioxide gas dissolver 220 by a pressing force of the circulation pump 252. When applied the output of the high-voltage pulse generator 221 (the high-voltage pulse (pulsed electromagnetic field: PEMF) with positive (+) potential), the capacitor c may be gradually charged by the primary inductor Li and, due to a change in current in this time, trigger voltage is generated in the secondary inductor L2 so as to transfer pulse energy between the trigger voltage electrodes 224a and 224b and the ground electrodes 223a and 223b. When high voltage in the form of a pulsed electromagnetic field (PEMF) is applied to the discharge electrodes 222a and 222b, magnetic fields in the form of a pulsed electromagnetic field (PEMF) may be produced in opposite directions at an angle of 90° to a current flow direction. At this time, from the lower portion to the upper portion of the carbon dioxide gas dissolver 220, the magnetic fields in the form of a pulsed electromagnetic field (PEMF) in opposite directions may overlap and extinct in the middle portion between the second electrode 224b of the trigger electrodes and the second electrode 223b of the ground electrodes, in the middle portion between the second electrode 223b of the ground electrodes and the first electrode 222a of the discharge electrodes, in the middle portion between the first electrode 222a of the discharge electrodes and the first electrode 223a of the ground electrodes, in the middle portion between the first electrode 223a of the ground electrodes and the second electrode 222b of the discharge electrodes, and in the middle portion between the second electrode 222b of the discharge electrodes and the first electrode 224a of the trigger electrodes to thus produce pulse quantum energy in a zero magnetic field state. During passing an area in which free discharge occurs in water, air bubbles containing carbon dioxide gas are degassed and dissolved to prepare second carbonated water, and bacteria in the aqueous solution are sterilized in an electroporation manner. Further, during circulation to the inside of the second reactor 250, when power is supplied to the first and second cusp coils 246 and 247 from the power supply 247, magnetic fields may be generated at an angle of 90° to a current flow direction in the first and second cusp coils 246 and 247. Following this, the magnetic fields in opposite directions may overlap so as to be deflected upward from the middle portion between the first and second cusp coils 246 and 247 and then extinct to thus produce pulse quantum energy in a zero magnetic field state, which in turn is irradiated to the aqueous solution so as to activate the aqueous solution. At the same time, DC power in the form of a pulsed electromagnetic field (PEMF) generated in IGBT power supply 241 is applied to the plurality of positive (+) electrodes 242 and negative (−) electrodes 243 mounted on the cradle 244 in the electrolysis device 240, wherein the IGBT power supply 241 consists of a step-down transformer 241a, a rectifier circuit 241b, an IGBT inverter 241c, a power output unit 241d, a control signal generator 241e and a microcomputer 241f.

In the step-down transformer 241a, the input voltage single-phase 220V, 60 Hz AC power is reduced to a single-phase in the range of 12 to 24V. Further, in the rectifier circuit 241b, the single-phase 220V, 60 Hz AC power in the step-down transfer 241 is converted into single-phase DC power in the range of 12 to 24V. The IGBT inverter 241c may supply DC power input by a control signal transmitted from the outside to the load side, while the control signal generator 241e may generate control signals in a pulse width modulation (PWM) control way and in the form of pulse frequency modulation (PFM), pulse frequency (density) modulation (PDM) and pulse repetition rate (PRR) control and transmit the same to the IGBT inverter 241c. Further, by comparing the voltage applied to the positive (+) electrode 242 and the negative (−) electrode 243 with the previously programmed input voltage and then adjusting the same, the previously programmed and input voltage value may be applied from the power output unit 241d to the positive (+) electrode 242 and the negative (−) electrode through conductive wires. Further, the microcomputer 241f may convert the output signal of the control signal generator 241e into a digital form in order to set a PWM width of the control signal from the received output signal and then transfer the control signal with the set PWM width to the control signal generator 241e so that DC power in the form of a pulsed electromagnetic field (PEMF) in the range of single-phase 12 to 24V is supplied to the plurality of positive (+) electrodes 242 and negative (−) electrodes 243, each of which is in a modified solenoid coil shape wherein the modified solenoid coils are installed in opposite directions, through a polarity reverse converter 241g for a predetermined time. When the polarity of the DC power supplied to the positive (+) electrode 242 and the negative (−) electrode 243 is converted by the set time input in the microcomputer 241f (from + to − power, from − to + power) and then DC power in the form of a pulsed electromagnetic field (PEMF) is supplied to the plurality of positive (+) electrodes 242 and negative (−) electrodes through conductive wires wherein the directions of the modified solenoid coils are opposed to each other, magnetic fields may be generated at an angle of 90° to a current flow direction and the magnetic fields in the form of a pulsed electromagnetic field (PEMF) generated in opposite directions in the middle portion between the plurality of positive (+) electrodes 242 and negative (−) electrodes 243, which are installed in opposite directions, may overlap and extinct to produce pulse quantum energy in a zero magnetic field state, which is irradiated to the aqueous solution to perform electrolysis in the positive (+) electrode 242 and the negative (−) electrode 243 so that water molecules are dissociated to generate oxygen at the positive (+) electrode 242 and hydrogen at the negative (−) electrode 233. In this regard, this reaction may be expressed by the following equations 1, 2 and 3.

Electrolysis of water

Half reaction (−) electrode: 2H2O(l)+2e→H2(g)+2OH−(aq) Equation 1

Half reaction (+) electrode: H2O(l)→½O2(g)+2H+(aq)+2e− Equation 2

Overall reaction: 2H2O(l)→2H2(g)+O2(g) Equation 3

Hydrogen gas (2H2) is generated at the (−) electrode in the reactions of Equation 1, Equation 2 and Equation 3,

Oxygen gas (O2) is generated at the (+) electrode to become a state in which electrons are insufficient (oxidized state), and then, the following additives may be supplied to the second reactor 250 by the metering pump 234 in the additive supply unit 230, so as to prepare an aqueous solution containing the same wherein, if any one material selected from: Monocarboxylic acids such as carboxylic acid ((COOH)2) HCOOH (methanoic acid (formic acid)), CH3COOH (ethanoic acid (acetic acid)), CH3CH2COOH (propionic acid), etc.;

dicarboxylic acids such as HOOC—COOH (oxalic acid), HOOCCH2COOH (malonic acid), HOOC(CH2))COOH(succinic acid), etc.; unsaturated aliphatic carboxylic acids such as CH3(CH2)14COOH (palmitic acid), CH3(CH2)16COOH (stearic acid), CH3(CH2)7CH═CH(CH2)7COOH (cis) (oleic acid), etc.; aromatic carboxylic acids such as lactic acid (C3H6O3), C6H5-COOH (benzoic acid), C6H5(OH)COOH (salicylic acid), etc.; as well as any one or more materials selected from sodium bicarbonate (NaHCO3), potassium bicarbonate (KHCO3), magnesium Bicarbonate (Mg(HCO3)2), calcium bicarbonate (Ca(HCO3)2) and potassium oxalate (K2C2O4) is supplied to the second reactor 250, electrons may be supplied to the aqueous solution in an oxidized state which lacks electrons in the electrolysis process to perform a reduction reaction and, during the reduction, carboxylic acid is oxidized to generate carbon dioxide gas (CO2) in the aqueous solution. For example, the reaction of oxalic acid as an example of the carboxylic acids is shown in Equation 4 below.

(COOH)2→2CO2+2H++2e− Equation 4

As an additive such as carboxylic acid is added to the aqueous solution in an electron-deficient state by electrolysis, the reaction of Equation 4 for replenishing electrons proceeds to thus accelerate the carbon dioxide gas generation reaction.

In the second reactor 250, an electron-shortage state occurs by electrolysis, and an electron-deficient aqueous solution and an additive such as carboxylic acid are mixed, and a reaction of replenishing electrons proceeds in the aqueous solution, whereby the carboxylic acid is oxidized and carbon dioxide gas in the aqueous solution is generated explosively. A pulsed electromagnetic field (PEMF) DC voltage is applied between the positive (+) electrode 242 and the negative (−) electrode 243 so that the pH value of the aqueous solution reaches the range of 6 to 7. Following this, magnetic fields in the form of a pulsed electromagnetic field (PEMF) may be irradiated to the aqueous solution, and then, the magnetic fields in the form of a pulsed electromagnetic field (PEMF) in opposite directions may overlap and extinct at a center distance between the positive (+) electrode 242 and the minus (−) electrode 243 so as to produce pulse quantum energy in a zero magnetic field state, which is irradiated. At the same time, whenever the pH value approaches 7 while electrolyzing the aqueous solution, any one of acidic substances such as hydrochloric acid (HCl), sulfuric acid (H2SO4), nitric acid (HNO3) and acetic acid (CH3COOH) is selected and put into the aqueous solution in an appropriate amount in order to lower the pH value of the aqueous solution so that the pH value does not move to the alkaline range, and the pH is maintained in a weakly acidic range of 6 to 7 to thus keep the aqueous solution in an oxidative state lacking electrons. When any one of the carboxylic acids stored in the storage tank 231 is selected and supplied to the aqueous solution in the oxidative state lacking electrons in the second reactor 250 for electrolysis through the metering pump 233, the electrons may be provided to the aqueous solution to perform reduction, while oxidizing the carboxylic acid to thus accelerate generation of carbon dioxide gas in the aqueous solution.

Further, when the pH value of the aqueous solution is 6 or more, carbon dioxide gas is stably generated. On the other hand, when the pH value is less than 6, the carbon dioxide gas is dissolved and decomposed into ions, and reacts at the positive (+) pole of the electrode 242 as in Equation 5 to so that the concentration of carbonated water disappears.

2HCO3−→2CO2+H2O+2e−+2O2− Equation 5

As shown in Equation 5, when the pH value becomes 6 or less during operation and potassium oxalate (K2C2O4) stored in the additive storage tank is added to the aqueous solution in the second reactor 250 using a metering pump to dissolve the same, the aqueous solution may become an alkaline solution in a dissolution step of potassium oxalate and, when the alkaline aqueous solution is electrolyzed, hydrogen at the positive electrode, that is, a cathode 233 and oxygen at the negative electrode, that is, an anode 232 may be generated during decomposition, while producing carbon dioxide gas (CO2).

HCO3−→CO2+OH− Equation 6

or

(COO−)2→CO2+O2+2e− Equation 7

Further, when feeding sodium bicarbonate (NaHCO3), potassium bicarbonate (KHCO3), magnesium bicarbonate (Mg(HCO3)2) and calcium bicarbonate (Ca(HCO3)2 stored in the first additive storage tank to the second reactor 210 by a metering pump and dissolving the same, the aqueous solution in a dissolution step of sodium bicarbonate (NaHCO3), potassium bicarbonate (KHCO3), magnesium: bicarbonate (Mg(HCO3)2) and calcium bicarbonate (Ca(HCO3)2) becomes an alkaline aqueous solution. When the alkaline aqueous solution is electrolyzed, hydrogen at the cathode 243 and oxygen at the anode 242 may be generated during the decomposition process and, as shown in Equations 8, 9, 10 and 11, carbon dioxide (CO2) is generated.

For sodium bicarbonate (NaHCO3)

NaHCO3→CO2+NaOH Equation 8

For potassium bicarbonate (KHCO3)

KHCO3→CO2+KOH Equation 9

Magnesium Bicarbonate (Mg(HCO3)2)

Mg(HCO3)2→2CO2+Mg(OH) Equation 10

Calcium Bicarbonate (Ca(HCO3)2)

Ca(HCO3)2→2CO2+Ca(OH) Equation 11

Therefore, the pH value of the aqueous solution is adjusted to be in the range of 6 to 7 according to the above reaction formula, and oxalic acid added later, oxalic acid in an oxalic acid solution in an oxidation atmosphere through electrolysis, etc. is subjected to a chemical reaction with carboxylic acid to induce explosive generation of carbon dioxide micro-bubbles, thereby generating a great amount of carbon dioxide gas. Further, hydrogen, oxygen and carbon dioxide gas generated by dissociation of water molecules during the electrolysis process are dissolved in an aqueous solution and then dissociated in the electrolysis process, thereby generating carbon dioxide gas.

Ionic materials such as potassium ion (K+), calcium ion (Ca2+), and magnesium ion (Mg2+), etc. among the cations of the aqueous solution during the electrolysis process are highly reactive and may be reduced to ions to generate hydrogen (H2). Further, among Schottky metals such as platinum (Pt), gold (Au), palladium (Pd), iron (Fe), cobalt (Co), chromium (Cr), nickel (Ni), silver (Ag), titanium (Ti), rubidium (Ru), copper (Cu), molybdenum (Mo), iridium (Ir), rhodium (Rh), etc. used as the positive (+) electrode 242 in the electrolysis device 240, the materials such as platinum (Pt), gold (Au), silver (Ag), copper (Cu), rhodium (Rh), etc., in addition, the ionic materials eluted from gold (Au), silver (Ag), copper (Cu), etc. during the electrolysis process among ohmic metals such as aluminum (Al), silver (Ag), gold (Au), iron (Fe), and chromium (Cr), titanium (Ti), nickel (Ni), copper (Cu), etc. used as the material of the negative (−) electrode 253 are less reactive than hydrogen ions, therefore, the electrolyte is reduced.

Further, the material of the positive (+) electrode 242 and the negative (−) electrode 243 may be prepared as follows.

Among carbon (C), hydrogen (H), oxygen (O), nitrogen, phosphorous (P), potassium (K), sulfur (S), calcium (Ca), magnesium (Mg), chlorine (Cl), boron (B), iron (Fe), manganese (Mn), copper (Cu), zinc (Zn), nickel (Ni) and molybdenum (Mo), which are known as essential nutrients necessary for synthesizing organic matters, that is, sugar, amino acid, lipid, vitamin, etc. by plants that absorb inorganic elements from the air and soil using solar energy, inorganic substances such as potassium (K), calcium (Ca), magnesium (Mg), boron (B), iron (Fe), manganese (Mn), copper (Cu), zinc (Zn), nickel (Ni) and molybdenum (Mo) may be selected and prepared as a single component or in the form of alloy, whereby these are supplied to carbonated water in the form of ions.

As a potassium alloy, sodium (Na)-potassium (k) alloy (Na-k alloy) may be used. Likewise, nickel-manganese alloy (Ni—Mn alloy), nickel-copper alloy (Ni—Cu alloy), manganese-copper alloy (Mn—Cu) alloy, aluminum-copper alloy (Al—Cu alloy), copper-zinc alloy (Cu—Zn alloy), copper-tin alloy (Cu—Sn alloy), copper-titanium based copper alloy (Cu—Ti alloy) and copper-nickel-silicon based alloy (Cu—Ni—Si alloy) may be used. Further, as a manganese alloy, the manganese alloy (Mn alloy: SMn 443 alloy steel for mechanical structure (KS D 3867)) may be used, wherein composition and content of the above alloy are shown in Table 6.

TABLE 6
Composition and content of manganese alloy (Mn alloy: SMn 445
alloy steel for mechanical structure (KS D 3867) for use

| Division | C | Si | Mn | P | S | Ni | Cr |
|---|---|---|---|---|---|---|---|
| SMn443 | 0.4-0.46% | 0.15-0.035% | 1.35-1.65% | 0.030% | 0.030% | 0.25% | 0.35-0.70% |

Iron and iron alloy used herein may include carbon steel (SS400), STS304, ferromanganese, ferrotitanium, ferronickel, ferrozircon, ferrobron, ferromolybdenum, ferroporphos, ferrobadium, etc., Mg or magnesium alloys used herein may include any one or more among Mg or Mg—Al—(Zn)—(Mn)-based alloy (product name: Electron) produced in Europe, and MG-Zn—Zr based or Mg-rare earths based, Mg-misch metal-based, Mg—Ce based and Mg—La based materials, and boron steel is used for boron alloys.

Further, in the electrolysis reaction of water, the hydroxyl radical (OH−) generated in the reactions of Equation 1 and Equation 6 above may react with metal ions such as potassium ion (K+), calcium ion (Ca2+), magnesium ion (Mg2+), iron ions (Fe2+, Fe3+), aluminum ions (Al3+), etc which are eluted from the electrodes (+,−) to produce potassium hydroxide (KOH), calcium hydroxide (Ca(OH)2), magnesium hydroxide (Mg(OH)2), ferric hydroxide (Fe(OH)2), ferric hydroxide (Fe(OH)3), aluminum hydroxide (Al(OH)3, etc., wherein the hydroxyl ion (OH−) is generated by dissociation of water molecules in the electrolysis process and through irradiation of quantum energy. In this process, cationic material and anionic material are removed, resulting in production of carbonated water which contains any one or more substances among: carbon dioxide gas-releasing substance such as aromatic carboxylic acid having anti-oxidation (reduction) functions and exhibiting an oxidation potential measurement value of −600 to −1200 mV; plant growth promoting substances such as auxin; and moisture fluctuation inhibitors. Then, The carbonated water may be pressurized by the pressure pump 431 in the space 410 where the plant growth promotion system is installed, and supplied to the feed pipe 432 through an injection nozzle 434 attached thereto, followed by foliar fertilization of the planted plants. Therefore, according to the supply of the above carbonated water, oxidative stress including the biological stress caused by other organisms such as pests and diseases and the abiotic stress caused by changes in the physical or chemical environments such as heat, drought, salinity, etc. may be overcome to restore the lost ability of the plant roots to absorb necessary materials from the soil, which in turn allows the plant to produce sufficient vitamins, amino acids, hormones, etc.

Further, various ions including potassium ions (K+), calcium ions (Ca2+), magnesium ions (Mg2+), iron ions (Fe2+, Fe3+), aluminum ions (Al3+), zinc ions (Zn2+) which are precipitated from the electrodes 242 and 243 during electrolysis may supply minerals to the plants planted in the space where the plant growth promoting system is implemented.

Further, when power in the form of a pulsed electromagnetic field (PEMF) generated by the power supply 241 of the electrolysis device 240 is supplied to the electrodes 242 and 243 processed in the shape of a solenoid coil modified in opposite directions to each other, and when power in the form of a pulsed electromagnetic field (PEMF) generated by the power supply 248 is supplied to the first and second cusp coils 246 and 247 mounted on the outer surface of the second reactor, magnetic fields in the form of a pulsed electromagnetic field (PEMF) may be generated in opposite directions at an angle of 90° to a current flow direction, and then, may overlap and extinct to produce pulse quantum energy. When irradiating the magnetic field in the form of a pulsed electromagnetic field (PEMF) and the pulse quantum energy to the carbonated water containing any one or more among carbon dioxide gas-releasing substances such as aromatic carboxylic acid, plant growth promoting substances such as auxin and moisture fluctuation inhibitors to bring about electrical disturbance and electric polarization, thereby inducing (generating) a quantum wave field, whereby water molecules may have electrostatic traction, interference over a long distance (inter-stimulation between plants), and hydrogen bonds and covalent bonds between water dipoles may be partially dissociated to form smaller group water in a “microcluster” structure. Therefore, when the carbonated water treated in a coherent domain state with high order, which contains carbon dioxide gas-releasing substances such as aromatic carboxylic acid, plant growth promoting substances such as auxin and/or moisture fluctuation inhibitors, is used for foliar fertilization of the soil in the space 410 where the plant growth promoting system is implemented as well as leaves of the plants planted in the soil, the carbonated water may be rapidly absorbed through pores of the leaves to thus minimize the loss of nutrients due to release into the atmosphere, improve photosynthetic efficiency, and quickly supply nutrients to the roots of the plants, thereby promoting plant growth.

*Source: A paper by Emilio Del Guidice, a scientist at the Institute of Nuclear Physics in Milan, Italy.

In this regard, coherence is a physical term, meaning that two electric dipoles far apart from each other affect each other while oscillating.

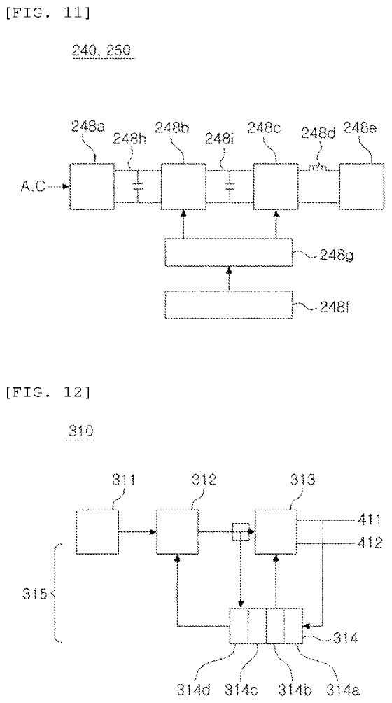

FIG. 11a is a cross-sectional view showing a power supply of the pulse quantum energy generator shown in FIG. 10. When described with reference to the accompanying drawing, the power supply 248 may include a rectifier 248a, a converter 248b, an inverter 248c, a resonance reactor 248d, a pulse transformer 248e, a control unit 248f involving a pulse width modulation (PWM) control way and functions of pulse frequency modulation (PFM), pulse frequency (density) modulation (PDM) and pulse repetition rate (PRR) control, a gate driver 248g, a first capacitor 248h and a second capacitor 248i.

The rectifier 248a may convert the single-phase 220V 60 Hz AC power input into a DC voltage.

The converter 248b may boost the DC voltage resulting from conversion of the AC power to the DC power in the rectifier 248a to a high voltage through a switching operation.

The inverter 248c may modulate the DC voltage boosted by the converter 248b into a pulsed electromagnetic field (PEMF) voltage.

The resonance reactor 248d may match the loads of the first and second cusp coils 246 and 247.

The pulse transformer 248e boosts the output voltage of the inverter 248c. In order to perform pulse amplitude modulation (PAM) of the switching output between the first and second cusp coils 246 and 247 receiving application of output voltage of the pulse transformer 248e and the inverter 248c, the control unit 248f may form a signal to control the output voltage of the converter 248b. Further, in order to adjust an intensity of the magnetic field generated in the first cusp coil 246 and the second cusp coil 247 so as to control an amount of quantum energy, the control unit 248f may form a signal enabling pulse frequency (density) modulation independent of a width of the pulse. Further, the power supply described above may include the gate driver 248g that amplifies the voltage of the control signal applied from the control unit 248f, and then, applies the same to the converter 248b and the inverter 248c.

In this regard, the power supply may further include the first capacitor 248h that reduces the ripple of the voltage rectified through the rectifier 248a and then inputs a voltage of the first capacitor 248c into the converter 248b, and the second capacitor 248i that reduces the ripple of the DC voltage boosted by the converter 248b and then inputs a voltage of the second capacitor 248i into the inverter 248c.

The rectifier 248a converts the supplied AC power to a DC voltage, the converter 248b boosts the DC voltage through a switching operation, and the inverter 248c converts the boosted DC voltage into a voltage in the form of AC pulse (pulsed electromagnetic field; PEMF). Following this, the pulse transformer 142e boosts the output voltage of the inverter 142c and applies the same to the first and second cusp coils 246 and 247.

Further, since an input unit (not shown) is separately built inside the control unit 248f, the user can directly input the current values, voltage values, frequency values, power supply time and stop time (timer function), etc. to the input unit.

A winding direction of the first cusp coil 246 may be counterclockwise and the coil may be wound at a predetermined number of turns so that an electromagnetic force is directed downwardly in the second reactor 250 based on the Fleming left hand rule. On the other hand, the second cusp coil 247 may be wound in a clockwise direction at a predetermined number of turns so that an electromagnetic force is directed upwardly in the second reactor 250 based on Fleming's left hand rule.

Further, the number of turns of the second cusp coil 247 may be more than that of the first cusp coil 246 by 20 to 50%, so that the electromagnetic force generated by the second cusp coil 247 becomes higher than that of the first cusp coil 246 by 20 to 50%. Therefore, the electromagnetic force may act upward so that input materials, specifically, carboxylic acid introduced from the first storage tank 231a to the second reactor 250 in the additive feeder 230, which generates carbon dioxide gas during decomposition, or natural auxin materials as plant growth hormones, phosphoric acid compounds, etc. which are introduced to the inside of the second reactor 250 in the second storage tank 231ba, or the moisture fluctuation inhibitors such as a,a-trehalose introduced to the inside of the second reactor 250 in the third storage tank 231c may show delayed sedimentation rate and extended residence time so as to improve the reaction efficiency in the second reactor 250, and therefore, the activated aqueous solution is supplied to a carbonated water supply means 420 in the target space 410 where the plant growth promoting system is implemented.

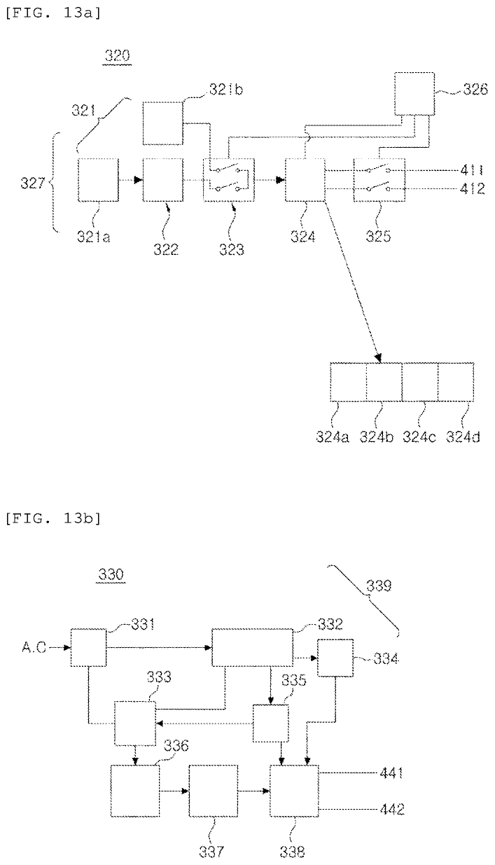

FIG. 13 is a cross-sectional view showing a third quantum energy generator for irradiating quantum energy to a space where the plant growth promoting system with irradiation of quantum energy is installed, as shown in FIG. When described with reference to the accompanying drawing, the third quantum energy generator 310 may include a power supply unit 315 consisting of: an AC power generator 311; an AC/DC converter 312; a DC/DC converter 313; a control unit 314 involving a pulse width modulation (PWM) control way and functions of pulse frequency modulation (PFM), pulse frequency (density) modulation (PDM) and pulse repetition rate (PRR) control, as well as first and second quantum energy generating coils 441 and 442 provided in the space 410 where the plant growth promoting system is installed.

The AC power supply 311 supplies the single-phase 220V, 60 Hz power to the AC/DC converter 312.

The AC/DC converter 312 switches and converts commercial AC power into DC power. Specifically, the AC power supplied from the AC power generator 311 passes through a filter for removing electromagnetic interference (EMI) (not shown) to remove the electromagnetic interference, and the AC power free of the electromagnetic interference is rectified and smoothened in the rectifier (not shown). Then, the rectified AC power is subjected to power factor correction (PFC) with a power factor corrector (not shown) and then is supplied to the DC converter 313.

The DC/DC converter 313 may supply power in the form of a pulsed electromagnetic field (PEMF), which was modulated by control signals for adjustment of the pulse shape, the pulse period, the frequency repetition rate, the frequency burst length, etc. through the control signal in regard to the modulation of the pulse width, the pulse frequency (density) and the pulse repetition rate in the control unit 314, to the first quantum energy generating coil 441 and a the second quantum energy generating coil 442 provided in the space 410 where the plant growth accelerating system is installed.

The control unit 314 may switch and control the DC power fed back from the AC/DC converter 312 according to a change in the output power supplied to the first quantum energy generating coil 441 and the second quantum energy generating coil 442, thereby varying a voltage level of DC power supply. Further, the control unit 314 may include; a current detector 314a that detects a change in the load current of the output power supplied to the first quantum energy generating coil 441 and the second quantum energy generating coil 442; a variable controller 314b that is operated when the load current from the current detector 314a exceeds a preset current value to provide first and second signals; a first controller 314c to control switching of the DC/DC converter 313 according to the first signal of the variable controller 314b; and a second controller 314d to control switching of the power factor corrector (not shown) according to the second signal of the variable controller 314b.

Further, adjustment functions such as adjustment of power supply time and stop time (timer function), switching element function, etc. may further be added to the control functions.

When the power in the form of a pulsed electromagnetic field (PEMF) generated in the power supply unit 315 is supplied to the first quantum energy generating coil 441 and the second quantum energy generating coil 442 facing each other at an interval in the space 410 where the plant growth promoting system is installed, such that the winding directions of the coils are opposed to each other, magnetic fields in the form of a pulsed electromagnetic field (PEMF) may be generated and irradiated in opposite directions at an angle of 900 to a current flow direction in the first quantum energy generating coil 441 and the second quantum energy generating coil 442, and then, the magnetic fields may overlap and extinct in the middle portion between the first quantum energy generating coil 441 and the second quantum energy generating coil 442 to thus produce pulse quantum energy in a zero magnetic field state. This pulse quantum energy may be irradiated to: a soil for planting the plant in the space 410 where the plant growth promoting system is installed; the plant planted in the soil; the firstly prepared nitric oxide, which is injected for fertilization and foliar fertilization to the plant, or nitric oxide water mixed with a nitrogen-releasing source, clay, fly ash, mica, lanthanide rare earths, enzymes, soil microorganisms, etc.; and the secondly prepared carbonated water, which contains carbon dioxide gas-releasing substances such as aromatic carboxylic acid, plant growth promoting substances such as auxin and/or moisture fluctuation inhibitors, so as to bring about electrical disturbance and electric polarization, thereby inducing (generating) a quantum wave field. Further, according to the irradiation of the pulse quantum energy, hydrogen bonds and covalent bonds between water dipoles are partially dissociated to form smaller group water in a “microcluster” structure and in a coherent domain state with high order, so as to activate: the moisture (H2O) of the soil and the sap of the plants planted in the soil; the nitric oxide water for fertilization and foliar fertilization, which is a mixture prepared by adding a nitrogen-releasing source, clay, fly ash, mica, lanthanide rare earths, enzymes, soil microorganisms, etc. thereto; the carbonated water, which contains carbon dioxide gas-releasing substances such as aromatic carboxylic acid, plant growth promoting substances such as auxin and/or moisture fluctuation inhibitors in activated state. Therefore, when supplying the above-activated product to the leaves of the plant planted in the space 410 where the plant growth promoting system with irradiation of quantum energy is implemented, in order to perform fertilization and foliar fertilization, it may be quickly absorbed through pores of the leaves to thus minimize the loss of nutrients due to release into the atmosphere, to improve photosynthetic efficiency, and to rapidly supply nutrients to the roots of the plant, thereby promoting plant growth.

Further, according to the present invention, nutrients including minerals in the soil, as well as enzymes, bacteria and soil microorganisms may be activated to relieve oxidative stress, while attaining resistance to pests and diseases, promoting the growth and increasing harvest yield.

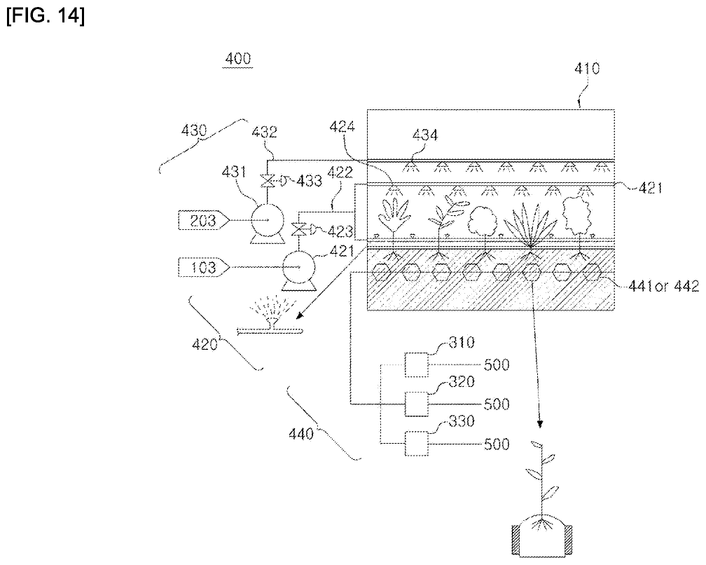

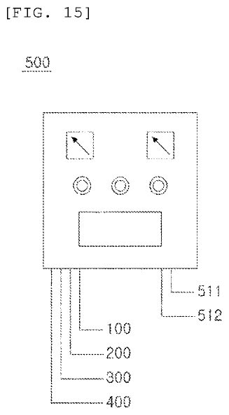

FIG. 14 is a cross-sectional view showing a fourth quantum energy generator for irradiating quantum energy to the space where the plant growth promoting system with irradiation of quantum energy as shown in FIG. 1. When described with reference to the accompanying drawing, the second quantum energy generator 320 may include a power supply device 327 consisting of: a power supply unit 321 comprising an AC power supply 321a or a DC power supply (DC: battery) 322b; AC/DC converter 322; an automatic supply power switch 323 (ATS); a low frequency generation/output unit 324; a switching element 325; and a control unit 326 involving a pulse width modulation (PWM) control way and functions of pulse frequency modulation (PFM), pulse frequency (density) modulation (PDM) and pulse repetition rate (PRR) control, as well as first and second quantum energy generating coils 441 and 442 which are provided in the space 410 wherein the plant growth promoting system is installed.

When AC power of 220V 6 Hz is supplied from the AC power supply (AC) 321a in the power supply unit 321 to a step-down transformer (not shown), the step-down transformer may reduce the power to single-phase 6 to 50V range, 60 Hz AC power in the range of single-phase 6 to 50V and then supply the same to the AC/DC converter 322 through the automatic supply power converter 323 (ATS), followed by rectifying the same into DC power in the range of single-phase 6 to 50V. When the DC power is supplied to a low-frequency or high-frequency generation/output unit 324, which consists of an oscillator 324a, a frequency divider 324b, an adjuster 324c and an amplifier 324d, through the automatic supply power converter 323 (ATS), otherwise, the DC power in the range of 6 to 50V in the DC power supply 321b (battery) is supplied to the low-frequency or high-frequency generation/output unit 324, which consists of an oscillator 324a, a frequency divider 324b, an adjuster 324c and an amplifier 324d, through the automatic supply power converter 323 (ATS), when data required for treatment in advance, which was programmed in the oscillator 324a, is input in the control unit 326, and when appropriate electromagnetic wave to be applied to the first and second quantum energy generating coils 441 and 441 is generated and applied to the frequency divider 324b, the electromagnetic wave generated by the oscillator 324a in the frequency divider 324b may be overlapped with frequencies in different directions in the first and second quantum energy generating coils 441 and 442. In order to sufficiently produce quantum energy generated in a zero magnetic field state, the above frequency may be converted into low-frequency signal and, when applying this signal to the adjuster 324c, the adjuster 154c may adjust low-frequency pulse signal generated in the frequency divider 154b according to the control of the control unit 156 to thus regulate an intensity of the low frequency. When the low-frequency pulse signal is applied to the amplifier 324d, the amplifier 324 may amplify the low-frequency pulse signal through the adjuster 324c to form a pulsed electromagnetic field (PEMF) type power. When the power in the form of a pulsed electromagnetic field (PEMF) is applied to the first and second quantum energy generating coils 441 and 442, which are provided in the space 410 where the plant growth promoting system is installed, through the switching element 325, pulse electric fields (PEMF) may be generated in opposite directions, followed by overlapping and extinction thereof to produce pulse quantum energy. This quantum energy may be irradiated to: a soil for planting the plant in the space 410 where the plant growth promoting system is applied, and the plant planted in the soil; the firstly prepared nitric oxide water, which is injected for fertilization and foliar fertilization to the plant, or the secondly prepared nitric oxide water which contains any one or more materials among a nitrogen-releasing source, clay, fly ash, mica, lanthanide rare earths, enzymes, soil microorganisms, etc.; the secondly prepared carbonated water which contains carbon dioxide gas-releasing substances such as aromatic carboxylic acid, plant growth promoting substances such as auxin and/or moisture fluctuation inhibitors; and moisture of the soil for planting the plant, sap of the plant planted in the soil, nitric oxide water for fertilization of soil and for fertilization of leaves of the plant planted in the soil, carbonated water, and the sap of plant, moisture in atmosphere and moisture in the soil, etc., so as to bring about electrical disturbance and electric polarization in water molecules, thereby inducing (generating) a quantum wave field. Therefore, according to the irradiation of the above pulse quantum energy, water molecules may have electrostatic traction, interference over a long distance (inter-stimulation between plants) may occur, and hydrogen bonds and covalent bonds between water dipoles may be partially dissociated to form smaller group water in a “microcluster” structure and in a coherent domain state with high order. Therefore, when supplying the above product for foliar fertilization of leaves of the plant planted in the space 40 where the plant growth promoting system is implemented, it may be quickly absorbed through pores of the leaves to thus minimize the loss of nutrients due to release into the atmosphere, to improve photosynthetic efficiency, and to rapidly supply nutrients to the roots of the plant, thereby promoting plant growth.

Further, according to the present invention, nutrients including mineral components in the soil, as well as enzymes, bacteria and soil microorganisms may be activated to relieve oxidative stress, while attaining resistance to pests and diseases, promoting plant growth and increasing harvest yield.

FIG. 15 is a cross-sectional view showing a fifth quantum energy generator for irradiating quantum energy to a space where the plant growth promoting system with irradiation of quantum energy, as shown in FIG. 1. When described with reference to the accompanying drawing,

a fifth quantum energy generator 330 may include a power supply device 339 consisting of: a power supply 331; a switch power supply 332; a micro-controller 333; a capacitor 334; a pulse shaper 335; a pulse phase time controller 336; a voltage level converter 337; and a switch HEXFET 338, as well as the first quantum energy generating coil 441 and the second quantum energy generating coil 442, which are provided in the space where the plant growth promoting system is installed.

The power supply 331 supplies DC power to the switch power supply 332 and the microcontroller 333 using a current outlet such as an AC/DC outlet. The switch power supply 332 controls the microcontroller 333 with voltage. The microcontroller 333 uses a high frequency of 100 KHz to 6 MHz with a certain capacity (bit). The switch power supply 332 also supplies current to the capacitor 334. The capacitor 334 supplies a high-frequency pulse to an inductor (not shown).

The microcontroller 333 controls the pulse shaper 335 and the pulse phase time control 336. The pulse shaper 335 and the pulse phase time control 336 may determine pulse shape, a burst width, burst envelope shape, and burst repetition rate. If combined with an internal waveform generator such as a sine wave or an arbitrary number generator, a specific waveform may be provided. The voltage level converter 308 may control power (frequency, current) applied to the first quantum energy generating coil 441 and the second quantum energy generating coil 442, thereby controlling an induced electromagnetic field in the form of a pulsed electromagnetic field (PEMF). The switch HEXET 338 transmitting a wave shape to the inductor (not shown) may apply power in the form of

an arbitrary pulsed electromagnetic field (PEMF) co the first and second quantum energy generating coils 441 and 442, which are provided in the space where the plant growth promoting system is installed, so that the pulsed electromagnetic fields (PEMF) are generated in opposite directions, followed by overlapping and extinction thereof to produce pulse quantum energy in a zero magnetic field state. The produced pulse quantum energy may be irradiated to: a soil in the space 410 where the plant growth promoting system is installed; the firstly prepared nitric oxide water or the secondly prepared nitric oxide water which includes any one or more materials among a nitrogen-releasing source, clay, fly ash, mica, lanthanide rare earths, enzymes, soil microorganisms, etc. for fertilization and foliar fertilization of leaves of the plant planted in the soil; the firstly prepared carbonated water or the secondly prepared carbonated water, which contains carbon dioxide gas-releasing substances such as aromatic carboxylic acid, plant growth promoting substances such as auxin and/or moisture fluctuation inhibitors, so as to bring about electrical disturbance and electric polarization in water molecules, thereby inducing (generating) a quantum wave field. Therefore, according to the irradiation of the above pulse quantum energy, water molecules may have electrostatic traction, interference over a long distance (inter-stimulation between plants) may occur, and hydrogen bonds and covalent bonds between water dipoles may be partially dissociated to form smaller group water in a “microcluster” structure and in a coherent domain state with high order. Therefore, when supplying the above product for foliar fertilization of leaves of the plant planted in the space 40 where the plant growth promoting system is implemented, it may be quickly absorbed through pores of the leaves to thus minimize the loss of nutrients due to release into the atmosphere, to improve photosynthetic efficiency, and to rapidly supply nutrients to the roots of the plant, thereby promoting plant growth.

Further, according to the present invention, nutrients including mineral components in the soil, as well as enzymes, bacteria and soil microorganisms may be activated to relieve oxidative stress, while attaining resistance to pests and diseases, promoting plant growth and increasing harvest yield.

FIG. 15 is a cross-sectional view showing an operating system in which the plant growth promotion system with irradiation of quantum energy, as shown in FIG. 1, is applied to a target space. When described with reference to the accompanying drawing, the operating system 400 may include a target space where the plant growth promotion system is applied, a nitric oxide water supply means 420, a carbonated water supply means 430, and a quantum energy irradiation means 440.

The target space 410 in which the plant growth promotion system is applied may be any one selected among a glass greenhouse, a container-type smart farm, a vinyl house, any space such as fields, rice fields, mountains that can be partitioned in the range of: 0 m to 1 Km in the horizontal direction; 10 m to 1 Km in the vertical direction; and a height of 1 m below the ground surface and 0 to 5 m above the ground surface.

The nitric oxide water supply means 420 may comprise: a feed pipe 422 to which the first nitric oxide water prepared in the nitric oxide dissolver 120 or the second nitric oxide water produced in the first reactor 150, which contains any one or more materials among a nitrogen-releasing source, clay, fly ash, mica, lanthanide rare earths, enzymes and soil microorganisms is supplied; a pressure pump 421; an electromagnetic valve 423; and a plurality of injection nozzles 424 mounted on the pipe which is installed on the ground surface in the range of 5 m above the ground surface. When power is supplied to the pressure pump 421 and the electromagnetic valve 423 in the control panel 500, the nitric oxide water produced in the first reactor 150 may be inhaled and pressurized by the pressure pump 421, pass through the electromagnetic valve 423, and then, fed to the pipe installed on the ground surface in the range of 5 m above the ground surface. Thereafter, the nitric oxide water may be injected to leaves of the plant as well as the soil through the plurality of injection nozzles 424 formed on the pipe for a predetermined time, so as to be absorbed to the roots in the form of foliar fertilization through the soil. A spray cycle, spray time, spray amount of nitric oxide may be adjusted by a control circuit of the control panel 500 which is programmed and input in advance.

When the nitric oxide water is injected on the roots of planted plants for foliar fertilization through the injection nozzle 424, Auxin as a plant growth promoting hormone may be produced, a hydrolytic enzyme for an outer cell wall that inhibits plant pathogenic fungi may be produced, and sidephores promoting plant growth through soil infectious disease control may also be produced, while solubilizing insoluble phosphorous and activating rhizosphere microorganisms (plant growth promoting rhizobacteria: PGPR) for fixing nitrogen. Further, auxin is an endogenous growth regulator of plants, and may promote cell division (PY-01), increase the length of the plant, increase the volume, wherein strains PY-01, PY-02, PY-03, PY-01 can perform reduction of nitrate into nitrite.

Further, the nitric oxide water may fix phosphorus in soil or water to form nucleic acid, which is the basis of plant cells, may construct phospholipids of a cell membrane, and may form sugar phosphate in a process of decomposing sugar and generating starch by respiration, thereby accelerating formation of ATP, NADP, etc. and the growth of cereal crops.

Further, in the process of preparing nitric oxide water, iron ions in water are activated to control the formation of tertiary iron ions (Fe3+) and adjust a concentration thereof. Herein, the iron ions are involved in spore germination of plant pathogens, and may promote germ tube elongation, form chlorophyll and prevent yellowing.

Further, nitric oxide is a powerful antioxidant, and may directly remove active oxidizing species (ROS) in plant cell fluid, remove hydrogen peroxide (H2O2) and detoxify heavy metals (Rubio et al. 2000, Manuel Becana et al. 2003).

The carbonated water supply means 430 may comprise: a feed pipe 432 to which the first carbonated water prepared in the carbon dioxide gas dissolver 220 or the second carbonated water produced in the second reactor 250, which contains any one or more substances among carbon dioxide gas-releasing substances such as aromatic carboxylic acid, plant growth promoting substances such as auxin and moisture fluctuation inhibitors; a pressure pump 431; an electromagnetic valve 433; and a plurality of injection nozzles 434 mounted on the pipe which is installed on the ground surface in the range of 5 m above the ground surface. When power is supplied to the pressure pump 431 and the electromagnetic valve 433 in the control panel 500, the carbonated water as well as carbon dioxide gas produced in the second reactor 210 may be inhaled and pressurized by the pressure pump 431, pass through the electromagnetic valve 433, and then, fed to the pipe installed on the ground surface in the range of 5 m above the ground surface. Thereafter, the carbonated water may be injected to the plants through the plurality of injection nozzles 434 formed on the pipe for a predetermined time, so as to be absorbed in the form of foliar fertilization. A spray cycle, spray time, spray amount of the carbonated water may be adjusted by a control circuit of the control panel 500 which is programmed and input in advance.

Plant photosynthesis uses solar energy as well as carbon dioxide gas and water to generate carbohydrates and other organic molecules. In this regard, carbon fixation refers to conversion of carbon dioxide into organic molecules. In the present invention, when the carbonated water supplied from the second reactor 250 is pressurized by the pump 431, supplied to the plurality of injection nozzles 434 formed on the pipe and sprayed on leaves of the plant for foliar fertilization, carbon dioxide gas (CO2) may be quickly absorbed in the leaves owing to a high concentration of carbon dioxide gas (CO2) in the microenvironment of the leaf surface without substantial loss of carbon dioxide gas (CO2) to the atmosphere so that most of the carbon dioxide gas (CO2) can be absorbed by the plants, thereby enhancing the conductivity of the leaf and promoting plant growth.

Under conditions of relatively abundant nutrients, sunlight and water, plants mainly absorb water and gases such as carbon dioxide (CO2) through stomata.

Under these conditions, a cuticle conductivity of carbon dioxide gas (CO2) is relatively small compared to the cuticle conductivity of water vapor which has a size smaller than that of carbon dioxide gas (CO2).

Eventually, a diffusion path of carbon dioxide gas (CO2) is definitely stomata, that is, pores, whereas the path of water vapor includes both pores and cuticles.

However, when the leaves darken or become dehydrated, the pores of the stomata begin to close.

Therefore, water loss and the exchange of carbon dioxide gas (CO2) become increasingly dependent on the cuticle.
(Boyer et al, (1997) Plant phyiol, 114.185-191).

The plant cuticle is a protective film to cover the epidermis of organs, which does not exist in leaves, sprouts and other parasitic plants. This is composed of lipids and hydrocarbon polymers containing wax, and is synthesized only by epidermal cells. The plant cuticle is a lipid polymer layer containing wax that exists on the outer surface of major organs of all carnivorous plants.

Cuticles are present throughout leaves, stems, flowers and fruits, and may develop and become thicker as they mature. In addition to the external cuticle covering the body surface, there is also a thin film of lead-like material or cutin on a cell wall that comes into contact with air in the tissues of the leaf and epidermis. This is called the internal cuticle. Both of these two cuticle layers are connected to each other through the micro-surfaces of the pores.

The main function of the plant cuticle is to prevent evaporation of water from the epidermal surface while playing a role of a permeable barrier that prevents foreign substances and solutes from entering the tissue. In addition to such functions as the permeability barrier for water and other molecules (to prevent water loss), the microstructure and nanostructure of the cuticle may function to prevent contamination of plant tissues with external water, dust and microorganisms.

The quantum energy irradiating means 440 may include: a power supply as any one selected from the first, second, and third quantum energy generation power supplies 315, 327 and 339; a first quantum energy generating coil 441; a second quantum energy generating coil 442; and conductive wires 443, wherein winding directions of the first quantum energy generating coil 441 and the second quantum generating coil 442 are opposed to each other. Specifically, a plurality of first quantum energy generating coils 441 and second quantum energy generating coils may be installed to face each other in a range of 1 m underground and 5 m above the ground surface. When power generated in the power supply of any one quantum energy generator, which is selected among the third quantum energy generator 310 shown in FIG. 12, the fourth quantum energy generator 320 shown in FIG. 13a and the fifth quantum energy generator 330 shown in FIG. 13b, is applied to the first quantum energy generating coil 441 and the second quantum energy generating coil 442 wound in opposite directions through the conductive wires 443, magnetic fields in the form of a pulsed electromagnetic field (PEMF) may be generated in opposite directions at an angle of 90° to a current flow direction and irradiated, and then, the magnetic fields in the form of a pulsed electromagnetic field (PEMF) may overlap and extinct in the center portion at which the first quantum energy generating coil 441 and the second quantum energy generating coil 442 are arranged to face each other, so as to produce pulse quantum energy in a zero magnetic field state.

When the pulse quantum energy is irradiated to: a soil; plants planted in the soil; the firstly prepared nitric oxide, which is injected for fertilization and foliar fertilization to the plants, or the secondly prepared nitric oxide water which is mixed with a nitrogen-releasing source, clay, fly ash, mica, lanthanide rare earths, enzymes, soil microorganisms, etc.; and the firstly prepared carbonated water and the secondly prepared carbonated water, which contains carbon dioxide gas-releasing substances such as aromatic carboxylic acid, plant growth promoting substances such as auxin and/or moisture fluctuation inhibitors, it may bring about electrical disturbance and electric polarization, thereby inducing (generating) a quantum wave field. Further, according to the irradiation of the pulse quantum energy, hydrogen bonds and covalent bonds between water dipoles are partially dissociated to form smaller group water in a “microcluster” structure and in a coherent domain state with high order, so as to activate: the moisture (H2O) of the soil and the sap of the plants planted in the soil; the nitric oxide water for fertilization and foliar fertilization, which is a mixture prepared by adding a nitrogen-releasing source, clay, fly ash, mica, lanthanide rare earths, enzymes, soil microorganisms, etc. thereto; the carbonated water, which contains carbon dioxide gas-releasing substances such as aromatic carboxylic acid, plant growth promoting substances such as auxin and/or moisture fluctuation inhibitors in activated state, whereby the planted plants are subjected to fertilization and foliar fertilization.

How do the roots respond to what happens at the top of a plant in a sophisticated communication system within the plant? The sophisticated communication system is similar to an email system.

Nitrogen (N) is an important nutrient for plants but is often unevenly distributed in the soil. Plants have thus evolved a systemic mechanism: nitrogen starvation (deficiency) on one side of the root compensates for nitrogen uptake in the other.

Nitrogen-deficient roots secrete small peptides into the stem while receiving two leucine-rich repeat receptor kinases (LRR-RKs).

Plant Arabidopsis lacking this pathway exhibited stunted growth with nitrogen deficiency symptoms. Accordingly, a signal from the root to the stem helps the plant to adapt to local fluctuations in nitrogen availability.

Therefore, plants are operating by integrating local and overall nutrient signals to efficiently consume resources.

Tabata et al. (.) discovered a peptide signaling mechanism, in that the root locally senses soil nitrogen deficiency from the peptide signal and communicates with the plant, and the returned (receiving for outgoing) signal promotes the growth of lateral roots in areas with high concentrations of nitrate so as to facilitate nitrate absorption. The system presupposes that the cells of the stem & #56194;& #56402; read;;& #56194;& #56403; and understand the peptides and appropriately respond thereto. That is, the signal to be read goes downward to the underground.

The nitrate uptake system is regulated by cell-autonomous local signals triggered by nitrate itself and long-range system signals to transduce external and internal nitrogen states across spatially distant root compartments.

Further, millions of small organisms are contained even in a spoonful of soil under the bottom layer of farmland where plants are grown. These bacteria and fungi form a symbiotic relationship with the plant's roots and, as a reward for the continuous nutrient supply of the host plant, may help water absorption as well as the absorption of essential elements (components) such as nitrogen.

In more detail, it could be understood that the fungal thread physically binds multiple roots (often also bonds the roots of other plant species) and constitutes a single mycorrhizal network.

Pulsating Plants (pulsed electromagnetic field (PEMF) is generated in the quantum energy generating coil of the present invention, followed by overlapping and extinction thereof to produce pulse quantum energy, which is irradiated in zero magnetic field state)

By sophisticated video-imaging technology according to a team led by botanist Simon Gilroy from the University of Wisconsin, it was able to capture the growing appearance showing delicate expansion of individual root cells known as root hairs.

There are millions of projections of such elongated cortex that cover the roots of plants. It is already known that root hairs significantly increase the surface area of the plant root system and thus increase the soil volume from which water and mineral nutrients can be obtained. However, how elaborately the root hairs were formed and grown still remained as a mystery. When Gilroy's research team took pictures of root hairs with a camera, root hairs growing in pulses periodically every 20 seconds could be observed. As a result of investigating more specifically, such pulses were associated with a sharp pH variation at the tip of root hairs and also with specific reactive compound concentrations. In this finding, it could be seen that the plants were not slow, not static, but were actually more dynamic than imagined. Furthermore, plant cells have to overcome a cell wall made of cellulose, even though the wall is very heavy and hard so that the reinforced strength of cellulose may prevent the cell from collapsing due to enormous internal water pressure (Turgor). However, for the growth of the root hair clip, it should pump and put protons deep into the cell wall so as to create an acidity (pH) gradient and, after the protons flowed into the cell wall, the cell wall may stretch and the root hair tip may be extended. However, the plant cell almost instantly exhales the inhaled protons. Further, the cellulose strands are held in place to re-strengthen the cells. After a short pause, the above cycle repeats, and the plants may growth while preventing the root hairs from becoming too weak and collapsing through the repeated periodic undulations.

Photosynthesis in Plants

Further, when oxygen (O2) and nitric oxide (NO) in the air and active gases such as hydroxyl ions (OH−) are supplied, the plants grown in a cultivation room 201 may breathe and perform photosynthesis.

The leaves of plants have stomata, which may be said to be the gates through which the plant and the air can communicate. The leaves of plants take in external substances from the air through these stomata and release internal substances into the air. And whenever this need arises, the stoma is opened.

Oxygen required for respiration is received through the stomata in this way. Further, carbon dioxide generated in the process of respiration is also exhaled through the stomata. The same process is also applied to photosynthesis. Carbon dioxide required for photosynthesis is also received through the stomata while oxygen generated during photosynthesis is exhaled through the stomata.

Plant respiration takes place throughout day and night, unlike photosynthesis occurring only during the day.

Further, photosynthesis generally occurs only in the chlorophyll of leaves, but respiration in plants occurs in all cells.

Plants breathe not only at night but also during the day through photosynthesis. However, since these two processes occur simultaneously, carbon dioxide expelled from respiration is immediately absorbed by photosynthesis. When nitric oxide is absorbed through the stomata of the plant,

1. Nitric oxide (NO) activates rhizosphere microorganisms (PGPR: Plant Growth Promoting Rhizobacteria).

Activation of rhizosphere produces auxin, a plant growth promoting hormone, produces an outer cell wall and hydrolytic enzymes that inhibit phytopathogenic fungi, and produces siderophores (plant growth is promoted through soil infectious disease control) to thus solubilize insoluble phosphorus, while fixing nitrogen.

The Auxin is a plant endogenous growth regulator that promotes cell division, increases the length of the plant, increases the volume, and is a strain with excellent affinity for farm soil (PY-01, PY-02, PY-03), wherein the PY-01 strain reduce soil nitrate to nitrite.

2. Fixation of phosphorus (P)

Effects of phosphorus (P) on plants may include: construction of nucleic acid that is a base of cells; construction of phospholipids in cell membranes; formation of sugar phosphate in the process of decomposing sugar and producing starch through respiration; production of ATP, NADP, etc.; and promotion of the growth of cereal crops.

When phosphorus (P) is deficient, the deficiency symptoms are different for each plant. However, when phosphorus is insufficient, in the description of corn as an example, although the growth of young sprouts of corn is slow, the symptoms are relatively clear after the 5th leaf stage. Leaves are tinged with purple, the corn is in full ear, the growth of the dense hairs is slow, root development is poor and division is reduced, stem roots are purple, leaves are dark green with a little purple color, and the ears are small and the grains are few. In the case of rice, height is short, wlautodlc is dark green, leaves is tinged with purple, the number of young flowers and grains decreases, which in turn reduces the yield.

3. Nitric oxide (NO) is a powerful antioxidant that provides abnormal signals to the metabolism of plant cells and causes paralysis, can prevent oxidative stress disorder causing RNA mutation, can remove hydrogen peroxide (H2O2), and has stress-tolerance and detoxification of heavy metals. The antioxidant can directly remove reactive oxygen species (ROS) in plant cell fluid (Rubio et al. 2001, Manuel Becana et al. 2003).

1. Borax (Na2B4O7) contains the element (B) absolutely necessary for the initial growth of crops, and is involved in the movement of carbohydrates and the formation of cell membranes.

2. Sodium hexametaphosphate (NaPO3)6 acts to transfer heat and decompose carbohydrates in plants, allows plant cells to make sugar from carbon dioxide and water by chlorophyll and sunlight, improves sweet taste, promotes the growth of branches and leaves, increases the growth of branches and leaves, resulting in an increase in harvest yield.

3. Potassium carbonate (K2CO3) facilitates photosynthesis, water evaporation and control of water supply to increase resistance to cold weather damage, contributes to generation of plant fiber, and enhances plant cell composition.

4. Sodium pyrophosphate (Na4P2O7) is a nutrient that accelerates germination, promotes plant maturation, and enhances the ability of starch generation.

5. Calcium carbonate (CaCO3) is a component of cell membranes, and neutralizes acid soil and thus corrects soil reaction so as to promote the activity of soil microorganisms, while playing a major role in improving the soil environment suitable for plant growth.

6. Magnesium oxide (MgO) is a component to form chlorophyll, which is an essential element in green plants, and especially enhances the activity of enzymes involved in phosphate metabolism and photosynthesis.

7. Sodium molybdate (Na2MoO4) plays an important trace element in the production of amino acids and proteins in plants and is a constituent of nitrogen reducing factors.

8. Soda silicate (Na2SiO3) has the feature of being soluble in water, so as to dissolve and neutralize acidic soil when sprayed on the soil. Soluble silicic acid absorbed from the roots rises into the plant and is deposited in the epidermal cell membrane on the leaf surface to strengthen the plant. Further, it inhibits excess nitrogen absorption and makes the plant strong against pests and diseases.

The present invention provides a substantial advantage of increasing the growth of plants, especially leafy vegetables and flowers. Increased growth may require shorter growing seasons or shorter harvest times. The present invention provides some protection against insects and pests as well as improved control of pathogens, fungi, slimes and algae, and further provides a number of additional advantages including great reduction or prevention of rot, crop loss due to wilting, drying and dry rot, etc. Each of such advantages provides the opportunity for significant cost savings, increased productivity and improved versatility in land use.

Foliar application may solve the problem of leaching from the soil and induce a quick response in plants. Foliar application of phosphorus, zinc and iron provides maximum benefits over adding phosphorus to soils where phosphorus is fixed in an inaccessible form to plants and less zinc and iron are available.

See https://en.wikipedia.org/wiki/Foliarfeeding (see access Jul. 31, 2017).

Foliar fertilization has been used as a means of supplying supplemental amounts of minor and major nutrients, plant hormones, stimulants, and other beneficial substances. Observed effects of foliar fertilization include increased yield, resistance to disease and pests, improved drought tolerance, and improved crop quality. Plant response depends not only on the stage of growth of the plant, but also on the species, fertilizer type, concentration, and frequency of application, as well as on the stage of plant growth. For foliar fertilization, appropriate time may be set to coincide with specific growth or fruiting stages, and fertilizer formulations may be adjusted appropriately for best results. With respect to nutrient absorption, foliar fertilization may be 8 to 20 times more efficient than ground application.

See Foliar Fertilization George Kuepper, NCAT Agriculture Specialist, Published 2003, ATTRA Publication #CT135, accessed https://attra.ncat.org/attra-pub/summaries/summary.php? See accessed pub=286 #intro on Jul. 31, 2017.

1. A plant growth promoting system with irradiation of quantum energy, comprising:
a nitric oxide generator (110) that consists of a filter housing (111) in which a dust removal filter (111a) is provided, an external air introduction FAN (112), a discharge chamber (113) in a hollow structure in which an outer cylinder (113a) and an inner cylinder (113b) are provided, a discharge electrode (114a) disposed in a circumferential direction of an inner surface of the outer cylinder (113a), a ground electrode (114b) disposed in a circumferential direction of an outer surface of the inner cylinder (113b), electric heaters (116a) and (116b) which are inserted into the discharge electrode (114a) and the ground electrode (114b), a first power supply (115) for applying high-voltage power to the discharge electrode (114a) and the ground electrode (114b), first and second power supplies (116c) and (116d) for applying power to the first and second electric heaters (116a) and (116b), a pressurizer (117), and a venture-ejector (118) which is connected to a circulation pump (152) of a first reactor;
a nitric oxide dissolver (120) that consists of a high-voltage pulse generator (121), as well as discharge electrodes (122a) and (122b), ground electrodes (123a) and (123b) and trigger voltage electrodes (124a) and (124b), which are provided to be insulated inside a circulation pipe of the first reactor, a transformer (125), and conductive wires (126a, 126-1a, 126b, 126c), whereby bubbles containing nitric oxide are degassed and dissolved during discharge in water so as to produce first nitric oxide water while sterilizing bacteria in water and irradiating quantum energy;
a first additive feeder (130) that consists of storage tanks (131a, 131b, 131c, 131d), a feed pipe (132) which is connected to a lower portion of the storage tanks and disposed at one side of an upper portion of the first reactor, and a metering pump (133);
a first quantum energy generator (140) that consists of a drive motor (141), a shaft (141a) made of an insulating material and connected to the drive motor (141), a shaft lower fixture (141b), a variable power supply (142), first magnetic field generating coils (143a, 143b, 143c), second magnetic field generating coils (144a) and (144b), and a conductive wire (145);
a nitric oxide water supply means (160) in a rectangular parallelepiped shape having an inclined structure on a lower portion thereof, in which a circulation pipe (151) is installed on one part of the left side of the inclined lower portion, a circulation pump (152) is mounted on the circulation pipe (151), a discharge pipe (153) on one part of a lower right side, a drain pipe (154) is provided on the bottom surface, a (municipal) water supply pipe (155) is mounted on one part of an upper right side, another circulation pipe (151) is mounted on one side of a top surface, the drive motor (141) of the first quantum energy generator (140) is provided in the center at an interval, the additive feed pipe (132) is disposed at an interval, a nitric oxide concentration detector (511) is installed at an interval, the shaft (141a) made of an insulating material connected to the drive motor (141) and the shaft lower fixture (141b) are installed therein, and the first reactor (150) is provided therein and consists of a plurality of first magnetic field generating coils (143a, 143b, 143c) and second magnetic field generating coils (144a) and (144b) while being apart from each other on the insulating material shaft (141a), and these coils receive power from the variable power supply (142) installed on the outside, wherein any one or more substances among a nitrogen-releasing source, clay, fly ash, mica, lanthanide rare earths, enzymes and soil microorganisms is introduced and mixed so as to produce a second nitric oxide water containing the same;
a carbon dioxide gas (CO2) feeder (210) that consists of a container (bombe) (211) filled with carbon dioxide gas at high pressure, a pressure regulator (212), an electric heater (213), a flow control valve (214), a feed pipe (215), and a venture-ejector (216);
a carbon dioxide gas dissolver (220) that consists of a high-voltage pulse generator (221), discharge electrodes (222a) and (222b), ground electrodes (223a) and (223b), trigger voltage electrodes (224a) and (224b), a transformer (225), and conductive wires (226a, 226-1a, 221b, 226c), wherein bubbles containing carbon dioxide gas are degassed and dissolved during discharge in water to produce a first carbonated water while sterilizing aquatic bacteria and irradiating quantum energy;
a second additive feeder (230) that consists of storage tanks (231a, 231b, 231c), a feed pipe (232) and a metering pump (233);
an electrolysis device (240) that includes an electrolyzer (245) consisting of a DC power supply (241), a positive (+) electrode (242), a negative (−) electrode (243) and a conductive wire (244), as well as a second quantum energy generator (249) consisting of a first cusp coil (245), a second cups coil (248) and a power supply (248), thereby embracing a pulse quantum energy generator that performs an electrolysis reaction while irradiating the firstly prepared carbonated water with quantum energy;
a carbonated water supply means (260) in a rectangular parallelepiped shape having an inclined structure on a lower portion of the main body, in which a circulation pipe (251) is installed on one part of the left side of the inclined lower portion of the main body, a circulation pump (252) is mounted on the circulation pipe, a carbon dioxide gas feeder (210) is provided at an interval, a dissolver (220) is provided at an interval, a discharge pipe (253) is mounted on one part of a lower right side, a drain pipe (254) is provided on the bottom surface, a (municipal) water supply pipe (255) is mounted on one part of an upper right side, another circulation pipe (251) is mounted on one side of a top surface, the additive feed pipe (232) is provided at an interval, a carbonated water concentration detector (512) is provided at an interval, the positive (+) electrode (242) and the negative (−) electrode (243) of the first electrolyzer are installed inside, and a second reactor (250) is provided therein, in which the first cusp coil (246) and the second cusp coil (247) receiving power from the power supply (248) of the second quantum energy generator (249) are installed on the outside at an interval so as to perform electrolysis while irradiating the firstly prepared carbonated water with quantum energy, wherein any one or more substances among carbon dioxide gas-releasing substances such as aromatic carboxylic acid, plant growth promoting substances such as auxin, and moisture fluctuation inhibitors is introduced to produce a second carbonated water containing the same;
a third quantum energy generator (310) that includes a power supply unit (315) consisting of an AC power generator (311), AC/DC converter (312), DC/DC converter (313) and a control unit (314) involving a pulse width modulation (PWM) control way and functions of pulse frequency modulation (PFM), pulse frequency (density) modulation (PDM) and pulse repetition rate (PRR) control, as well as first and second quantum energy generating coils (441) and (442), wherein the power in the form of a pulsed electromagnetic field (PEMF) produced by the power supply unit (315) is applied to the first and second quantum energy generating coils (441) and (442), which are disposed in a space (410) where the plant growth promotion system is installed, to generate, overlap and extinct the pulsed electromagnetic field (PEMF) in opposite directions to produce pulse quantum energy, and the produced pulse quantum energy is irradiated to: a soil for planting the plant in the space (410) where the plant growth promoting system is installed; the plant planted in the soil; and the nitric oxide water and the carbonated water injected to the soil and the plants for fertilization and foliar fertilization;
a fourth quantum energy generator (320) that includes a power supply device (327) consisting of: a power supply unit (321) comprising an AC power supply (321a) or a DC power supply (DC: battery) (322b); AC/DC converter (322); an automatic supply power switch (323) (ATS); a low frequency generation/output unit (324); a switching element (325); and a control unit (326) involving a pulse width modulation (PWM) control way and functions of pulse frequency modulation (PFM), pulse frequency (density) modulation (PDM) and pulse repetition rate (PRR) control, as well as a second quantum energy generator (320), wherein the power in the form of a pulsed electromagnetic field (PEMF) applied from the power supply device (327) is applied to the first and second quantum energy generating coils (441) and (442), which are disposed in the space (410) where the plant growth promotion system is installed, to generate, overlap and extinct the pulsed electromagnetic field (PEMF) in opposite directions to produce pulse quantum energy and irradiate the pulsed quantum energy;
a fifth quantum energy generator (330) that includes a power supply device (339) consisting of: a power supply (331); a switch power supply (332); a micro-controller (333); a capacitor (334); a pulse shaper (335); a pulse phase time controller (336); a voltage level converter (337); and a switch HEXFET (338), as well as the first quantum energy generating coil (441) and the second quantum energy generating coil (442), wherein the power in the form of a pulsed electromagnetic field (PEMF) applied from the power supply device (339) is applied to the first and second quantum energy generating coils (441) and (442), which are disposed in the space (410) where the plant growth promotion system is installed, to generate, overlap and extinct the pulsed electromagnetic field (PEMF) in opposite directions to produce pulse quantum energy, and the produced pulse quantum energy is irradiated to: the soil for planting the plant in the space (410) where the plant growth promoting system is installed; the plant planted in the soil; and the nitric oxide water and the carbonated water injected to the soil and the plants for fertilization and foliar fertilization, and wherein any one among the above quantum energy generators is selected and used as a quantum energy irradiation device (300) to irradiate quantum energy;
the space (410) which is defined by predetermined horizontal length, vertical length and height to a predetermined height from the ground surface and in which the plant growth promoting system is installed, as well as underground of the soil at a predetermined depth and the ground surface;
a nitric oxide water and nitric oxide-containing water supply means (420) that consists of a pressure pump (421), a feed pipe (422), an electromagnetic valve (423) and an injection nozzle (424), wherein the nitric oxide water containing any one or more substances among a nitrogen-releasing source, clay, fly ash, mica, lanthanide rare earths, enzymes and soil microorganisms is supplied to the space (410) in which the plant growth promoting system is installed;
a carbon dioxide gas and carbonated water supply means (430) that consists of a pressure pump (431), a feed pipe (432), an electromagnetic valve (433) and an injection nozzle (434), wherein the carbonated water containing any one or more substances among carbon dioxide-releasing substances such as aromatic carboxylic acid, plant growth promoting substances such as auxin, and moisture fluctuation inhibitors is supplied to the space (410) in which the plant growth promoting system is installed; and
a quantum energy generator (400) that consists of any one power supply selected among the above first, second and third quantum energy generation power supplies (315, 327 and 339), as well as the first quantum energy generating coil (441) and the second quantum energy generating coil (442), wherein quantum energy is irradiated to: the soil for planting the plant in the space (410) where the plant growth promoting system is installed; the plant planted in the soil; and the nitric oxide water and the carbonated water injected to the soil and the plants for fertilization and foliar fertilization, and, in addition, further comprising a control panel (500).

2. The system according to claim 1, wherein the nitric oxide gas generator (110) consists of a filter housing (111) in which a dust removal filter (111a) is provided, an external air introduction FAN (112), a discharge chamber (113) in a hollow structure in which an outer cylinder (113a) and an inner cylinder (113b) are provided, a discharge electrode (114a) disposed in a circumferential direction of an inner surface of the outer cylinder (113a), a ground electrode (114b) disposed in a circumferential direction of an outer surface of the inner cylinder (113b), electric heaters (116a) and (116b) which are inserted into the discharge electrode (114a) and the ground electrode (114b), a first power supply (115) for applying high-voltage power to the discharge electrode (114a) and the ground electrode (114b), first and second power supplies (116c) and (116d) for applying power to the first and second electric heaters (116a) and (116b), and a pressurizer (117), wherein high voltage is applied to the air passing between the discharge electrode (114a) and the ground electrode (114b) provided inside the discharge chamber (113) from the FAN (112) to supply the high voltage to the discharge electrode (114a) and the ground electrode (114b), thereby initiating discharge, while the generated high electric field electron energy is applied to the flowing air so as to decompose air constituents such as nitrogen molecules, oxygen molecules, water molecules in water vapor through electrochemical reaction such as dissociation, excitation, ionization, oxidation and reduction, thereby generating nitric oxide and hydroxyl ions used for bacteria sterilization, and further the nitric oxide is pressurized and supplied to the neck (118a) of the venture-ejector (118) installed on the circulation pump (152) in the first reactor.

3. The system according to claim 1, wherein the nitric oxide dissolver (120) consists of a high-voltage pulse generator (121), as well as discharge electrodes (122a) and (122b), ground electrodes (123a) and (123b) and trigger voltage electrodes (124a) and (124b), which are provided to be insulated inside a circulation pipe of the first reactor, a transformer (125), and conductive wires (126a, 126-1a, 126b, 126c), wherein, when power in the form of a pulsed electromagnetic field (PEMF) generated in the high-voltage pulse generator (121) is applied to the discharged electrodes (122a) and (122b), the ground electrodes (123a) and (123b), and the trigger electrodes (124a) and (124b), magnetic fields in the form of a pulsed electromagnetic field (PEMF) are generated between the discharge electrodes, followed by overlapping and extinction of the same to produce pulse quantum energy, and the produced pulse quantum energy is irradiated to an aqueous solution containing nitric oxide gas to bring about electrical disturbance and electric polarization during discharge in water, thereby inducing (generating) a quantum wave field so that the water molecules have electrostatic traction, hydrogen bonds and covalent bonds between water dipoles are partially dissociated to form a small group water in a “microcluster” structure, and bubbles containing nitric oxide are easily degassed to improve a dissolution rate of nitric oxide gas, and a nitric oxide water is firstly prepared and activated in a process of treatment in order form a high-order coherent domain state, while sterilizing aquatic bacteria.

4. The system according to claim 1, wherein the first additive feeder (130) consists of storage tanks (131a, 131b, 131c, 131d), a feed pipe (132) which is connected to a lower portion of the storage tanks and disposed at one side of an upper portion of the first reactor, and a metering pump (133), wherein the additive stored in the first storage tank (131a) is a nitrogen monoxide (NO) releasing material that is hydroxide apatite (Ca10(PO4)10(OH)2) forming a diazenium diolate functional group by adding nitrogen monoxide, wherein a phosphate compound in apatite (Ca10(PO4)10(OH)2) is ay one selected among calcium metaphosphate (Ca(PO3)2), phosphoric acid (H3PO4), monosodium phosphate (NaH2PO4), dibasic sodium phosphate (Na2HPO4), primary potassium phosphate (KH2PO4), dibasic potassium phosphate (K2HPO4), monobasic ammonium phosphate (NH4H2PO4) and dibasic ammonium phosphate ((NH4)2HPO4), which is fed to the first reactor (150) for producing second nitric oxide through the feed pipe (132) so that the nitric oxide water contains a phosphate compound in water to thus increase a concentration of nitric oxide.

5. The system according to claim 1, wherein the additive stored in the second storage tank (131b) of the first additive feeder (130) is any one selected among a nitrogen-releasing source, clay, fly ash, furnace slag and lanthanide rare earths, which is supplied to the first reactor (150) for producing second nitric oxide through the feed pip (132) so as to contain minerals in the nitric oxide water.

6. The system according to claim 4, wherein the additive stored in the third storage tank (131c) of the additive feeder (130) is any one enzyme selected among acetyl xylan esterase, allophanate hydrolase, alpha amylase, alpha mannosidase, alpha-L-arabinofuranosidase, alpha-L-rhamnosidase, amylase, amylo-alpha-1,6-leucosidase, arylesterase, bacterial alpha-L-rhamnosidase, carboxymuconolactone decarboxylase, catalase, catechol dioxygenase, cellulase, chitobiaase/beta-hexo-amidinase, Co dehydratase, CoA ligase, dexarboxylase, dienlactone hydrolase, deoxygenase, dismutase, dopa4,5-deoxygenase, esterase, group 4 glycosylhydrolase, glucanase, glucodextranase, glucosidase, glutathione, S-transferase, glycosylhydrolase, hyaluronidase, hydratase/decarboxylase, hydrogenase, hydrolase, isoamylase, Laccase, levan sucraase/invertase, mandelate, racemase, mannosyl oligosaccharide glucokidase, meliviase, methanomicrobialespterin S-methyl transferase, methenyltetrahydro-methanopterin cyclohydrolase, methyl-coenzyme M-reductase, methyl muconolactone-methyl-isomerase, monoxide additional enzyme, pectinesterase, periplasm pectinate lyase, peroxidase, phenolase, phenol oxidase, phenolic decarboxylase, phytanoyl-CpA deoxygenase, polysaccharide deacetylase, Flonase, reductase, tetrahydromethanopterin S-methyl group transferase, ceromoca glucanotransferase and tryptophan 2,3-deoxygenase, Candida, Torula, Hanseniaspora, Hansenula, Kluyveromyces, Metschnikowia, Pichia, Starmerella and Torulaspora, which is introduced to the first reactor (150) so as to contain the enzyme in the nitric oxide water.

7. The system according to claim 4, wherein the additive stored in the fourth tank (131d) of the first additive feeder (130) is any one soil microorganism selected among Bacillus subtilis, Bacillus licheniformis, Bacillus mojavensis, Bacillus megaterium, Bacillus purmilus, Bacillus sp, Bacillus amyloliquefaciens, Cellulomonas, Cellulomonas biazotea, Pseudomonas denipripicans, Paenibacillus polymyxa, Pseudomonas stutzeri, RhodoPseudomonas palustris and Nitrobacillus geogiensis and stored, alternatively, any one any one growth agent selected among humic acids, fulvic acids, ulmic acids and humin, which is introduced to the first reactor (150) so as to contain the soil microorganism in the nitric oxide water.

8. The system according to claim 1, wherein the first quantum energy generator (140) consists of a drive motor (141), an insulating material shaft (141a) connected to the drive motor, a shaft lower fixture (141b), a variable power supply (142) involving a pulse width modulation (PWM) control way and functions of pulse frequency modulation (PFM), pulse frequency (density) modulation (PDM) and pulse repetition rate (PRR) control, a first magnetic field generating coil (143), a second magnetic field generating coil (144) and a conductive wire (145), wherein a high voltage in the form of a pulsed electromagnetic field (PEMF) generated in the variable power supply (142) is applied to the first magnetic field generating coil (143) and the second magnetic field generating coil (144), which are installed in plural to thus generate magnetic fields in the form of a pulsed electromagnetic field (PEMF) in opposite directions at an angle of 90° to a current flow direction, and the magnetic fields overlap and extinct to produce pulse quantum energy in a zero magnetic field state, which is irradiated in water to thus promote dissolution of nitric oxide in insoluble bubble state, further, the magnetic field in the form of a pulsed electromagnetic field (PEMF) and the pulse quantum energy are irradiated to the nitric oxide water which is mixed with the mineral materials such as phosphate compounds, clay, mica, etc., enzymes and soil microorganisms supplied from the first additive feeder (130) to bring about electrical disturbance to the nitric oxide water and electric polarization, thereby inducing (generating) a quantum wave field so that water molecules have electrostatic traction, interference phenomenon (inter-stimulation between plants) at long distances can occur, hydrogen bonds and covalent bonds between water dipoles are partially dissociated to form a small group water in a “microcluster” structure, and the mineral material such as phosphate compounds, clay, mica, etc., the enzyme material and/or the soil microorganism mixed in the nitric oxide water are irradiated with the magnetic field in the form of a pulsed electromagnetic field (PEMF) and the pulse quantum energy in a process of treatment to form a high-order coherent domain state.

9. The system according to claim 1, wherein the first reactor (150) has a rectangular parallelepiped shape, in which: a circulation pipe (151) is installed on one part of the lower left side of a main body (150) having an inclined lower portion; a circulation pump (152) is provided on the circulation pipe (151); a venture-ejector (118) having a venture neck (118a), into which nitric oxide is introduced, is installed at an interval; another circulation pipe (151), in which a nitric oxide water dissolver (120) is provided at an interval, is installed on one side of an upper portion of the main body; a water supply pipe (155) is installed on one part of the upper left side; the drive motor (141) of the quantum energy generator is provided at an interval in the center portion of the top surface; a nitric oxide concentration detector (511) is provided at an interval; an additive feed pipe (132) is installed at an interval; a discharge pipe (153) for supplying carbonated water is provided at one part of the lower side; a drain pipe (154) for discharging a deposit is mounted on the bottom side; a power supply (142) of the quantum energy generator (140) is provided at one part of the upper left side; a shaft (141a) connected to the drive motor (141) of the first quantum energy generator is disposed in the inner center portion and inserted in a shaft fixture (141b) mounted on an inner bottom of the first reactor (150); and the first and second quantum energy generating coils (143) and (144) in a disk shape having a predetermined diameter are inserted in the shaft (141a), provided in plural at intervals and connected to the power supply (142) through a conductive wire (145), wherein: nitric oxide is generated in the nitric oxide generator (110) through high-voltage discharge, pressurized and fed to the neck (118a) of the venture-ejector, supplied to the dissolver (120) through the circulation pipe (151) by the circulation pump (152) to be dissolved by irradiation of quantum energy and discharge in water, followed by supplying the dissolved nitric oxide at a low concentration to the inside of the main body; simultaneously, any one or more materials among a nitrogen-releasing source, clay, fly ash, mica, lanthanide rare earths, enzymes and soil microorganisms or all thereof are flowing into the reactor (150) from the additive feeder by the metering pump (133); power in the form of a pulsed electromagnetic field (PEMF) generated in the power supply (142) is supplied to the first and second quantum energy coils (143) and (144), which are provided in plural on a shaft (141a) of an stirrer (141) of the first quantum energy generator (140) at intervals while stirring the above material through the stirrer (141), so as to generate magnetic fields in the form of a pulsed electromagnetic field (PEMF) in the first and second quantum energy generating coils (143) and (144); these magnetic fields overlap and extinct to produce pulse quantum energy; the produced pulse quantum energy is irradiated to a secondly prepared nitric oxide water, in which the nitrogen-releasing source, clay, fly ash, mica, lanthanide rare earths, enzymes and/or soil microorganisms are mixed, to bring about electrical disturbance and electric polarization to the nitric oxide water, thereby inducing (generating) a quantum wave field, so that water molecules have electrostatic traction, interference phenomenon (inter-stimulation between plants) at long distances can occur, hydrogen bonds and covalent bonds between water dipoles are partially dissociated to form a small group water in a “microcluster” structure, and the nitrogen-releasing source, clay, fly ash, mica, lanthanide rare earths, enzymes and/or soil microorganisms mixed in the nitric oxide water are activated to produce second nitric oxide in a process of treatment to form a high-order coherent domain state.

10. The system according to claim 1, wherein the carbon dioxide gas dissolver (220) consists of a high-voltage pulse generator (221), discharge electrodes (222a) and (222b), ground electrodes (223a) and (223b), trigger voltage electrodes (224a) and (224b), a transformer (225), and conductive wires (221a) and (221b), wherein: carbon dioxide gas from a container (bombe) (211) filled with carbon dioxide gas is adjusted to an appropriate pressure in the pressure regulator (212), adjusted to an appropriated flow rate through the flow control valve (214), supplied to the neck of the venture-ejector (215) through the feed pipe (215), and then injected into the aqueous solution; high voltage in the form of a pulsed electromagnetic field (PEMF) generated in the high-voltage pulse generator (221) is applied to the aqueous solution containing carbon dioxide gas to generate magnetic fields in the form of a pulsed electromagnetic field (PEMF) in the discharge electrode (222), the ground electrode (223) and the trigger voltage electrode (224); the magnetic fields overlap and extinct to produce pulse quantum energy; the produced pulse quantum energy is irradiated to the aqueous solution containing carbon dioxide gas to bring about electrical disturbance and electric polarization during discharge in water, thereby inducing (generating) a quantum wave field, so that water molecules have electrostatic traction, hydrogen bonds and covalent bonds between water dipoles are partially dissociated to form a small group water in a “microcluster” structure, bubbles containing carbon dioxide gas are easily degassed to improve a carbon dioxide gas dissolution rate, a first carbonated water is prepared and the prepared carbonated water is activated in a process of treatment to form a high-order coherent domain state, while sterilizing aquatic bacteria.

11. The system according to claim 1, wherein the second additive feeder (230) consists of a storage tank (231), a feed pipe (232) and a metering pump (233), and the additive stored in the first storage tank (231a) is any one material selected among: monocarboxylic acids such as (COOH)2 (carboxylic acid), HCOOH (methanoic acid (formic acid)), CH3COOH (ethanoic acid (acetic acid)), CH3CH2COOH (propionic acid), etc.; dicarboxylic acids such as HOOC—COOH (oxalic acid), HOOCCH2COOH (malonic acid), HOOC(CH2))COOH (succinic acid), etc.; unsaturated aliphatic carboxylic acids such as CH3(CH2)14COOH (paimitic acid), CH3(CH2)16COOH (stearic acid), C3(CH2)7CH═CH(CH2)7COOH (cis) (oleic acid), citric acid (C6H8O7), etc.; aromatic carboxylic acids such as lactic acid (C3H6O3), C6H5-COOH (benzoic acid), C6H5 (OH) COOH (salicylic acid), etc.; sodium bicarbonate (NaHCO3), potassium bicarbonate (KHCO3), calcium bicarbonate (Ca(HCO3)2) and potassium oxalate (K2C2O4), and is supplied to the second reactor (250) to increase a carbonated water concentration in the aqueous solution, thus preparing a second carbonated water containing minerals.

12. The system according to claim 11, wherein the additive stored in the second storage tank (231b) of the second additive feeder (230) is any one material selected among natural auxin, synthetic auxin, auxin metabolite, auxin conjugate, auxin derivative and mixture (non-aqueous solution), auxin (AUXIN) and auxin (AUXIN) compounds such as indole-3-acetic acid, indole-3-butyric acid (IBA), indole 3-propionic acid, indole-3-acetic acid, phenylacetic acid, naphthalene acetic acid (NAA), 2,4-dichlorophenoxy acetic acid, 4-chloroindole-3-acetic acid, 2,4,5-trichlorophenoxy acetic acid, 2-methyl-4-trichlorophenoxyacetic acid, 2,3,6-trichlorobenzoic acid, ethylene, 4-amino-3,4,5-trichloro picoric acid, etc., or zeatin, various forms of zeatin such as N6-benzyl adenine, N6-(delta-2-isopentyl) adenine, 1,3-diphenyl urea, thidazuron, kinetin, cytokinin, cytokinin substances with activity, and other chemical formulations and mixtures thereof, or plant growth promoting substances such as gibberellin, abscisiccid, brassinosteroid, jasmonate, salicylic acid, peptides, strigolactone, etc., and is supplied to the second reactor (250), thereby preparing a second carbonated water containing the plant growth promoting substance.

13. The system according to claim 11, wherein the additive stored in the third storage tank (231c) of the second additive feeder (230) is any one material selected among moisture fluctuation inhibitors such as sugars of a,a-trehalose, specifically, among carbohydrate derivatives of a,a-trehalose having a glucose polymerization degree of 3 to 6, for example: monoglucosyis such as a-maltosyl, a-glucoside, a-isomaltosyl, a-glucoside; diglucosyls such as a, a-trehalose, a-maltolyosyl, a-glucoside (alias:: a-maltosyl, a, a-trehalose), a-maltosyl a-maltoside, a-isomaltosyl a-maltoside, a-isomaltosyl a-isomaltoside, etc.; triglucosyls such as a,a-trehalose, a-maltoterraosyl, a-glucoside (Alias: a-maltotriosyl, a,a-trehalose), a-Maltosyl a-malcotrioside, a-panosyl a-maltoside, etc.; tetraglucosyls such as a,a-trehalose, a-maltopentaosyl a-glucoside (alias: a-maltotetraosyl, a,a-trehalose), a-maltotriosyl malaltotrioside, a-panosyl a-maltotrioside, etc.; a,a-trehalose, and the like, and then is supplied to the second reactor (250), thereby preparing a second carbonated water containing the moisture fluctuation inhibitor.

14. The system according to claim 1, wherein the electrolysis device (240) consists of IGBT DC power supply (241) equipped with a polarity reverse converter (241g), a positive (+) electrode (242), a negative (−) electrode (243), and a conductive wire (244), wherein, when power in the form of a pulsed electromagnetic field (PEMF) generated in the DC power supply (241) is supplied to the positive (+) electrode (242) and the negative (−) electrode (243) through the conductive wire, magnetic fields are generated at an angle of 90° to a current flow direction and the generated magnetic fields overlap and extinct to produce pulse quantum energy, and the produced pulse quantum energy is irradiated to the carbonated water so that water molecules are dissociated to generate oxygen (O2) at the positive (+) electrode (242) and hydrogen (H2) at the negative (−) electrode (233), therefore, in an oxidative atmosphere in which the aqueous solution lacks electrons, carbon dioxide gas (CO2) is generated through a reduction reaction with any one material selected and supplied among: monocarboxylic acids such as (COOH)2 (carboxylic acid), HCOOH (methanoic acid (formic acid)), CH3COOH (ethanoic acid (acetic acid)), CH3CH2COOH (propionic acid), etc.; dicarboxylic acids such as HOOC—COOH (oxalic acid), HOOCCH2COOH (malonic acid), HOOC(CH2))COOH (succinic acid), etc.; unsaturated aliphatic carboxylic acids such as CH3(CH2)14COOH (palmitic acid), CH3(CH2)16COOH (stearic acid), CH3(CH2)7CH═CH(CH2)7COOH(cis) (oleic acid), citric acid (C6H8O7), etc.; aromatic carboxylic acids such as lactic acid (C3H6O3), C6H5-COOH (benzoic acid), C6H5(OH)COOH (salicylic acid), etc.; sodium bicarbonate (NaHCO3), potassium bicarbonate (KHCO3), calcium bicarbonate (Ca(HCO3)2) and potassium oxalate (K2C2O4), at the same time, the aqueous containing carbon dioxide gas is subjected to electrical disturbance to bring about electric polarization to induce (generate) a quantum energy field, so that water molecules have electrostatic traction, hydrogen bonds and covalent bonds between water dipoles are partially dissociated to form a small group water in a “microcluster” structure, bubbles containing carbon dioxide gas are easily degassed to improve a carbon dioxide gas dissolution rate, a second carbonated water is prepared and the prepared carbonated water is activated in a process of treatment to form a high-order coherent domain state.

15. The system according to claim 13, wherein the electrolysis device (240) consists of IGBT DC power supply (241) equipped with a polarity reverse converter (241g), a positive (+) electrode (242), a negative (−) electrode (243), and a conductive wire (244), wherein the IGBT power supply (241) includes a step-down transformer (241a), a rectifier circuit (241b), an IGBT inverter (241c), a power output unit (241d), a control signal generator (241e), a microcomputer (241f), as well as the polarity reverse converter (241g), wherein: an input voltage single-phase 220V, 60 Hz AC power is reduced to a single-phase in the range of 12 to 24V in the step-down transformer (241a); the single-phase 220V, 60 Hz AC power in the step-down transfer (241) is converted into single-phase DC power in the range of 12 to 24V in the rectifier unit (241b); the IGBT inverter (241c) supplies DC power input by a control signal transmitted from the outside to the load side; the control signal generator (241e) generates control signals in a pulse width modulation (PWM) control way and in the form of pulse frequency modulation (PFM), pulse frequency (density) modulation (PDM) and pulse repetition rate (PRR) control, and then transmits the same to the IGBT inverter (241c); thereafter, by comparing the voltage applied to the positive (+) electrode (242) and the negative (−) electrode (243) with the previously programmed input voltage and then adjusting the same, the previously programmed and input voltage value is applied to the positive (+) electrode (242) and the negative (−) electrode (243) through conductive wires; further, the microcomputer (241f) converts the output signal of the control signal generator (241e) into a digital form in order to set a PWM width of the control signal from the received output signal and then transfers the control signal with the set PWM width to the control signal generator (241e) whereby, when DC power in the form of a pulsed electromagnetic field (PEMF) in the range of single-phase 12 to 24V is supplied to the plurality of positive (+) electrodes (242) and negative (−) electrodes (243), each of which is in a modified solenoid coil shape wherein the modified solenoid coils are installed in opposite directions, through the conductive wire (244), the DC power in the form of a pulsed electromagnetic field (PEMF) from the DC power supply (241) is supplied to the plurality of positive (+) electrodes (242) and negative (−) electrodes (243), each of which is in a modified solenoid coil shape wherein the modified solenoid coils are installed in opposite directions and thus magnetic fields are generated at an angle of 900 to a current flow direction, and the magnetic fields in the form of a pulsed electromagnetic field (PEMF) generated in opposite directions in the middle portion between the plurality of positive (+) electrodes (242) and negative (−) electrodes (243), which are installed in opposite directions, overlap and extinct to produce pulse quantum energy in a zero magnetic field state, which in turn is irradiated to the carbonated water containing any one or more materials among carbon dioxide gas-releasing substances such as aromatic caroboxylic acid, plant growth promoting substance such as auxin, and moisture fluctuation inhibitors so as to bring about electrical disturbance and electric polarization, thereby inducing (generating) a quantum wave field, so that water molecules have electrostatic traction, interference phenomenon (inter-stimulation between plants) at long distances can occur, hydrogen bonds and covalent bonds between water dipoles are partially dissociated to form a small group water in a “microcluster” structure, and electrolysis is performed in the positive (+) electrode (242) and the negative (−) electrode (243) simultaneously with a process of treatment to form a high-order coherent domain state, so as to dissociate water molecules in the carbonated water, and further to dissociate covalent bonds of carbon dioxide gas-releasing material molecules such as aromatic carboxylic acid to produce carbon dioxide gas, while activating the plant growth promoting substances such as auxin and the moisture fluctuation inhibitor substances.

16. The system according to claim 15, wherein the material of the positive (+) electrode (242) in the electrolysis device (240) is any one selected and used among Schottky metals such as platinum (Pt), gold (Au), palladium (Pd), iron (Fe), cobalt (Co), chromium (Cr), nickel (Ni), silver (Ag), titanium (Ti), rubidium (Ru), copper (Cu), molybdenum (Mo), iridium (Ir), rhodium (Rh), etc., while the material of the negative (−) electrode (243) in the electrolysis device (240) is any one material selected and used from ohmic metals such as aluminum (Al), silver (Ag), gold (Au), iron (Fe), chromium (Cr), titanium (Ti), nickel (Ni) and copper (Cu), otherwise,
any one or more materials selected among sodium (Na)-potassium (K) alloy (Na-k alloy), nickel-manganese alloy (Ni—Mn alloy), nickel-copper alloy (Ni—Cu alloy), manganese-copper alloy (Mn—Cu) alloy, aluminum-copper alloy (Al—Cu alloy), copper-zinc alloy (Cu—Zn alloy), copper-tin alloy (Cu—Sn alloy), copper-titanium based copper alloy (Cu—Ti alloy) and copper-nickel-silicon based alloy (Cu—Ni—Si alloy), manganese alloy (Mn alloy: SMn 443 alloy steel for mechanical structure (KS D 3867)), iron and iron alloys such as carbon steel (SS400), STS304, ferromanganese, ferrotitanium, ferronickel, ferrozircon, ferrobron, ferromolybdenum, ferroporphos, ferrobadium, etc., any one or more Mg or magnesium alloys selected among Mg or Mg—Al— (Zn)—(Mn)-based alloy (product name: Electron) produced in Europe, and MG-Zn—Zr based or Mg-rare earths based, Mg-misch metal-based, Mg—Ce based and Mg—La based materials, and any one or more of boron steels as boron alloys are selected and used as a common material for the positive (+) electrode (242) and the negative (−) electrode (243), and
wherein each of the positive (+) electrode (242) and the negative (−) electrode (243) has a rectangular shape, is processed into a solenoid coil shape modified by a laser modeling technique, and is provided in plural on the cradle (244) such that the processed coils are wound in opposite directions on the positive (+) electrode (242) and the negative (−) electrode (243) facing to each other.

17. The system according to claim 15, wherein the electrolysis device (240) supplies power in the form of a pulsed electromagnetic field (PEMF) generated in the power supply (241) equipped with a polarity reverse converter (241g) to the positive (+) electrode (242) and the negative (−) electrode (243),
wherein metal ions such as potassium ion (K+), calcium ion (Ca2+), magnesium ion (Mg2+), iron ions (Fe2+, Fe3+), aluminum ions (A13+), etc. are eluted from the positive (+) electrode (242) and the negative (−) electrode (243) through electrolysis, and these ions are reacted with hydroxyl ions (OH—) generated by dissociation of water molecules in the carbonated water to produce potassium hydroxide (KOH), calcium hydroxide (Ca(OH)2), magnesium hydroxide (Mg(OH)2), ferric hydroxide (Fe(OH)2), ferric hydroxide (Fe(OH)3), aluminum hydroxide (Al(OH)3, etc.,
wherein, in the above process, cationic material and anionic material are removed, resulting in production of second carbonated water which contains any one or more substances among: carbon dioxide gas-releasing substances such as aromatic carboxylic acid having anti-oxidation (reduction) functions and exhibiting an oxidation potential measurement value of −600 to −1200 mV; plant growth promoting substances such as auxin; and moisture fluctuation inhibitors,
wherein the second carbonated water is pressurized by the pressure pump (431) in the space (410) where the plant growth promotion system is installed, and supplied to the feed pipe (432) through an injection nozzle (434) attached thereto, followed by foliar fertilization of the planted plants, so that oxidative stress including the biological stress caused by other organisms such as pests and diseases and the abiotic stress caused by changes in the physical or chemical environments such as heat, drought, salinity, etc. are overcome to restore the lost ability of the plant roots to absorb necessary materials from the soil, which in turn allows the plant to produce sufficient vitamins, amino acids, hormones, and the like.

18. The system according to claim 1, wherein the second quantum energy generator (249) consists of a first cusp coil (246), a second cusp coil (247) an a power supply (248), wherein the first cusp coil (246) faces a circumferential side at one upper portion of the outer side of the second reactor (250) and is wound in a counterclockwise direction at a predetermined number of turns while the second cusp coil (248) faces the circumferential side atone lower portion of the outer side of the second reactor (250) and is wound in clockwise direction at a predetermined number of turns 10 to 30% larger than the above number of turns in the first cusp coil (246), whereby, when a high voltage in the form of a pulsed electromagnetic field (PEMF) generated in the power supply (248) is applied to the first cusp coil (246) and the second cusp coil (247), a magnetic field in the form of a pulsed electromagnetic field (PEMF) is generated downwardly in the first cusp coil (246) and is irradiated to the aqueous solution while another magnetic field in the form of a pulsed electromagnetic field (PEMF) is generated upwardly in the second cusp coil (247) is irradiated to the aqueous solution, to thus generate magnetic fields in the form of a pulsed electromagnetic field (PEMF) in opposite directions on a portion at a first cusp coil side in the middle portion between the first cusp coil (246) and the second cusp coil (247), followed by overlapping and extinction of the magnetic fields to produce pulse quantum energy, which in turn is irradiated to the carbonated water that contains any one or more materials among carbon dioxide gas-releasing substances such as aromatic carboxylic acid, plant growth promoting substances such as auxin and moisture fluctuation inhibitors to bring about electrical disturbance and electric polarization to the carbonated water, thereby inducing (generating) a quantum wave filed, so that a so-called “microcluster” phenomenon occurs to partially dissociate hydrogen bonds between water dipoles, decrease a size of water molecule, and form a high-order coherent domain state, thereby activating the carbonated water as well as the carbon dioxide gas-releasing substance such as aromatic carboxylic acid, the plant growth promoting substance such as auxin and/or the moisture fluctuation inhibitors.

19. The system according to claim 17 or 18, wherein the minerals (calcium, iron, potassium, sodium, magnesium, etc.), natural auxin, synthetic auxin, auxin metabolites, the moisture fluctuation inhibitor such as sugar of a,a-trehalose contained in the carbonated water are irradiated with the magnetic field in the form of a pulsed electromagnetic field (PEMF) and the pulse quantum energy, which are generated during electrolysis by the electrolysis device (240) and the second quantum energy generator (249), to bring about electrical disturbance and electric polarization to the nitric oxide water, thereby inducing (generating) a quantum wave field, so that water molecules have electrostatic traction, interference phenomenon (inter-stimulation between plants) at long distances can occur, hydrogen bonds and covalent bonds between water dipoles are partially dissociated to form a small group water in a “microcluster” structure, and the natural auxin, synthetic auxin, auxin metabolites, the moisture fluctuation inhibitor such as sugar of a,a-trehalose contained in the carbonated water are activated to prepare a second carbonated water with activity, and the secondly prepared carbonated water is activated in a process of treatment to form a high-order coherent domain state.

20. The system according to claim 17 or 18, wherein the minerals are supplied to the aqueous carbonated water by an alternative method in that a pulse type power generated in the IGBT DC power supply (241) of the electrolysis device (240) is applied to the electrodes (242) and (243), and then, ionic potassium (K), calcium (Ca), magnesium (Mg), boron (B), iron (Fe), manganese (Mg), copper (Cu), zinc (Zn), nickel (Ni) and molybdenum (Mo) eluted from the electrodes are provided in the form of ions.

21. The system according to claim 18, wherein the power supply (248) of the second quantum energy generator (249) consists of a rectifier (248a), a converter (248b), an inverter (248c), a resonance reactor (248d), a pulse transformer (248e), a control unit (248f) involving a pulse width modulation (PWM) control way and functions of pulse frequency modulation (PFM), pulse frequency (density) modulation (PDM) and pulse repetition rate (PRR) control, a gate driver (248g), a first capacitor (248h) and a second capacitor (248i),
wherein: the rectifier (248a) converts the single-phase 220V 60 Hz AC power input into a DC voltage; the converter (248b) boosts the DC voltage resulting from conversion of the AC power to the DC power in the rectifier (248a) to a high voltage through a switching operation; the inverter (248c) modulates the DC voltage boosted by the converter (248b) into a pulsed electromagnetic field (PEMF) voltage; the resonance reactor (248d) matches the loads of the first and second cusp coils (246) and (247); the pulse transformer (248e) boosts the output voltage of the inverter (248c); in order to perform pulse amplitude modulation (PAM) of the switching output between the first and second cusp coils (246) and (247) receiving application of output voltage of the pulse transformer (248e) and the inverter (248c), the control unit (248f) forms a signal to control the output voltage of the converter (248b); further, in order to adjust an intensity of the magnetic field generated in the first cusp coil (246) and the second cusp coil (247) so as to control an amount of quantum energy, the control unit (248f) forms a signal enabling pulse frequency (density) modulation independent of a width of the pulse,
wherein the power supply further includes: the gate driver (248g) that amplifies the voltage of the control signal applied from the control unit (248f), and then, applies the same to the converter (248b) and the inverter (248c); and
the first capacitor (248h) that reduces the ripple of the voltage rectified through the rectifier (248a) and then inputs a voltage of the first capacitor (248c) into the converter (248b), and the second capacitor (248i) that reduces the ripple of the DC voltage boosted by the converter (248b) and then inputs a voltage of the second capacitor (248i) into the inverter (248c),
wherein the rectifier (248a) converts the supplied AC power to a DC voltage, the converter (248b) boosts the DC voltage through a switching operation, and the inverter (248c) converts the boosted DC voltage into a voltage in the form of AC pulse (pulsed electromagnetic field; PEMF), thereafter, the pulse transformer (142e) boosts the output voltage of the inverter (142c) and applies the same to the first and second cusp coils (246) and (247), thereby applying the power in the form of a pulsed electromagnetic field (PEMF) to the first and second cusp coils (246) and (247), so that magnetic fields in the form of a pulsed electromagnetic field (PEMF) are generated in the first and second cusp coils (246) and (247), which have winding directions opposite to each other, at an angle of 90° to a current flow direction, and the generated magnetic fields overlap and extinct to pulse quantum energy in a zero magnetic field state in the middle portion at a spaced distance between the first and second cusp coils (246) and (247).

22. The system according to claim 1, wherein the second reactor (250) has a rectangular parallelepiped shape, in which: a circulation pipe (251) is installed on one part of the left side of an inclined lower portion of the main body; a circulation pump (252) is mounted on the circulation pipe (251); a venture-ejector (216) including a venturi neck (216a) through which carbon dioxide gas is introduced is installed at an interval; another circulation pipe (251), in which a carbon dioxide gas dissolver (220) is provided, is installed at an interval on one side of an upper portion of the main body; a (municipal) water supply pipe (255) is provided on one part of the upper left side; a carbonated water concentration detection sensor (512) is mounted on one part of the right side of a top surface; an additive feed pipe (232) is mounted at a distance from the detection sensor; a discharge pipe (253) for supplying the carbonated water is installed on one part of the lower right side; a drain pipe (254) for discharging a deposit is installed on the bottom surface; a power supply (241) of the electrolysis device (240) is installed on one part of the upper right side; a first cusp coil (246) of the second quantum energy generator (249) is mounted on an upper portion of the outer side of the main body while a second cusp coil (247) is provided in a downward direction while being spaced at a distance from each other; and a plurality of positive (+) electrodes (242) and negative (−) electrodes (243) of the electrolysis device (240) are installed at a distance from each other on a cradle (244) on one upper side inside the second rector (250), wherein: carbon dioxide gas filled in the carbon dioxide gas container (211) is adjusted to appropriate pressure and flow rate, fed to the neck (216a) of the venture-ejector, and supplied to the dissolver (220) through the circulation pipe (251) to irradiate quantum energy, followed by dissolving the carbon dioxide gas through discharge in water to produce carbon dioxide gas at a low concentration, the produced carbon dioxide gas is provided to the inside of the main body; at the same time, any one or more materials among carbon dioxide gas-releasing substances such as aromatic carboxylic acid, plant growth promoting substances such as auxin and/or moisture fluctuation inhibitors or all thereof flowing into the second reactor (250) from the additive feeder through the metering pump (233) is introduced to the inside of the second reactor (250); when powder in the form of a pulsed electromagnetic field (PEMF) generated in the power supply (248) of the second quantum energy generator (249) is supplied to the first and second cusp coils (246) and (247) and power in the form of a pulsed electromagnetic field (PEMF) generated in the power supply (241) of the electrolysis device (240) is supplied to the positive (+) electrode (242) and the negative (+) electrode (243), magnetic fields in the form of a pulsed electromagnetic field (PEMF) are generated in opposite directions in the first and second cusp coils (246) and (247) of the second quantum energy generator (249) and the positive (+) and negative (−) electrodes (242) and (243) of the electrolysis device (240); the magnetic fields in the form of a pulsed electromagnetic field (PEMF) in opposite directions overlap and extinct in the middle portion between the first and second cusp coils (246) and (247) and in the middle portion between the plurality of positive (+) electrodes (242) and negative (−) electrodes (243) to thus produce pulse quantum energy in a zero magnetic state; this pulse quantum energy is irradiated to the carbonated water, in which any one or more materials among the carbon dioxide gas substance such aromatic caroboxylic acid, the plant growth promoting substance such as auxin and/or the moisture fluctuation inhibitors are mixed, in the second reactor (250) to bring about electrical disturbance and electric polarization to the carbonated water, thereby inducing (generating) a quantum wave field, so that a so-called “microcluster” phenomenon occurs to partially dissociate hydrogen bonds between water dipoles, decrease a size of water molecule, and form a high-order coherent domain state, thereby activating the carbonated water as well as the carbon dioxide gas-releasing substance such as aromatic carboxylic acid, the plant growth promoting substance such as auxin and/or the moisture fluctuation inhibitors, in addition, a carbonated water containing potassium (K), calcium (Ca), magnesium (Mg), boron (B), iron (Fe), manganese (Mg), copper (Cu), zinc (Zn), nickel (Ni) and molybdenum (Mo) ions eluted from the electrodes (242) and (243) of the electrolysis device (240) is prepared.

23. The system according to claim 1, wherein the third quantum energy generator (310) includes a power supply (315) consisting of: an AC power generator (311); AC/DC converter (312); DC/DC converter (313); and a control unit (314) involving a pulse width modulation (PWM) control way and functions of pulse frequency modulation (PFM), pulse frequency (density) modulation (PDM) and pulse repetition rate (PRR) control, as well as first and second quantum energy generating coils (441) and (442), wherein the power in the form of a pulsed electromagnetic field (PEMF) produced by the power supply (315) is applied to the first and second quantum energy generating coils (441) and (442), which are disposed in a space (410) where the plant growth promotion system is installed, to generate magnetic fields in the form of a pulsed electromagnetic field (PEMF) at angle of 900 to a current flow direction in the quantum energy generating coils (441) and (442), respectively, the generated magnetic fields in the form of a pulsed electromagnetic field (PEMF) in opposite directions overlap and extinct to produce pulse quantum energy in a zero magnetic field state, which is irradiated to: a soil for planting plants; plants planted in the soil; the nitric oxide water which is mixed with a nitrogen-releasing source, clay, fly ash, mica, lanthanide rare earths, enzymes, soil microorganisms, etc. and which is injected for fertilization and foliar fertilization to the plants; and the carbonated water which contains carbon dioxide gas-releasing substances such as aromatic carboxylic acid, plant growth promoting substances such as auxin and/or moisture fluctuation inhibitors, to thus bring about electrical disturbance and electric polarization, thereby inducing (generating) a quantum wave field, so that hydrogen bonds and covalent bonds between water dipoles are partially dissociated to form smaller group water in a “microcluster” structure and in a coherent domain state with high order, so as to activate: the moisture (H2O) of the soil and the sap of the plants planted in the soil; the nitric oxide water for fertilization and foliar fertilization, which is a mixture prepared by adding a nitrogen-releasing source, clay, fly ash, mica, lanthanide rare earths, enzymes, soil microorganisms, etc. thereto; the carbonated water, which contains carbon dioxide gas-releasing substances such as aromatic carboxylic acid, plant growth promoting substances such as auxin and/or moisture fluctuation inhibitors in activated state, thereby promoting the growth of the planted plants.

24. The system according to claim 1, wherein the fourth quantum energy generator (320) includes a power supply device (327) consisting of: a power supply unit (321) comprising an AC power supply (321a) or a DC power supply (DC: battery) (322b); AC/DC converter (322); an automatic supply power switch (323) (ATS); a low frequency generation/output unit (324); a switching element (325); and a control unit (326) involving a pulse width modulation (PWM) control way and functions of pulse frequency modulation (PFM), pulse frequency (density) modulation (PDM) and pulse repetition rate (PRR) control, as well as the first and second quantum energy generating coils (441) and (442), wherein power in the form of a pulsed electromagnetic field (PEMF) generated in the power supply device (327) is applied to the first and second quantum energy generating coils (441) and (442) provided in the space (410), in which the plant growth promoting system is applied, such that winding directions of the coils are opposed to each other, to generate magnetic fields in the form of a pulsed electromagnetic field (PEMF) in opposite directions in the first and second quantum energy generating coils (441) and (442), and the generated magnetic fields in the form of a pulsed electromagnetic field (PEMF) overlap and extract to produce pulse quantum energy in a zero magnetic field state, which is irradiated to: a soil for planting plants; plants planted in the soil; the nitric oxide water which is mixed with a nitrogen-releasing source, clay, fly ash, mica, lanthanide rare earths, enzymes, soil microorganisms, etc. and which is injected for fertilization and foliar fertilization to the plants; and the carbonated water which contains carbon dioxide gas-releasing substances such as aromatic carboxylic acid, plant growth promoting substances such as auxin and/or moisture fluctuation inhibitors, to thus bring about electrical disturbance and electric polarization, thereby inducing (generating) a quantum wave field, so that hydrogen bonds and covalent bonds between water dipoles are partially dissociated to form smaller group water in a “microcluster” structure and in a coherent domain state with high order, so as to activate: the moisture (H2O) of the soil and the sap of the plants planted in the soil; the nitric oxide water for fertilization and foliar fertilization, which is a mixture prepared by adding a nitrogen-releasing source, clay, fly ash, mica, lanthanide rare earths, enzymes, soil microorganisms, etc. thereto; and the carbonated water, which contains carbon dioxide gas-releasing substances such as aromatic carboxylic acid, plant growth promoting substances such as auxin and/or moisture fluctuation inhibitors in activated state, thereby promoting the growth of the planted plants.

25. The system according to claim 1, wherein the fifth quantum energy generator (320) includes a power supply device (339) consisting of: a power supply (331); a switch power supply (332); a micro-controller (333); a capacitor (334); a pulse shaper (335); a pulse phase time controller (336); a voltage level converter (337); and a switch HEXFET (338), as well as the first quantum energy generating coil (441) and the second quantum energy generating coil (442), wherein the power in the form of a pulsed electromagnetic field (PEMF) applied from the power supply device (339) is applied to the first and second quantum energy generating coils (441) and (442), which are disposed in the space (410) where the plant growth promotion system is applied, to generate magnetic fields in the form of a pulsed electromagnetic field (PEMF) in opposite directions, and the generated magnetic fields in the form of a pulsed electromagnetic field (PEMF) overlap and extinct in the middle portion between the first and second quantum energy generating coils (441) and (442) while being spaced to each other, to thus produce pulse quantum energy in a zero magnetic field state, which is irradiated to: a soil for planting plants; plants planted in the soil; the nitric oxide water which is mixed with a nitrogen-releasing source, clay, fly ash, mica, lanthanide rare earths, enzymes, soil microorganisms, etc. and which is injected for fertilization and foliar fertilization to the plants; and the carbonated water which contains carbon dioxide gas-releasing substances such as aromatic carboxylic acid, plant growth promoting substances such as auxin and/or moisture fluctuation inhibitors, to thus bring about electrical disturbance and electric polarization, thereby inducing (generating) a quantum wave field, so that hydrogen bonds and covalent bonds between water dipoles are partially dissociated to form smaller group water in a “microcluster” structure and in a coherent domain state with high order, so as to activate: the moisture (H2O) of the soil and the sap of the plants planted in the soil; the nitric oxide water for fertilization and foliar fertilization, which is a mixture prepared by adding a nitrogen-releasing source, clay, fly ash, mica, lanthanide rare earths, enzymes, soil microorganisms, etc. thereto; and the carbonated water, which contains carbon dioxide gas-releasing substances such as aromatic carboxylic acid, plant growth promoting substances such as auxin and/or moisture fluctuation inhibitors in activated state, thereby promoting the growth of the planted plants.

26. The system according to claim 18, wherein the space (400) where the plant growth promoting system is applied is constructed to include: a space (410) comprising underground of a soil in a predetermined depth, the ground surface, and a space defined by predetermined horizontal length and vertical length and a predetermined height from the ground surface, in which the plant growth promoting system is installed:
a nitric oxide and nitric oxide-containing water supply means (420) that consists of a pressure pump (421), a feed pipe (422), an electromagnetic valve (423) and an injection nozzle (424), wherein the nitric oxide and nitric oxide water is supplied to the space (410) in which the plant growth promoting system is installed;
a carbon dioxide gas and carbonated water supply means (430) that consists of a pressure pump (431), a feed pipe (432), an electromagnetic valve (433) and an injection nozzle (434), wherein the carbon dioxide gas and the carbonated water is supplied to the space (410) in which the plant growth promoting system is installed; and
a quantum energy generator (400) that consists of any one power supply of the quantum energy generator selected among the power supply (315) of the third quantum energy generator (310), the power supply (327) of the fourth quantum energy generator (320) and the power supply (339) of the fifth quantum energy generator (330), wherein power in the form of a pulsed electromagnetic field generated in the power supply of the any one type quantum energy generator is applied to the first and second generating coils (441) and (442), which are arranged to face each other in the space (410) where the plant growth promoting system is installed, to generate magnetic fields in the form of a pulsed electromagnetic field (PEMF) in the middle portion between the first and second generating coils (441) and (442), and the generated magnetic fields overlap and extinct to produce pulse quantum energy in a zero magnetic field state, which is irradiated by a quantum energy irradiation means (440) to the space (410) where the plant growth promoting system is applied, in addition, further comprising a control panel (500).

27. The system according to claim 24, wherein a method for supplying the nitric oxide water to the plant planted in the space where the plant growth promoting system is applied includes: operating the pump (421); and feeding the nitric oxide water prepared in the first reactor (150) via the feed pipe and injecting the same through the injection nozzle (424) to roots of the plant planted in the soil, wherein the nitric oxide water only, the activated nitric oxide prepared by irradiating pulse quantum energy thereto only, the nitric oxide water which is mixed with the nitrogen-releasing source, clay, fly ash, mica, lanthanide rare earths, enzymes and/or soil microorganisms added thereto only, otherwise, the nitric oxide containing the nitrogen-releasing source, clay, fly ash, mica, lanthanide rare earths, enzymes and/or soil microorganisms which are activated by irradiating pulse quantum energy are injected to leaves of the plant, thereby performing fertilization and foliar fertilization.

28. The system according to claim 24, wherein a method for supplying the carbonated water to the plant planted in the space where the plant growth promoting system is applied includes: operating the pump (431); and feeding the carbonated water prepared in second reactor (250) via the feed pipe and injecting the same through the injection nozzle (434) to leaves of the plant planted in the soil, wherein the carbonated water only, the activated carbonated water prepared by irradiating pulse quantum energy only, the carbonated water containing the carbon dioxide gas-releasing substance such as aromatic carboxylic acid, the plant growth promoting substance such as auxin and/or the moisture fluctuation inhibitor only, otherwise, the carbonated water containing the carbon dioxide gas-releasing substance such as aromatic carboxylic acid, the plant growth promoting substance such as auxin and/or the moisture fluctuation inhibitor, which are activated by irradiating pulse quantum energy are injected to the leaves of the plant, thereby performing fertilization or foliar fertilization.

29. The system according to claim 1, wherein a method for irradiating the plant planted in a space where the plant growth promoting system is applied with the magnetic field in the form of a pulsed electromagnetic field (PEMF) and pulse quantum energy includes: embedding a plurality of first quantum energy generating coils (441) or the second quantum energy generating coils (442) at a height of 50 cm from the soil ground surface in the space where the plant growth promoting system is applied; installing a plurality of second quantum energy generating coils (442) or first quantum energy generating coils (441) at a height of 1 m above ground (from the ground surface) such that this coil face the first quantum energy generating coil (441) or the second quantum energy generating coil (442) embedded in the underground, and such that winding directions of the first quantum energy generating coil (441) and the second quantum energy generating coil (442) facing each other are opposed to each other; supplying the power in the form of a pulsed electromagnetic field (PEMF) generated in the power supply selected among the power supplies (311, 321, 331) of the third, fourth and fifth quantum energy generators (310, 320, 330) to generate magnetic fields in the form of a pulsed electromagnetic field (PEMF) in the first quantum energy generating coil (441) and the second quantum energy generating coil (442) facing each other, followed by overlapping and extinction of the magnetic fields in the form of a pulsed electromagnetic field (PEMF) to produce quantum energy in a zero magnetic field state; and irradiating the produced quantum energy to the roots and leaves of the planted plant.
